(19) United States
(12) Patent Application Publication
(10) Pub. No.: US 2025/0262122 A1
(43) Pub. Date: Aug. 21, 2025

(54) METHODS, SYSTEMS, AND/OR DEVICES FOR THERMAL TREATMENTS

(71) Applicant: John Richard Taylor, Irving, TX (US)

(72) Inventor: John Richard Taylor, Irving, TX (US)

(21) Appl. No.: 19/198,027

(22) Filed: May 3, 2025

Related U.S. Application Data
(63) Continuation-in-part of application No. 18/197,365, filed on May 15, 2023.
(63) Continuation of application No. 18/821,343, filed on Aug. 30, 2024.
(63) Continuation-in-part of application No. 29/773,825, filed on Mar. 11, 2021.
(63) Continuation-in-part of application No. 29/782,903, filed on May 10, 2021.

(51) Int. Cl. A61H 35/00; A61H 33/00

(52) U.S. Cl. CPC A61H 35/008; A61H 33/6005; A61H 2201/0111; A61H 2201/0188; A61H 2201/107; A61H 2201/1607; A61H 2201/5082; A61H 2203/0468

(57) ABSTRACT

A soaking-device is usable to soak a given body part of a user. The body part may be a face or a portion of the face of the user. The user may be a person or other animal. The soaking-device includes a vessel-subassembly. The vessel-subassembly includes a wettable-subassembly. The wettable-subassembly itself and/or interaction of the wettable-subassembly with a part of the vessel-subassembly, its outermost-shell, may not utilize screws or the like mechanical fasteners. The wettable-subassembly may include a neck-gasket for removable physical contact with a neck portion of the user. The wettable-subassembly is configured to hold a volume of an immersion-liquid for the soaking of the body part. Prior to use, the volume of the immersion-liquid may be heated or cooled. A breathing-apparatus may be used. A tower may be placed next to the wettable-subassembly to shine light into and/or to release bubbles into the immersion-liquid.

### PRIORITY NOTICE

The present (instant) U.S. nonprovisional patent application claims priority under 35 U.S.C. § 120 to U.S. nonprovisional patent application Ser. No. 18/821,343 filed on Aug. 30, 2024, the disclosure of which is incorporated herein by reference in its entirety. The present (instant) U.S. nonprovisional patent application is a continuation of U.S. nonprovisional patent application Ser. No. 18/821,343 filed on Aug. 30, 2024.

The present (instant) U.S. nonprovisional patent application claims priority under 35 U.S.C. § 120 to U.S. nonprovisional patent application Ser. No. 18/197,365 filed on May 15, 2023, the disclosure of which is incorporated herein by reference in its entirety. The present (instant) U.S. nonprovisional patent application is a continuation-in-part (CIP) of U.S. nonprovisional patent application Ser. No. 18/197,365 filed on May 15, 2023.

The present (instant) U.S. nonprovisional patent application claims priority under 35 U.S.C. § 120 to U.S. nonprovisional patent application Ser. No. 29/773,825 filed on Mar. 11, 2021, the disclosure of which is incorporated herein by reference in its entirety. The present (instant) U.S. nonprovisional patent application is a continuation-in-part (CIP) of U.S. nonprovisional patent application Ser. No. 29/773,825 filed on Mar. 11, 2021.

The present (instant) U.S. nonprovisional patent application claims priority under 35 U.S.C. § 120 to U.S. nonprovisional patent application Ser. No. 29/782,903 filed on May 10, 2021, the disclosure of which is incorporated herein by reference in its entirety. The present (instant) U.S. nonprovisional patent application is a continuation-in-part (CIP) of U.S. nonprovisional patent application Ser. No. 29/782,903 filed on May 10, 2021.

### CROSS REFERENCE TO RELATED PATENT APPLICATIONS

The following U.S. patents, by the same inventor as the present inventions, are incorporated by reference as if fully set forth herein: U.S. utility U.S. Pat. No. 10,667,990, U.S. utility U.S. Pat. No. 10,449,341, U.S. utility U.S. Pat. No. 10,667,991, U.S. utility U.S. Pat. No. 11,154,697, U.S. design patent D863575, U.S. design patent D863576, U.S. design patent D864403, U.S. design patent D889675, U.S. design patent D916303, and U.S. design patent D921906.

### TECHNICAL FIELD OF THE INVENTION

The present invention relates in general to devices that are configured for soaking a particular body portion of a subject and more specifically to such a soaking device that is also configured hydrotherapy, thermal therapy, cryotherapy, light therapy, and/or bubble therapy.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

With respect to thermal therapies and/or cryotherapies, where heat or cool may be delivered to a particular body or portion of a body of a given animal subject, such as, but not limited to, a human, a primate, a mammal, or a vertebrate animal, and with further respect to conduction as a means for heat transfer, a solid material may generally provide more efficient heat transfer over a liquid material, and a liquid material may generally provide more efficient heat transfer over a gas material.

However, good solid materials for heat transfer, such as, but not limited to, copper (and other metals and/or alloys) are difficult and/or expensive to shape to yield a heat transfer surface that would be capable of physically touching all or most all of the skin of a subject's face; and such a problem is further compounded by the fact that each person's face (or any other body part) is dimensionally unique as compared to other people and with respect to a single person those dimensions may change, even if just slightly, over that person's lifetime. For example, it would be unreasonable create a diecast mold for every body portion (e.g., face, hand, foot, etc.) of a given subject and it would be equally unreasonable to fill each such diecast mold with copper or the like, for each person that desires to have their face (or other body portion) heated or cooled. As such, solid materials for conductive heat transfer may be less than desirable to use as means for heating or cooling the particular body or portion of the body of the given animal subject.

In this respect, liquids may be a superior heat transfer medium, as a liquid may easily and readily physically touch all or most all of the skin of any subject's face or other body part. Liquids, such as, but not limited to, water are particularly useful for heat transfer, for heating something or for cooling something that may be direct physical contact with the given liquid, because of, at least in part, the liquid's fluidity, density, and/or heat capacity. Thus, liquids, such as, but not limited to, water may be useful in the application of thermal therapies, cryotherapies, and/or hydrotherapies with respect to treating and/or benefiting the given animal subject.

Further, the human face because of its various nerves and nerve endings, such as, but not limited to, the trigeminal nerve, may be an ideal target for directed heating and/or cooling. That is, the human face may be an ideal target for directed hydrotherapy, thermal therapy, and/or cryotherapy. And because liquids, such as, but not limited to, water, may be a desirable heat transfer medium for therapies and/or for cryotherapies, then it may be desirable to use heated or cooled liquid to physically touch the skin of the face to impart a given desired hydrotherapy, thermal therapy, and/or cryotherapy. Further still, it may be desired to target treating of the face (of the subject) in this manner, with a heater or cooled liquid, and to do without wetting any other portion of the subject's body. To accomplish that goal, it would be desirable to have a soaking device, that holds a volume of an immersion liquid, wherein that soaking device is configured to removably receive a face (or portion thereof) of the subject, lowered down into the immersion liquid.

However, lowering down of the face (or a portion thereof) of the subject, into the immersion liquid may create at least two problems to address. One, the subject cannot breathe if their mouth and nose is submerged within the immersion liquid. And two, bending one's head in a manner that only submerges the face (or a portion thereof) can create undesirable strain and/or pain in the neck of the subject and/or could result in a hard surface (e.g., an upper edge or rim of the soaking device) being pressed uncomfortably into the soft tissues of the front of the subject's neck.

It could be desirable for the subject to use a breathing-apparatus when their face (mouth and/or nose) is submerged within the immersion liquid.

It could be desirable to include a headrest with the soaking device to alleviate neck strain issues.

It could be desirable to implement a neck gasket into an upper edge and/or a rim of the soaking device to alleviate having any hard surfaces pressed uncomfortably into the soft tissues of the front of the subject's neck.

Additionally, since a liquid heat transfer medium is contemplated, it may be desirable to include a means for measuring, determining, and/or learning what the temperature of the immersion liquid within the soaking device might be. It may be desirable if the soaking device and/or an accessory of the soaking device included such a temperature sensing (and displaying) means.

Further, since a liquid heat transfer medium is contemplated, gas bubble therapy may also be simultaneously employed along with the hydrotherapy, thermal therapy, and/or cryotherapy, if a gas or gasses are released as bubbles into the immersion liquid within the soaking device. Thus, it may be desirable to include a gas source and/or a bubble emitting means with use of the soaking device.

Also, when the liquid heat transfer medium may be mostly (substantially) optically transparent and/or translucent, then light therapy may also be simultaneously employed along with the hydrotherapy, thermal therapy, and/or cryotherapy, by shining light(s) into the immersion liquid within the soaking device. Thus, it may be desirable to include a light source to be used with the soaking device.

Lastly, it may be desirable to design and manufacture such a soaking device that may be shipped in at least a partially disassembled configuration and/or as flat as possible configuration (e.g., to minimize necessary warehouse storage space and/or to keep shipping costs down), that may be easily and readily assembled at a destination location in a manner that results in a robust waterproof soaking device; and that also utilizes as few as possible of screws, bolts, rivets, nails, pins, staples, brads, tacks, dowels, biscuits, or the like mechanical fasteners with respect to generating the waterproofness.

There is a need in the art for such a soaking device that is configured to use a liquid for its immersion liquid.

See also the “Background of the Invention” section of the Specification of U.S. nonprovisional patent application Ser. No. 18/197,365 filed on May 15, 2023, the disclosure of which is incorporated herein by reference in its entirety.

It is to these ends that the present invention has been developed.

### BRIEF SUMMARY OF THE INVENTION

To minimize the limitations in the prior art, and to minimize other limitations that will be apparent upon reading and understanding the present specification, embodiments of the present invention may describe soaking-device, a system that comprises the soaking-device, or a kit that comprises the soaking-device. In some embodiments, a soaking-device may be usable to soak a given body part of a user. In some embodiments, the body part may be a face or a portion of the face of the user; but the body part could also be different from the face. In some embodiments, when the face (or portion thereof) is the targeted body part, then the soaking-device may be a face soaking-device. In some embodiments, the face soaking-device may also be known or referred to as a Hydroeffacer. In some embodiments, the user may be a person or other animal (such as, but not limited to, a primate, a mammal, or a vertebrate animal). In some embodiments, the soaking-device may comprise a vessel-subassembly. In some embodiments, the vessel-subassembly may comprise a wettable-subassembly (and at least an outermost-shell). In some embodiments, the wettable-subassembly itself and/or physical interaction of the wettable-subassembly with another part of the vessel-subassembly, the outermost-shell, may not utilize screws, bolts, rivets, nails, pins, staples, brads, tacks, dowels, biscuits, nor the like mechanical fasteners. In some embodiments, the wettable-subassembly (specifically its front-panel) may comprise a neck-gasket for removable physical contact with a neck portion of the user. In some embodiments, the wettable-subassembly may be configured to hold a volume of an immersion-liquid (without leaking) for the soaking of the body part. In some embodiments, prior to intended soaking use, the volume of the immersion-liquid may be heated or cooled away from and/or separately from the wettable-subassembly.

Because the volume of the immersion-liquid within the wettable-subassembly may be heated or cooled, the soaking-device may be use for various thermal therapies, hydrotherapies, cryotherapies, combinations thereof, and/or the like. Thus, the soaking-device may be a thermal delivery device.

In some embodiments, various additives may be added to the volume of the immersion-liquid within the wettable-subassembly. In some embodiments, a breathing-apparatus may be used by the user to breathe if and when a nose and/or a mouth of the user are submerged (immersed) within the immersion-liquid within the wettable-subassembly. In some embodiments, the soaking-device, the system, and/or the kit may comprise the breathing-apparatus. In some embodiments, a tower may be placed next to the wettable-subassembly to shine light into and/or to release (gas) bubbles into the immersion-liquid that is located within the wettable-subassembly. In some embodiments, a rear-panel of the wettable-subassembly may be at least substantially (mostly) transparent and/or translucent to permit at least some of the emitted light from the tower to pass through the rear-panel and into the immersion-liquid that is located within the wettable-subassembly. In some embodiments, a headrest-assembly may be used by the user to support a portion of the user's head (and/or face) during intended use of the soaking-device. In some embodiments, the soaking-device, the system, and/or the kit may comprise the headrest-assembly. In some embodiments, the headrest-assembly may be (removably) attachable to the vessel-subassembly (such as, but not limited to, to handles of the vessel-subassembly).

It is an objective of the present invention to provide a thermal delivery device.

It is another objective of the present invention to provide a soaking-device as the thermal delivery device.

It is another objective of the present invention to provide a thermal delivery device (such as, but not limited to, a soaking-device) that is capable of cooling and/or heating a targeted portion (such as, but not limited to, a face) of a subject (user) (such as, but not limited to, a living human).

It is another objective of the present invention to provide a thermal delivery device (such as, but not limited to, a soaking-device) that is capable of selectively cooling and/or heating a face, a head, or a portion thereof without (directly) cooling and/or heating a remainder of that subject's (user's) body.

It is another objective of the present invention to provide a thermal delivery device (such as, but not limited to, a soaking-device) that is capable of selectively cooling and/or heating a face, a head, or a portion thereof without wetting a remainder of that subject's (user's) body.

It is another objective of the present invention to provide a system and/or a kit for cooling and/or heating a targeted portion of a subject (user).

It is another objective of the present invention to provide a system and/or a kit for cooling and/or heating a targeted portion of a subject (user) that at least utilizes a thermal delivery device (such as, but not limited to, a soaking-device).

It is another objective of the present invention to provide a method for cooling and/or heating a targeted portion of a subject (user).

It is another objective of the present invention to provide a method for cooling and/or heating a targeted portion of a subject (user) that at least utilizes a thermal delivery device (such as, but not limited to, a soaking-device).

It is another objective of the present invention to provide a method of inducing a desired and/or intended outcome in a subject by cooling and/or heating a targeted portion of the subject (user) that at least utilizes a thermal delivery device (such as, but not limited to, a soaking-device).

It is another objective of the present invention to provide a method of inducing release of at least one type of neurotransmitter that results in a desired and/or intended outcome in a subject (user) by cooling and/or heating a targeted portion of the subject (user) that at least utilizes a thermal delivery device (such as, but not limited to, a soaking-device).

It is another objective of the present invention to provide a method of [indirectly] stimulating a vagus nerve of a human by stimulating a trigeminal nerve of the human, wherein the trigeminal nerve is stimulated, at least in part, by heating the trigeminal nerve, cooling the trigeminal nerve, or alternating between heating and cooling of the trigeminal nerve using a thermal delivery device (such as, but not limited to, a soaking-device).

It is another objective of the present invention to provide a method of causing release of at least one type of neurotransmitter in an animal by, at least in part, heating a portion of the subject (animal), cooling the portion, or alternating between heating and cooling of the portion using a thermal delivery device (such as, but not limited to, a soaking-device).

It is another objective of the present invention to provide a method of transdermal delivery of at least one chemical across a portion of skin by applying the at least one chemical to an exterior portion of the skin and by, at least in part, heating the portion of the skin, cooling the portion of the skin, or alternating between heating and cooling of the portion of the skin using a thermal delivery device (such as, but not limited to, a soaking-device).

It is another objective of the present invention to provide a method of improving a region of treated skin by using a thermal delivery device on that region of skin.

It is another objective of the present invention to provide a thermal delivery device (such as, but not limited to, a soaking-device) that may be used recreationally and/or to relax.

It is another objective of the present invention to provide a soaking-device that is configured for the immersion/soaking of particular body portion(s), such as, but not limited to, the face (or head) of a person, but without having hard surfaces press into the soft tissues of a front of the neck of that person.

It is another objective of the present invention provide a soaking-device that is configured to warm, heat, cool, chill, combinations thereof, portions thereof, and/or the like, the particular body portion(s) that may be soaking/immersed within an immersion liquid of the soaking-device.

It is another objective of the present invention to make much (most) of the soaking-device from largely (mostly and/or mainly) off-the-shelf planar sheet materials, that may be subsequently formed, cut, bent, and/or machined into various components (parts) of the soaking-device.

It is another objective of the present invention to provide a soaking-device with a wettable-subassembly, wherein parts (components) of the wettable-subassembly do not require nor utilize screws, bolts, rivets, nails, pins, staples, brads, tacks, dowels, biscuits, or the like mechanical fasteners.

It is another objective of the present invention wherein physical interaction of the wettable-subassembly with another part of a vessel-subassembly, an outermost-shell, may not utilize screws, bolts, rivets, nails, pins, staples, brads, tacks, dowels, biscuits, nor the like mechanical fasteners.

It is another objective of the present invention wherein the wettable-subassembly of the soaking-device may have no electronics.

It is another objective of the present invention to provide a soaking-device, a system, and/or a kit that may further comprise a tower.

It is another objective of the present invention wherein the tower may have all of the electronics.

It is yet another objective of the present invention wherein the tower may be configured to shine light into and/or to release (gas) bubbles into an immersion-liquid that is located within the wettable-subassembly of the soaking-device.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is top-down perspective view of a user (person) using a soaking-device according to at least one embodiment.

FIG. 2A is a front and top perspective view of a soaking-device (without showing the user) according to at least one embodiment (shown with a headrest assembly in a raised configuration).

FIG. 2B is a front and top perspective view of a soaking-device (without showing the user) according to at least one embodiment (shown with a headrest assembly in a lowered [immersed] configuration).

FIG. 2C is a front, top, and right-side perspective view of a soaking-device (without showing the user) according to at least one embodiment (shown with a headrest assembly in a lowered [immersed] configuration).

FIG. 2D is a right-side, top, and partial rear (back) perspective view of a soaking-device (without showing the user) according to at least one embodiment (shown with a headrest assembly in a raised configuration).

FIG. 3A is a front, right-side, and bottom perspective view of a vessel-subassembly, of a soaking-device, according to least one embodiment.

FIG. 3B is a rear (back), right-side, and bottom perspective view of a vessel-subassembly, of a soaking-device, according to least one embodiment.

FIG. 3C is a rear (back) and top perspective view of a vessel-subassembly, of a soaking-device, according to least one embodiment.

FIG. 4A shows a front and top perspective of a vessel-subassembly with a neck-gasket and a wedge removed from a front-panel of the vessel-subassembly.

FIG. 4B is a closeup view of FIG. 4A focusing on a neck-gasket-channel of the front-panel of the vessel-subassembly.

FIG. 5A is a front and top perspective view of a portion of the front-panel (of the vessel-subassembly), showing how a bottom of a neck-gasket may be inserted into (or removed from) the neck-gasket-channel of the front-panel.

FIG. 5B is a front and top perspective view of a portion of the front-panel (of the vessel-subassembly), showing the bottom of the neck-gasket at least partially inserted into the neck-gasket-channel of the front-panel.

FIG. 5C is a front and top perspective view of a portion of the front-panel (of the vessel-subassembly), showing the bottom of the neck-gasket completely, fully, and/or entirely inserted into the neck-gasket-channel of the front-panel.

FIG. 6A is a front and top perspective view of a portion of the front-panel (of the vessel-subassembly), showing how a bottom of a wedge (clamp) may be inserted into (or removed from) the neck-gasket-channel of the front-panel.

FIG. 6B is a front and top perspective view of a portion of the front-panel (of the vessel-subassembly), showing the bottom of the wedge (clamp) at least partially inserted into the neck-gasket-channel of the front-panel.

FIG. 6C is a front and top perspective view of a portion of the front-panel (of the vessel-subassembly), showing the bottom of the wedge (clamp) at least mostly inserted into the neck-gasket-channel of the front-panel.

FIG. 7A is a front perspective view of a neck-gasket in a disassembled configuration, according to at least one embodiment.

FIG. 7B is a perspective view of at least one component (part) of a neck-gasket, showing its flexibility.

FIG. 7C is a perspective view of at least one component (part) of a neck-gasket, showing removal of a backing that covers an adhesive (or the like).

FIG. 7D is a perspective view showing how two components (parts) of a neck-gasket may be attached to each other.

FIG. 7E is a front perspective view of a neck-gasket in an assembled configuration, according to at least one embodiment.

FIG. 7F is a partial front and a partial right-side perspective view of a soaking-device, in intended use by a user (person), that shows how a front-of-the-neck of the user is in removable physical contact with at least a portion of the neck-gasket during this intended use.

FIG. 8A is a perspective view of a neck-gasket and of a wedge (clamp).

FIG. 8B is a perspective view of the wedge (clamp).

FIG. 9A is partial front, a partial top, and a left-side perspective view of a soaking-device and/or of a vessel-subassembly, showing how a handle may be removed (or attached).

FIG. 9B is partial front, a partial top, and a left-side perspective view of a soaking-device and/or of a vessel-subassembly, showing how a thermal-break may be removed (or attached).

FIG. 9C is partial front and a partial left-side perspective view of a soaking-device and/or of a vessel-subassembly, showing how and/or where a handle is attached to a side-panel-portion.

FIG. 9D is a top perspective view showing two handle assemblies, side-by-side, in disassembled configurations.

FIG. 9E is partial front, a top, and a partial right-side perspective view of a soaking-device and/or of a vessel-subassembly, showing how a handle and/or a thermal-break may be removed (or attached).

FIG. 9F is partial front, a top, and a partial right-side perspective view of a soaking-device and/or of a vessel-subassembly, showing how a handle and/or a thermal-break may be removed (or attached).

FIG. 9G is a perspective end view of a given handle, shown by itself, showing a (end) profile and a channel (track) of that given handle.

FIG. 9H is a closeup view of FIG. 9G, showing the channel (track) and how article(s) and/or mating-member(s) may be inserted into that channel (track).

FIG. 9I is a perspective end view of a given handle, shown by itself, showing the channel (track) and how article(s) and/or mating-member(s) may be inserted into that channel (track).

FIG. 10A is a partial top, a partial front, and a right-side perspective view showing how a vessel-subassembly may be assembled (or disassembled) (e.g., by separating an outermost-shell from a wettable-subassembly).

FIG. 10B is a partial front and a top perspective view showing how the wettable-subassembly may be lifted out from the outermost-shell.

FIG. 10C is a partial right-side and a partial top perspective view showing how the wettable-subassembly may be lifted out from the outermost-shell.

FIG. 11A is a partial perspective view of the outermost-shell (also referred to as an integral-outermost-sidewall-and-bottom), shown by itself, according to at least one embodiment.

FIG. 11B is a perspective view of the outermost-shell, shown by itself, according to at least one embodiment.

FIG. 11C is yet another perspective view of the outermost-shell, shown by itself, according to at least one embodiment.

FIG. 12A is a front and a top perspective view of the wettable-subassembly, shown by itself, according to least one embodiment.

FIG. 12B is a partial front and a partial top perspective view of the wettable-subassembly, shown by itself, according to least one embodiment.

FIG. 12C is a rear (back) and a top perspective view of the wettable-subassembly, shown by itself, according to least one embodiment.

FIG. 12D is a bottom rear perspective view of the wettable-subassembly, shown in a process of installing (or removing) insulation from a bottom of a wettable-floor-and-sidewalls.

FIG. 12E is a bottom rear perspective view of the wettable-subassembly, shown with the insulation installed.

FIG. 13A is an inside, interior, and/or internal perspective view of the front-panel (of the soaking-device, the vessel-subassembly, or of the wettable-subassembly), shown by itself, according to least one embodiment.

FIG. 13B is an outside, exterior, and/or external perspective view of the front-panel, shown by itself, according to least one embodiment.

FIG. 14A is an inside, interior, and/or internal perspective view of the rear-panel (of the soaking-device, the vessel-subassembly, or of the wettable-subassembly), shown by itself, according to least one embodiment.

FIG. 14B is an outside, exterior, and/or external perspective view of the rear-panel, shown by itself, according to least one embodiment.

FIG. 15A is a perspective view of a wettable-floor-and-sidewalls (of the soaking-device, the vessel-subassembly, or of the wettable-subassembly), shown by itself, according to least one embodiment.

FIG. 15B is another perspective view of the wettable-floor-and-sidewalls, shown by itself, according to least one embodiment.

FIG. 16A is partial perspective view showing how an end-gasket is attached to a terminal-end of the wettable-floor-and-sidewalls.

FIG. 16B is partial perspective view showing an end-gasket attached to a terminal-end of the wettable-floor-and-sidewalls.

FIG. 16C is a partial perspective view of the end-gasket, according to at least one embodiment.

FIG. 16D is a partial perspective view of the end-gasket, showing a receiving-channel of the end-gasket, according to at least one embodiment.

FIG. 17A is partial front, a partial right-side, and a top perspective view of the soaking-device shown with a breathing-apparatus.

FIG. 17B is a perspective view of the breathing-apparatus, according to at least one embodiment.

FIG. 17C is a side perspective view of the breathing-apparatus, according to at least one embodiment.

FIG. 17D is a rear (back) perspective view of the breathing-apparatus, according to at least one embodiment.

FIG. 17E is a top perspective view of the breathing-apparatus, shown in a disassembled configuration.

FIG. 17F is a side perspective view of the breathing-apparatus being used and/or being worn by a user (person).

FIG. 17G is a perspective view showing a user (person) using and/or wearing the breathing-apparatus before immersing at least a portion of a head and/or of a face of the user (person) within an immersion-liquid being held within the soaking-device (within the vessel-subassembly or within the wettable-subassembly).

FIG. 17H is a perspective view showing the user (person) using and/or wearing the breathing-apparatus while the at least the portion of the head and/or of the face of the user (person) is immersed within the immersion-liquid being held within the soaking-device (within the vessel-subassembly or within the wettable-subassembly).

FIG. 18A is a top and a front perspective view of a tower, shown by itself, wherein the tower may be used with the soaking-device.

FIG. 18B is a top, a front, and a right-side perspective view of the tower, shown by itself, according to at least one embodiment.

FIG. 18C is a rear (back) and a right-side perspective view of the tower, shown by itself, according to at least one embodiment.

FIG. 18D is a rear (back) perspective view of the tower, shown by itself, according to at least one embodiment.

FIG. 19 is a schematic block diagram showing at least some possible electronics of the tower, according to at least one embodiment.

FIG. 20 may be a schematic block diagram showing how volume(s) of an immersion-liquid, before being poured into the wettable-subassembly of the soaking device, may be heated or cooled, and then after such heating or cooling, the volume(s) of the immersion-liquid (that are now heated or cooled) may be poured into the wettable-subassembly.

### REFERENCE NUMERAL SCHEDULE

100 soaking-device 100
101 wettable-floor-and-sidewalls 101
102 vessel-subassembly 102
103 front-panel 103
104 wettable-subassembly 104
105 rear-panel 105
106 integral-outermost-sidewall-and-bottom (outermost-shell) 106
107 side-panel-portion 107
113 bottom-panel-portion 113
115 insulation 115
123 rabbet (inset-shelf or inset-ledge) 123
180 immersion-liquid 180
190 user (animal, human, or person) 190
191 head 191
192 face 192
193 back-of-neck 193
195 hand 195
197 front-of-neck 197
199 ear 199
201 neck-gasket-channel 201
203 top 203
205 cutout region 205
250 (gas) bubbles 250
306 capture-surface (retention-surface) 306
500 neck-gasket 500
501 flexible-member 501
503 rigid-member 503
505 adhesive 505
507 backing 507
600 wedge (clamp) 600
601 prong 601
701 internal (interior) surface 701
703 slot 703
705 channel (channel-for-end-gasket) 705
715 aperture 715
719 channel (channel-for-end-gasket) 719
811 external (exterior) surface 811
903 top 903
1001 top side 1001
1003 bottom side 1003
1005 left side 1005
1007 right side 1007
1101 floor-portion 1101
1103 sidewall-portion 1103
1105 top-ledge 1105
1107 terminal end 1107
1109 upper-surface 1109
1111 bottom-surface 1111
1200 end-gasket 1200
1201 receiving-channel 1201
1300 handle 1300
1301 top-portion 1301
1303 downward-protecting-portion (flange) 1303
1305 aperture 1305
1307 fastener 1307
1309 thermal-break 1309
1311 ascender-portion 1311
1400 slot (track) 1400
1401 opening 1401
1403 enclosed-region 1403
1405 terminal-end-edge 1405
1407 mating-member 1407
1700 breathing-apparatus 1700
1701 rigid-elongate-hollow-member (semi-rigid-elongate-hollow-member) 1701
1703 flexible-elongate-hollow-member 1703
1705 mouthpiece 1705
1707 fitting 1707
1709 aperture 1709
1800 headrest (headrest assembly) 1800
1821 bracket(s) 1821
2000 pitcher 2000
2001 cooling-means 2001
2003 heating-means 2003
2700 tower 2700
2701 user-interface 2701
2703 housing 2703
2705 handle 2705
2707 temperature-sensor 2707
2709 gas-line-tubing 2709
2710 bubble-emitter 2710
2711 main-power-cable 2711
2721 controller 2721
2723 light-source 2723
2725 gas-source (compressor or solenoid to gas cylinder) 2725
2727 screen 2727
2729 power 2729

Note, at least some of the above called out reference numerals used in this present (instant) patent application are also used in U.S. nonprovisional patent application Ser. No. 18/197,365 filed on May 15, 2023, by the same inventor; wherein the entire disclose of patent application Ser. No. 18/197,365 is included herein by reference.

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

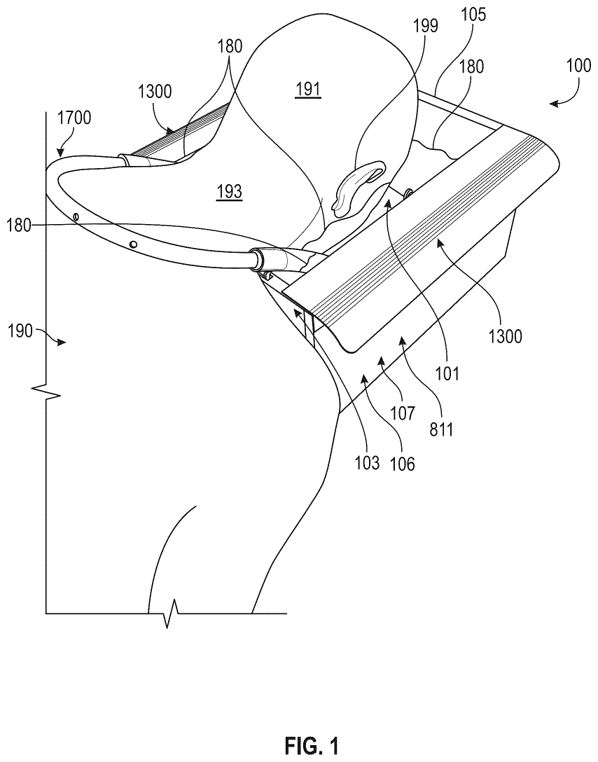

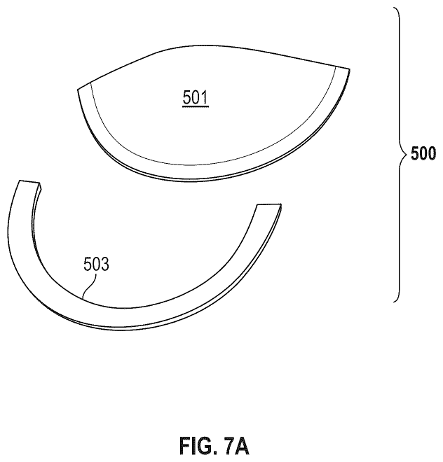

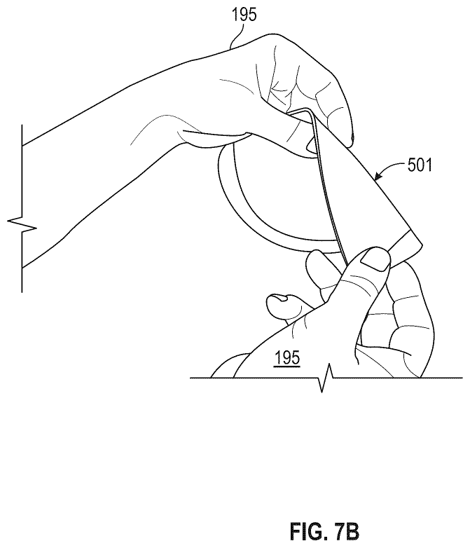

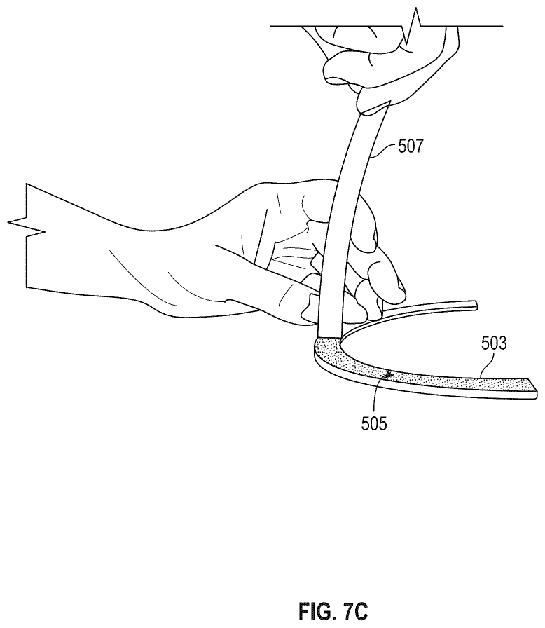

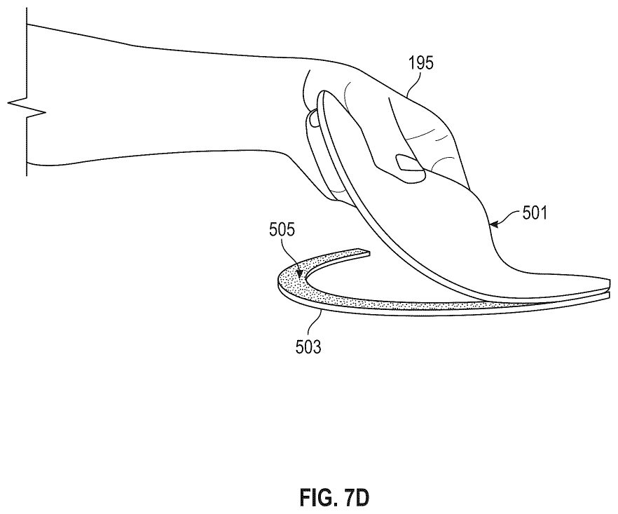

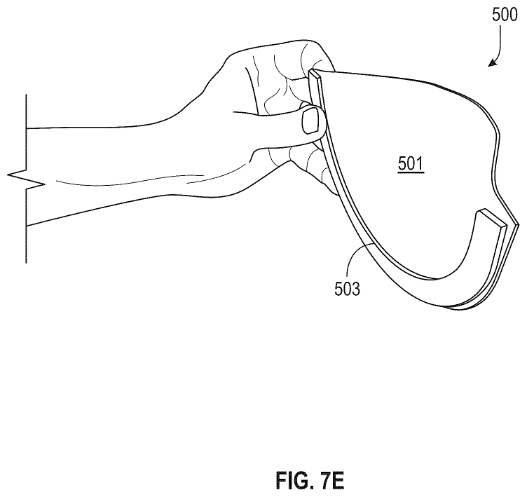

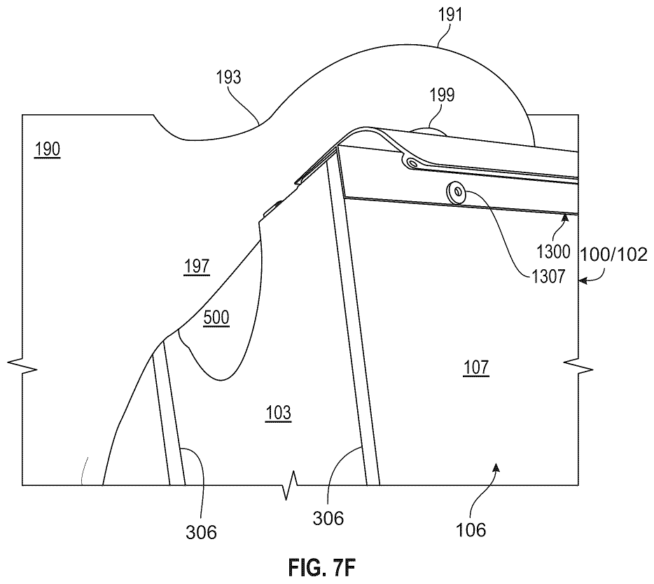

FIG. 1 shows a front, top, and right-side perspective view of an overall assembled soaking-device 100 (shown without tower 2700), in use by a human user 190, with a face 192 of the user 190 immersed (submerged) within an immersion-liquid 180 of a vessel of soaking-device 100. In some embodiments, when soaking-device 100 may in use as intended by user 190, such as is shown in FIG. 1, a back-of-neck 193 (closest to neck vertebrae) (of user 190) may not be touching a neck-gasket 500 of soaking-device 100, whereas, at least some of a front-of-neck 197 (further from the neck vertebrae) (of user 190) may be in direct physical contact with at least some portions of neck-gasket 500 (flexible-member 501) of soaking-device 100 (see FIG. 7F for front-of-neck 197). Compare for example, FIG. 1 to FIG. 7F. FIG. 1 shows back-of-neck 193 not touching neck-gasket 500, whereas, FIG. 7F shows at least some of front-of-neck 197 in direct physical contact with at least some portions of neck-gasket 500 (flexible-member 501). One ear 199 of user 190 may be visible in FIG. 1A portion of this ear 199 of user 190 may be just partially visible in FIG. 7F. Some embodiments, of soaking-device 100 may be a face soaking device.

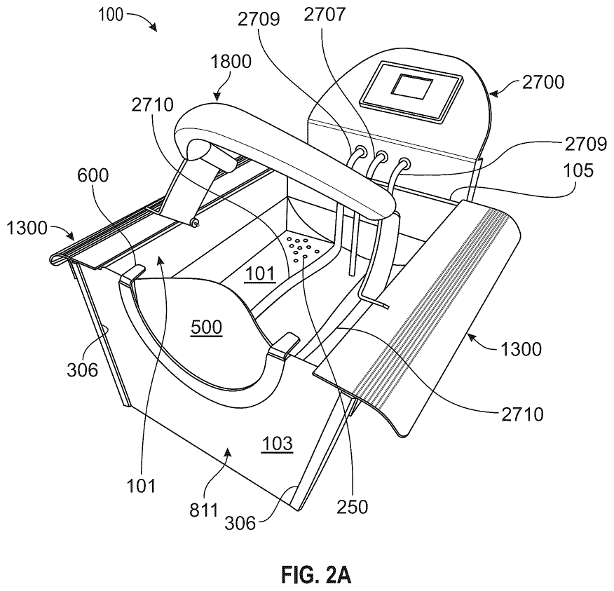

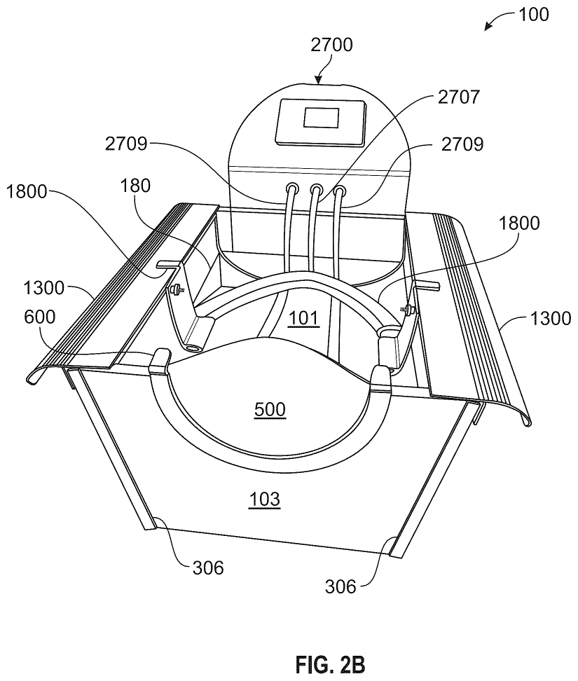

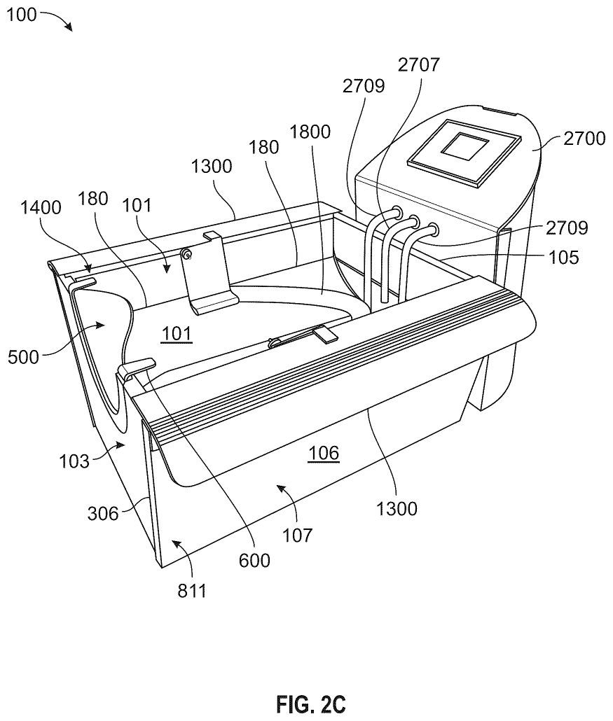

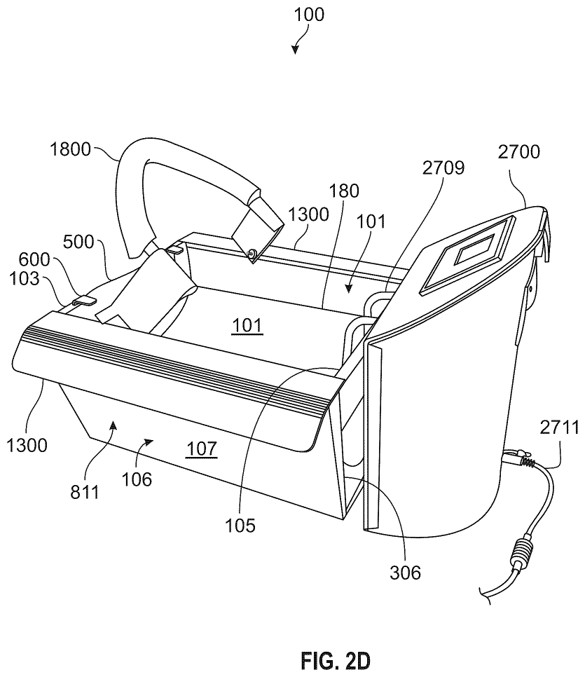

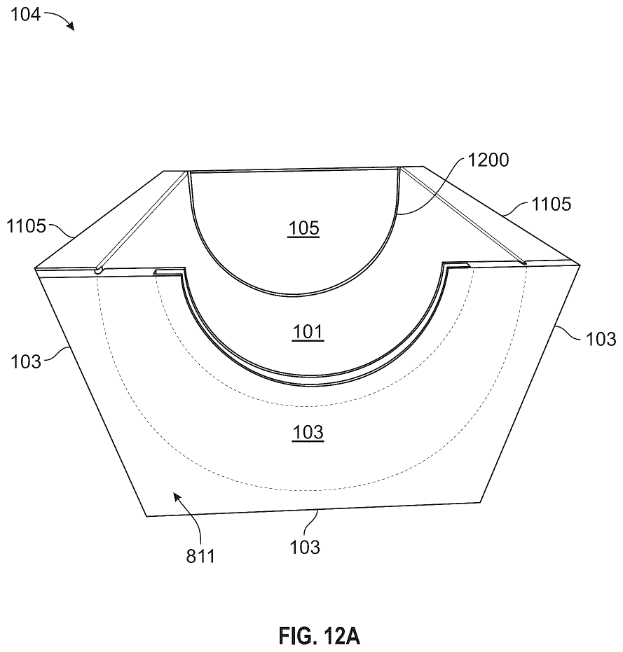

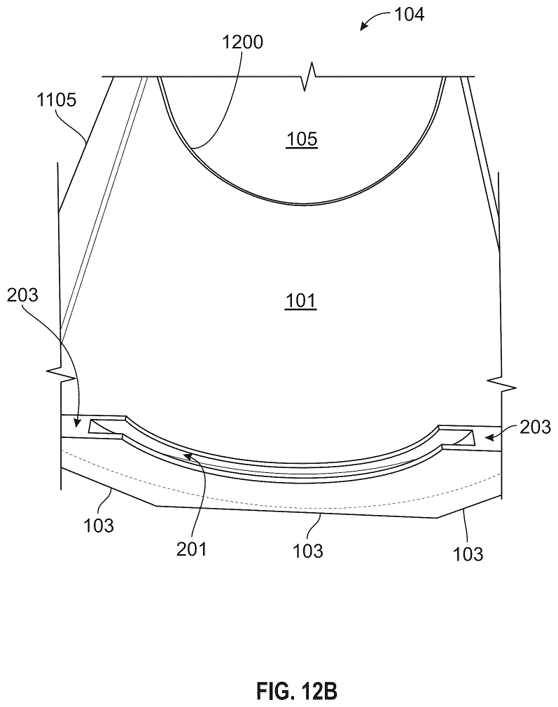

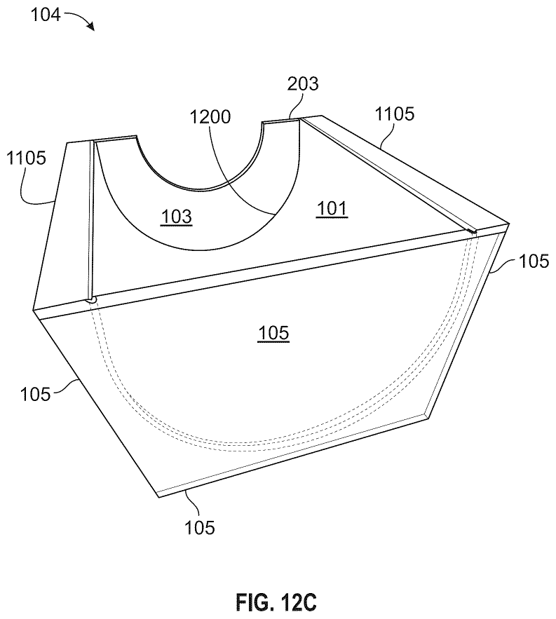

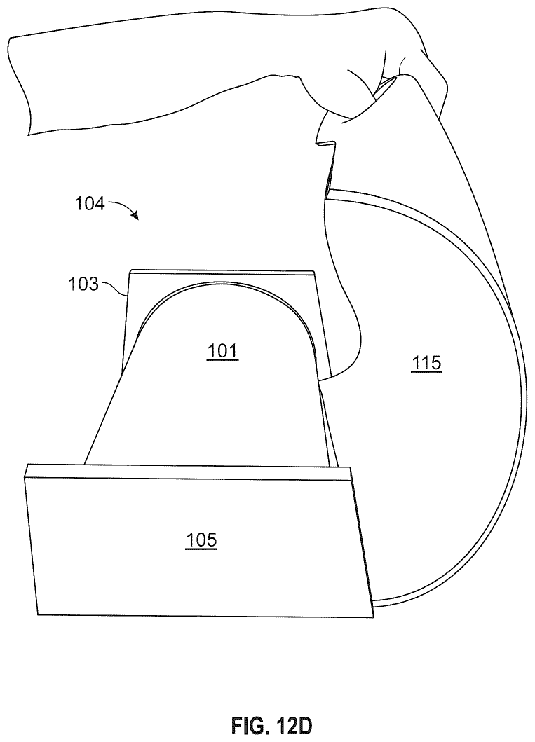

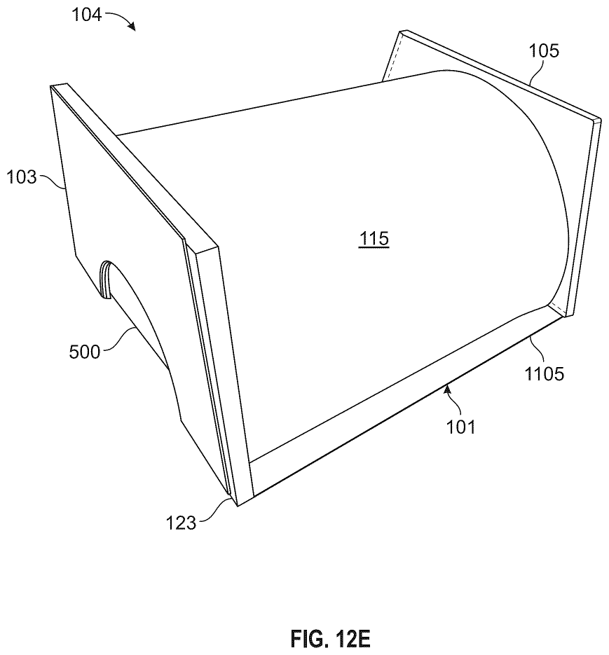

Continuing discussing FIG. 1, in some embodiments, soaking-device 100 may be configured to (temporarily) hold an immersion-liquid 180 (such as, but not limited to, water [with or without additives]) above a wettable-floor portion of a wettable-floor-and-sidewalls 101 component, between a wettable-sidewalls portion of the wettable-floor-and-sidewalls 101 component and between a front-panel 103 and a rear-panel 105 of soaking-device 100 (rear-panel 105 is first shown in FIG. 2D). In some embodiments, the front-panel 103 and the rear-panel 105 may be opposing from each other, with a length of the wettable-floor-and-sidewalls 101 disposed between front-panel 103 and rear-panel 105. In some embodiments, front-panel 103 may be distinguished from rear-panel 105, because front-panel 103 may have or may comprise neck-gasket 500 and/or because at least some of rear-panel 105 may be optically transparent (and/or translucent). In some embodiments, rear-panel 105 may have not nor comprise neck-gasket 500. In some embodiments, because wettable-floor-and-sidewalls 101 front-panel 103, and rear-panel 105 may be configured to hold this immersion-liquid 180 without leaking, those particular components (parts) may collaboratively work together in forming a watertight (water proof) vessel configured to hold this immersion-liquid 180, wherein that vessel may be wettable-subassembly 104. Thus, the wettable-floor-and-sidewalls 101, the front-panel 103, and the rear-panel 105 may define a waterproof vessel (container) (for holding this immersion-liquid 180) that is open at its top that is wettable-subassembly 104, as shown in FIG. 1. See also, FIG. 12A, FIG. 12B, and/or FIG. 12C that also shows these configurations and/or arrangements of the wettable-floor-and-sidewalls 101, the front-panel 103, and the rear-panel 105 of soaking-device 100 that when assembled (as intended) may form this waterproof vessel (container) of wettable-subassembly 104 that is open at its top. In some embodiments, wettable-subassembly 104 may comprise: wettable-floor-and-sidewalls 101, front-panel 103, and rear-panel 105. In some embodiments, wettable-subassembly 104 may be configured to house, hold, and/or retain at least some volume of immersion-liquid 180 in a manner that is free from leaking that volume of immersion-liquid 180.

Continuing discussing FIG. 1 in some embodiments, immersion-liquid 180 may be the direct physical medium that at least one body part, body portion, combinations thereof, portion thereof, and/or the like of the user 190 (subject 190) is submerged into within wettable-subassembly 104. In some embodiments, immersion-liquid 180 may be enhanced by heating and/or cooling of immersion-liquid 180 (see e.g., FIG. 20 and its discussion); and/or by including one or more additives to immersion-liquid 180. In some embodiments, immersion-liquid 180 may be a primary heat transfer medium used to heat and/or cool the at least one body part, body portion, combinations thereof, portion thereof, and/or the like of the user 190 (subject 190), with respect to given volume of immersion-liquid 180 within wettable-subassembly 104. In some embodiments, at least most of immersion-liquid 180 may be comprised of water. Note, discussions of “immersion-liquid 180” from U.S. nonprovisional patent application Ser. No. 18/197,365 filed on May 15, 2023, may be applicable to embodiments of this present patent application.

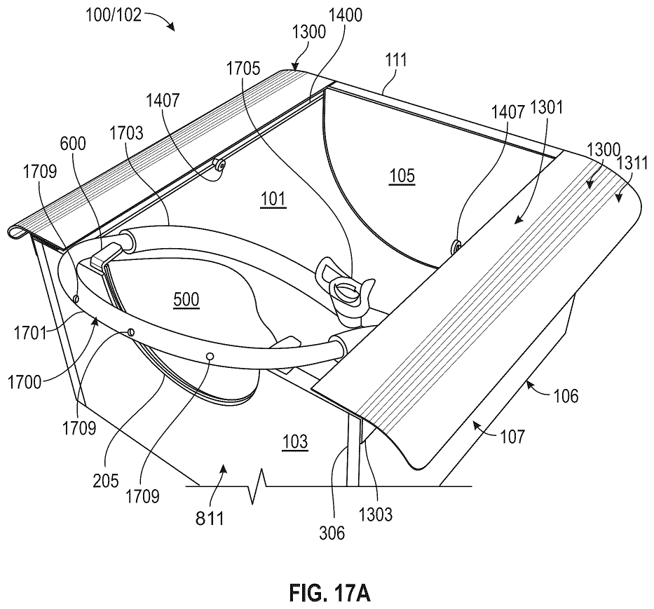

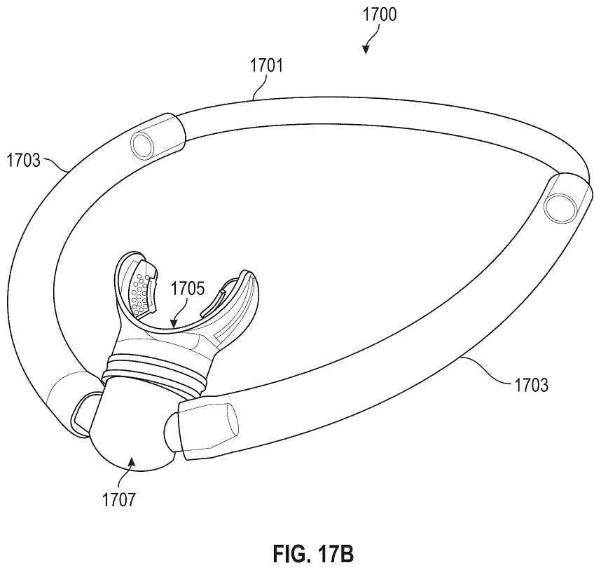

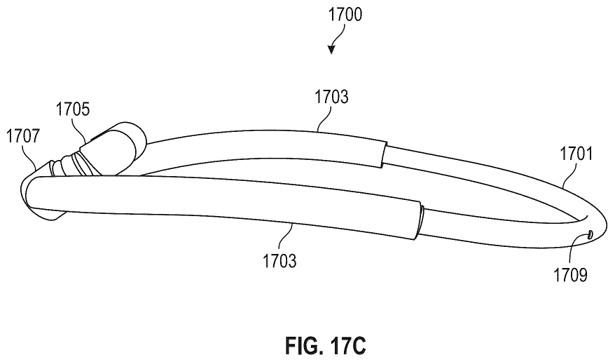

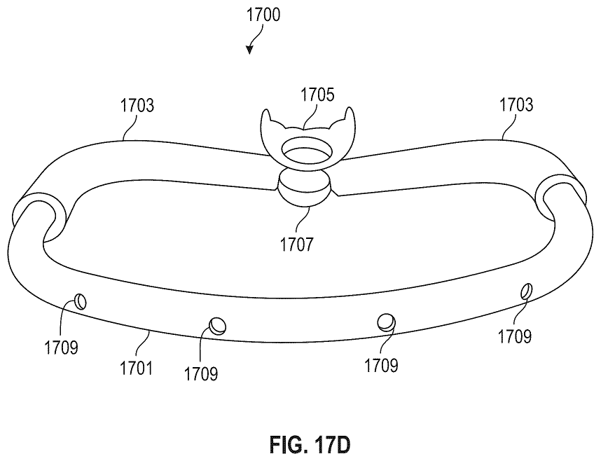

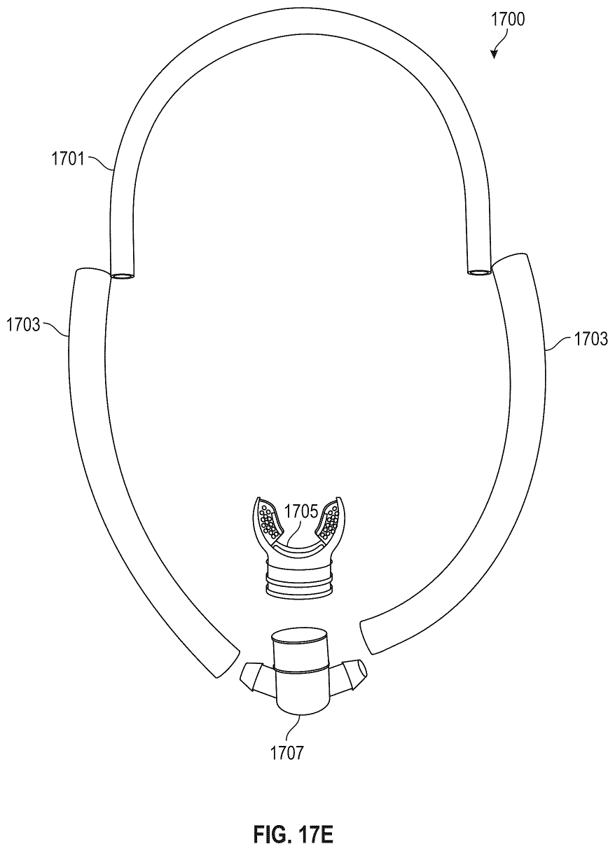

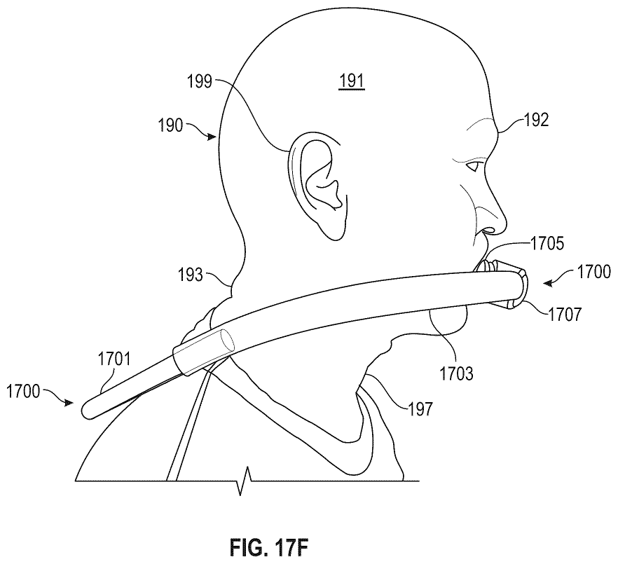

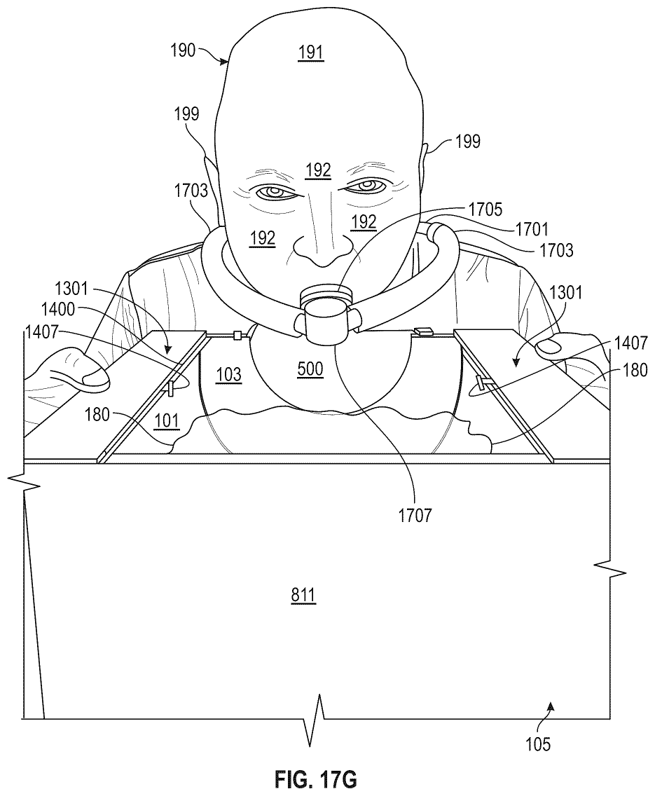

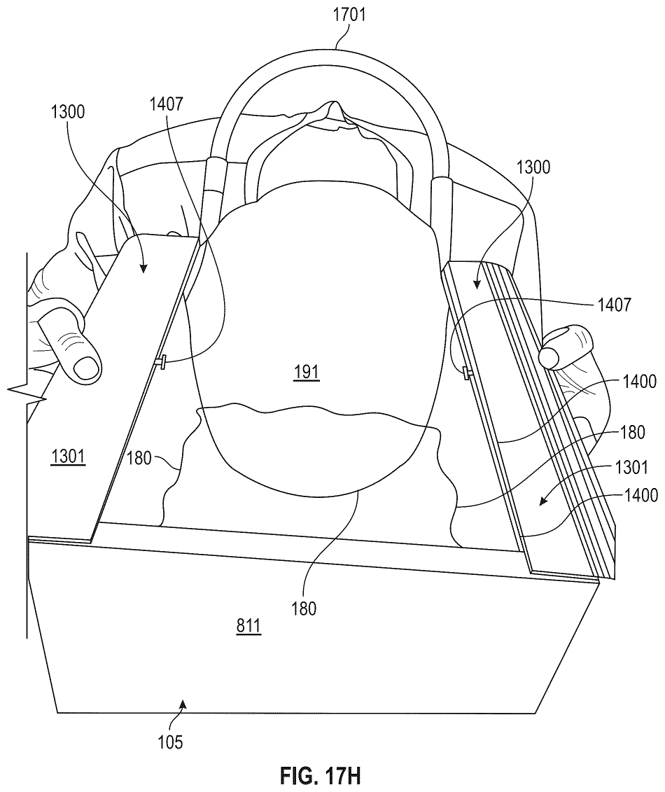

Continuing discussing FIG. 1, in some embodiments, immersion-liquid 180 may also be referred to as a liquid (or slurry, mud, gel, or the like) because immersion-liquid 180 may be used to immerse (submerge) at least one body part, body portion, combinations thereof, portion thereof, and/or the like of the user 190 (e.g., within wettable-subassembly 104, when wettable-subassembly 104 is holding at least some immersion-liquid 180). For example, and without limiting the scope of the present invention, this at least one body part, body portion, combinations thereof, portion thereof, and/or the like of the user 190 as shown in FIG. 1 may be a face 192 of user 190, a portion of face 192 of user 190, and/or a portion of a head 191 of user 190. Note, face 192 of user 190 may be at least partially shown in FIG. 17F and/or in FIG. 17G. In some embodiments, immersion-liquid 180 within this vessel (wettable-subassembly 104) of soaking-device 100 may be heated, cooled, chilled, combinations thereof, portions thereof, and/or the like.

In some embodiments, immersion-liquid 180 within this vessel of soaking-device 100 may have various predetermined additives added to the liquid (water), such as, but not limited to: salts, ions, minerals, electrolytes, chemicals, medicines, pharmaceuticals, botanicals, essential oils, fragrances, perfumes, soaps, surfactants, cleaners, moisturizers, cosmetics, shampoos, conditioners, lotions, muds, gels, ointments, other liquids, solids, particulates, combinations thereof, portions thereof, and/or the like.

In some embodiments, an animal 190 body part (or portion thereof) may be soaked within this immersion-liquid 180 that is being (temporarily) hold within the vessel portion of soaking-device 100. In some embodiments, animal 190 may be selected from a vertebrate animal, a mammalian animal, a primate animal, or a human. In some embodiments, the body part of animal 190 may be selected from head 191, a face 192, a hand 195, a foot, an arm, a leg, combinations thereof, portions thereof, and/or the like. In some embodiments, reference numeral “190” may refer to the user of soaking-device 100 who is and/or intends to have a body portion soaked (immersed) within the vessel portion (wettable-subassembly 104) of soaking-device 100 (that may have some volume of immersion-liquid 180); wherein this user 190 may be selected from a vertebrate animal, a mammalian animal, a primate animal, or a human.

FIG. 1 also shows concurrent use of a breathing-apparatus 1700. In some embodiments, when a mouth and/or a nose of user 190 may be submerged (immersed) within immersion-liquid 180 of the vessel portion (wettable-subassembly 104) of soaking-device 100, the breathing-apparatus 1700 may be used by that user 190, so that user 190 may continue to breathe while concurrently having their face 192 (mouth and/or their nose) completely (entirely) submerged within the volume of immersion-liquid 180 being held in wettable-subassembly 104. Note, breathing-apparatus 1700 is further shown in FIG. 17A through FIG. 17H and is further discussed in the discussion of those figures.

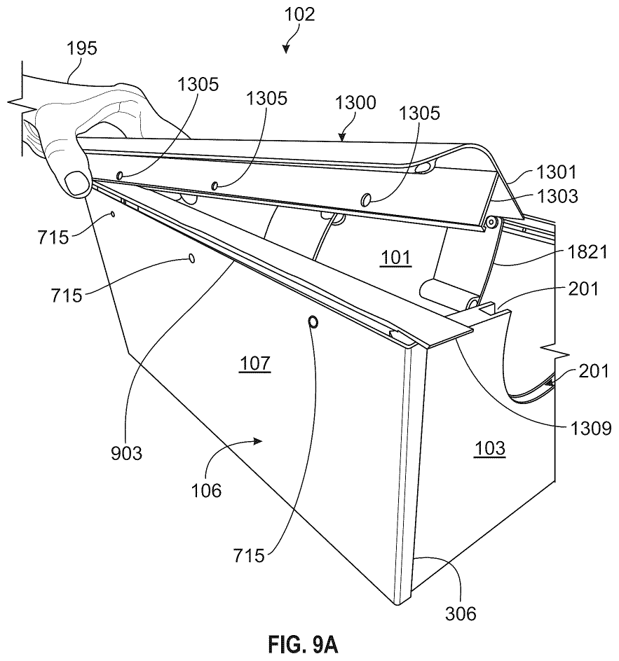

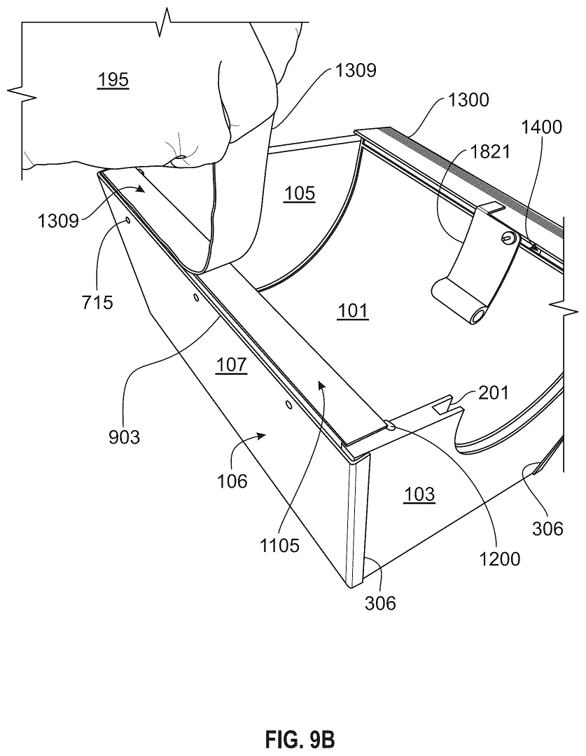

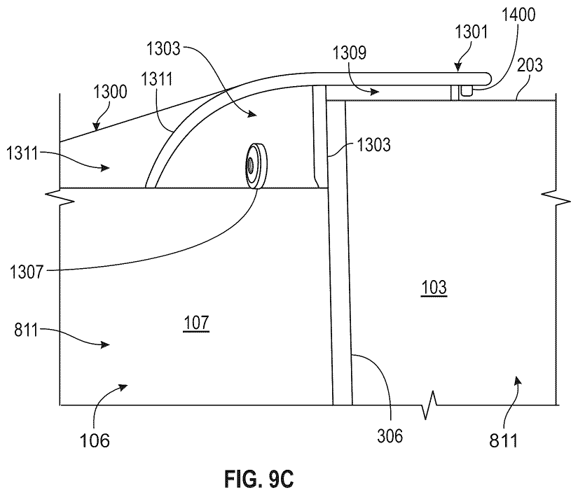

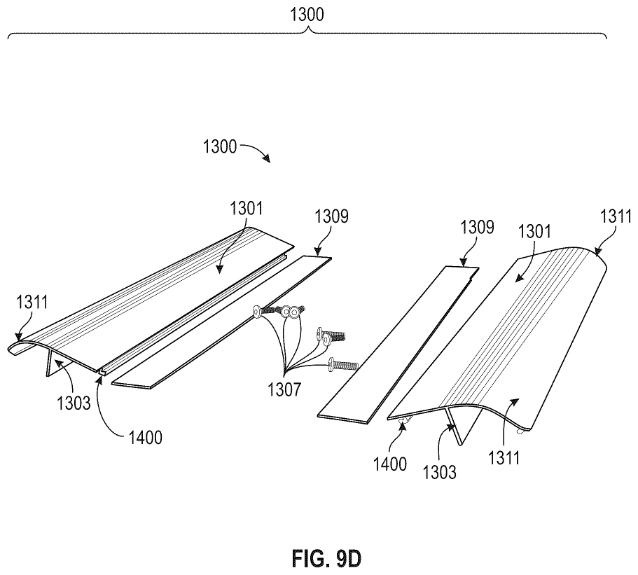

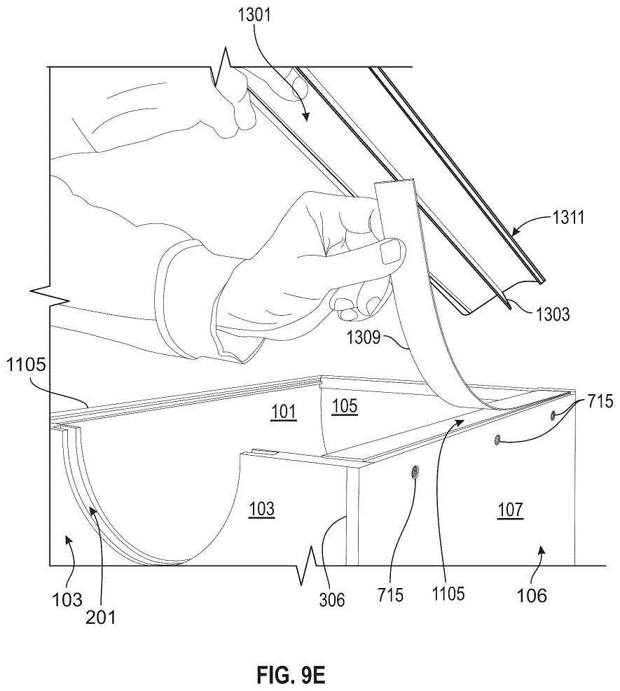

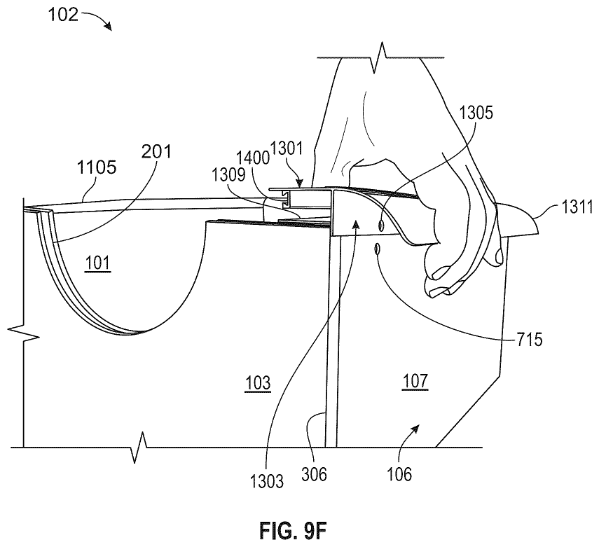

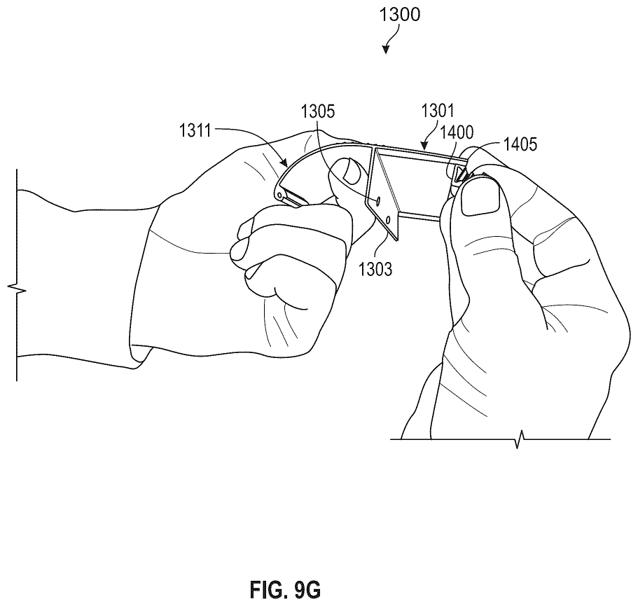

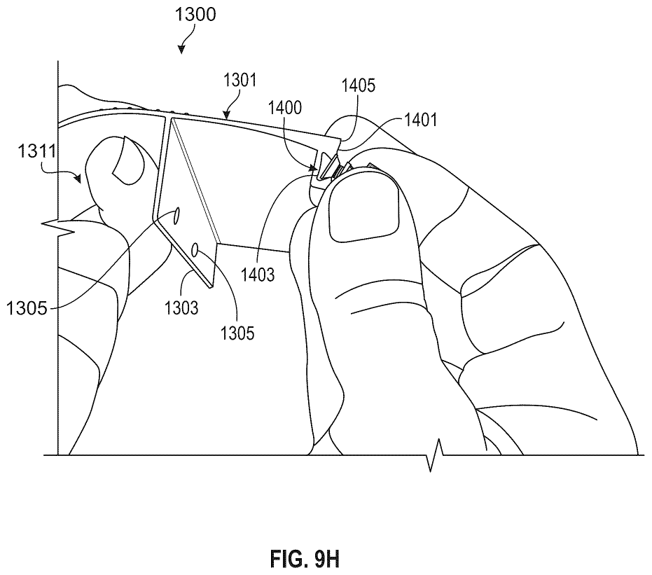

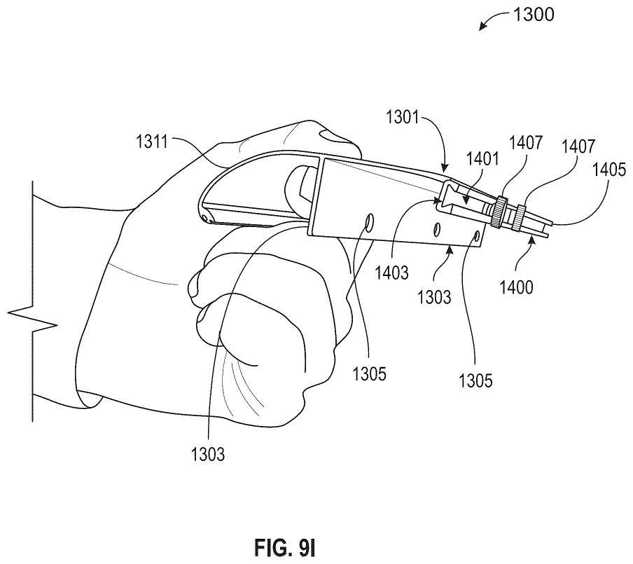

FIG. 1 also shows handles 1300 of soaking-device 100. In some embodiments, handles 1300 may be configured for user 190 to hold and/or be used to carry soaking-device 100, with or without immersion-liquid 180 within the vessel portion of soaking-device 100. Note, handles 1300 are further shown in FIG. 9A through FIG. 9I and is further discussed in the discussion of those figures.

FIG. 2A shows a top front perspective view of soaking-device 100 FIG. 2B shows another top front perspective view of soaking-device 100, from a different viewing angle as compared to FIG. 2A. FIG. 2C shows a top front and side (right-side) perspective view of soaking-device 100. FIG. 2D shows a top rear (back) and side (right-side) perspective view of soaking-device 100, without showing user 190 FIG. 2A, FIG. 2B, FIG. 2C, and FIG. 2D also omit showing user 190. FIG. 2D shows a portion of rear-panel 105. Additionally, a head-rest (assembly) 1800 and tower 2700 are also shown in FIG. 2A, FIG. 2B, FIG. 2C, and FIG. 2D. Note, head-rest (assembly) 1800 was thoroughly shown and discussed in U.S. nonprovisional patent application Ser. No. 18/197,365 filed on May 15, 2023, the disclosure of which is incorporated herein by reference in its entirety (patent application Ser. No. 18/197,365 is by the same inventor as the present [instant] patent application). Head-rest (assembly) 1800 may be used by user 190 when a portion is rotated to be within wettable-subassembly 104 and/or within immersion-liquid 180 to provide a load bearing structural support for a portion of the head 191, the face 192, and/or other body portion of user 190, when that user 190 may be using soaking-device 100 as intended to soak their given body portion within immersion-liquid 180. For example, head-rest (assembly) 1800 is shown in its rotated out of immersion-liquid 180 configuration (and/or out of wettable-subassembly 104 configuration) in FIG. 2A and in FIG. 2D; whereas, FIG. 2B and FIG. 2C show that same head-rest (assembly) 1800 in its rotated down into the immersion-liquid 180 configuration (in wettable-subassembly 104 configuration).

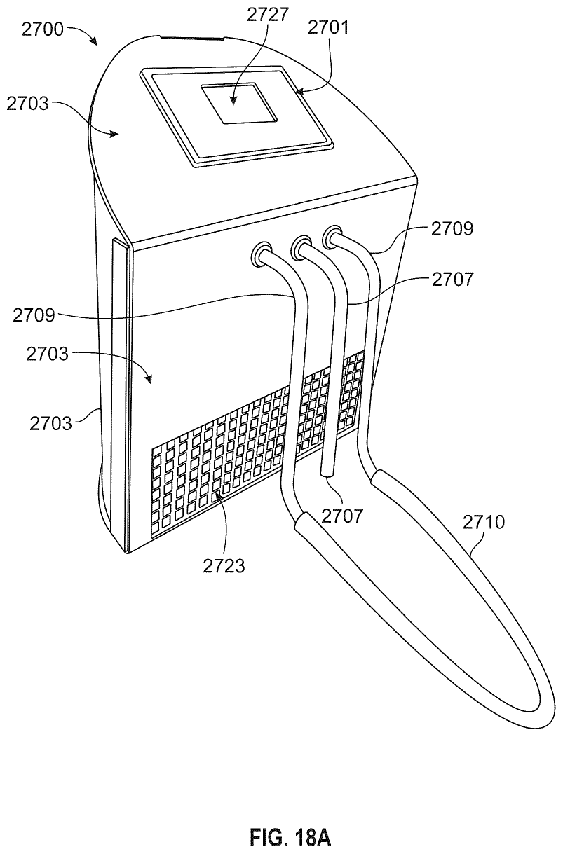

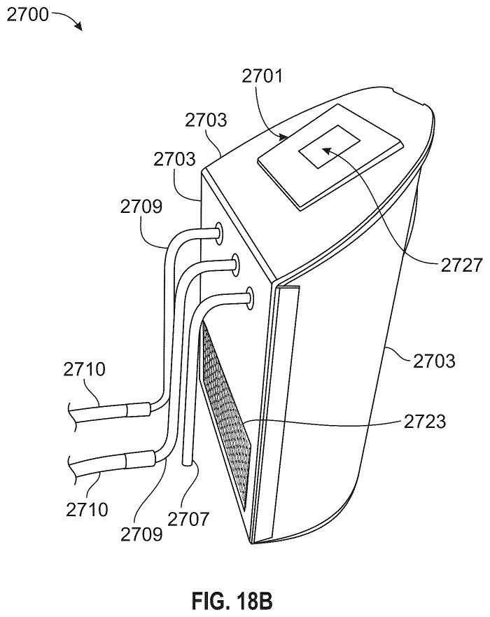

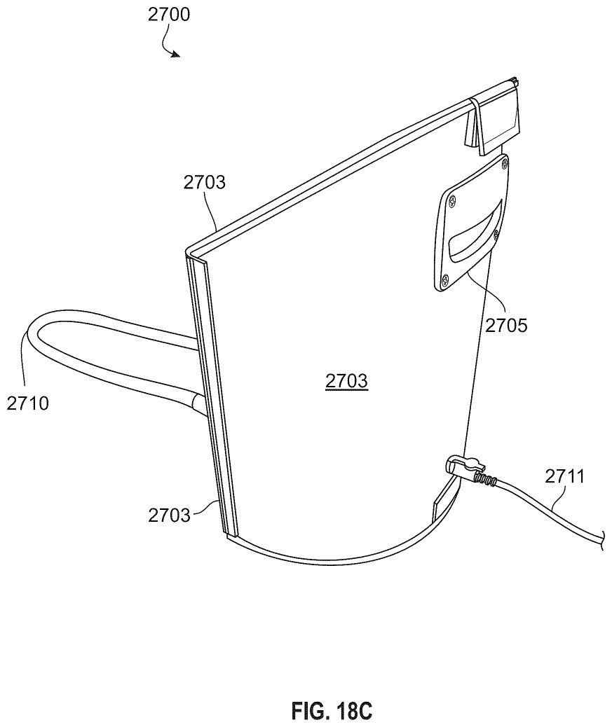

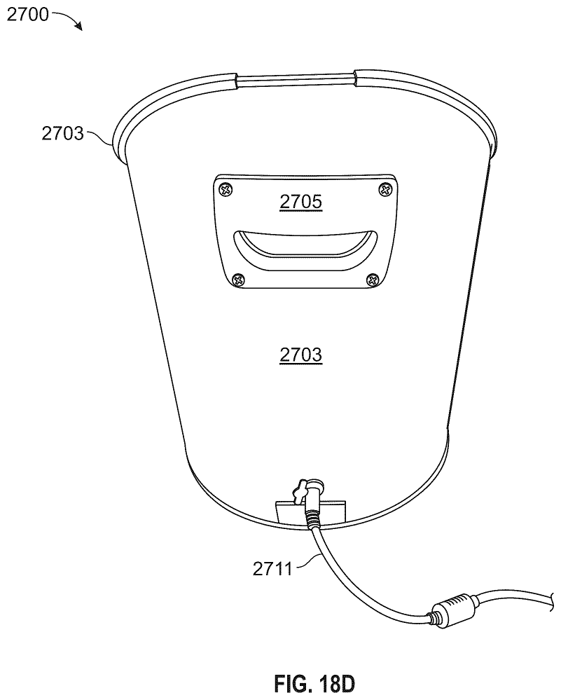

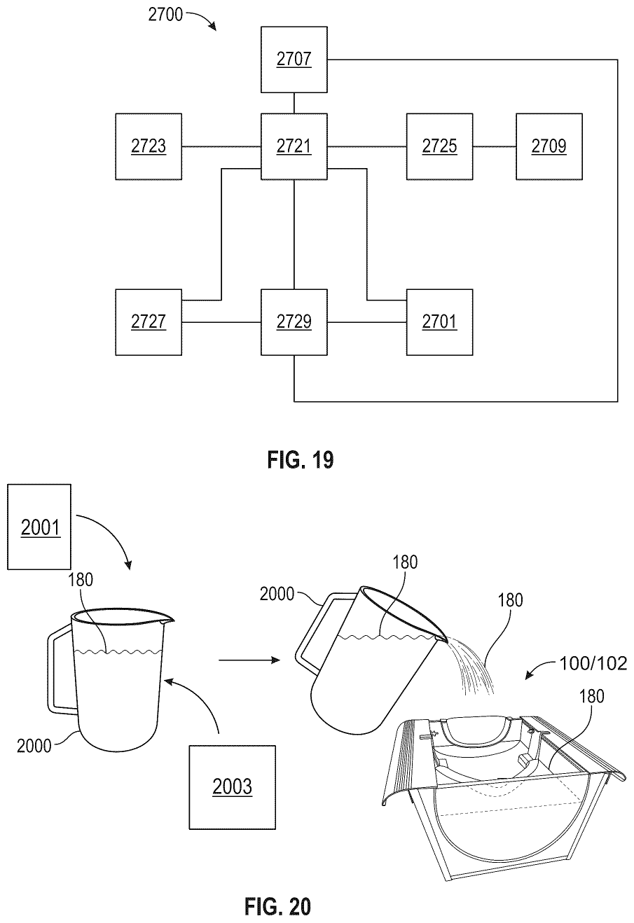

Continuing discussing FIG. 2A, FIG. 2B, FIG. 2C, and FIG. 2D, in some embodiments, tower 2700 may provide various enhancements to a user 190 intended use of soaking-device 100, such as, but not limited to, providing a means to shine light into wettable-subassembly 104 and/or to providing a means of adding bubbles to immersion-liquid 180 within wettable-subassembly 104. Tower 2700 is further shown in FIG. 18A, FIG. 18B, FIG. 18C, and FIG. 18D; and electronics of tower 2700 are shown in a schematic block diagram in FIG. 19.

Further, FIG. 2A shows a portion of a bubble-emitter 2710 removably located within the volume of immersion-liquid 180 within wettable-subassembly 104, which may be emitting bubbles 250 into the volume of immersion-liquid 180 within wettable-subassembly 104. In this manner, soaking-device 100 may be used for bubble therapy. In some embodiments, bubble-emitter 2710 may be operatively connected to gas-line-tubing 2709, which may be operatively connected to gas-source 2725, wherein gas-source 2725 may be a component and/or controlled by tower 2700, see e.g., FIG. 18A and FIG. 19. Gas-source 2725 may not be shown directly in FIG. 2A, but in some embodiments, at least some portion of gas-source 2725 (e.g., when a gas compressor and/or a gas pump) may reside within tower 2700. See FIG. 19 for gas-source 2725.

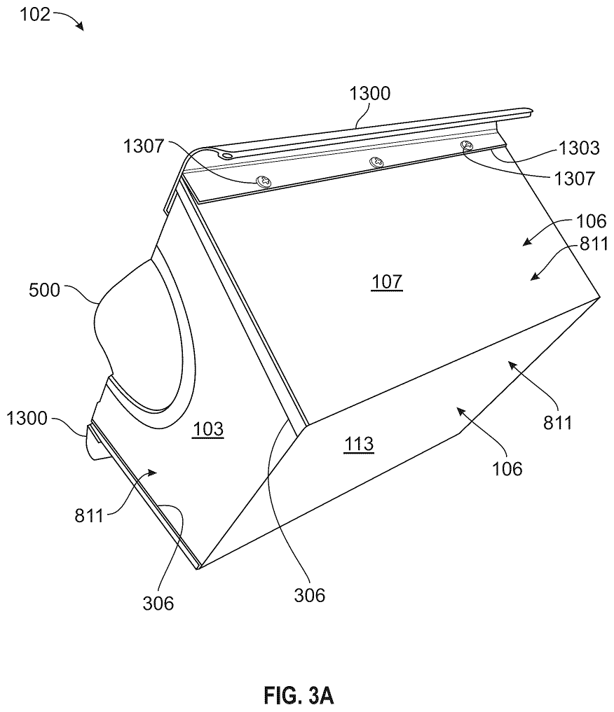

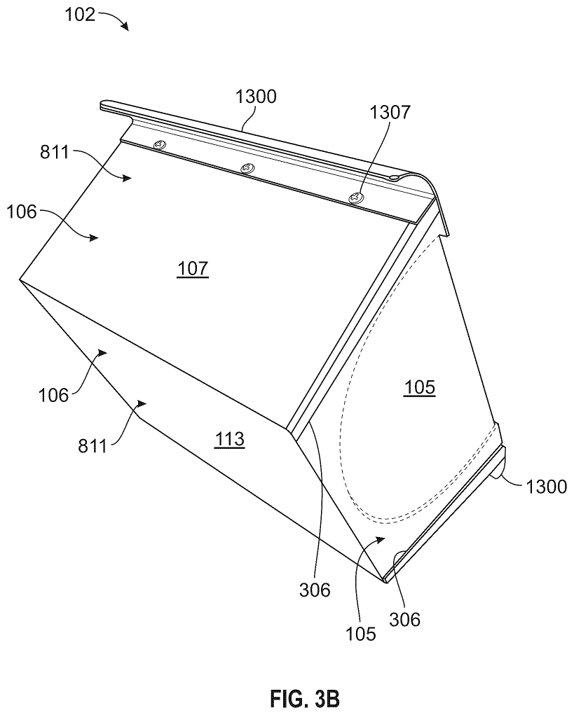

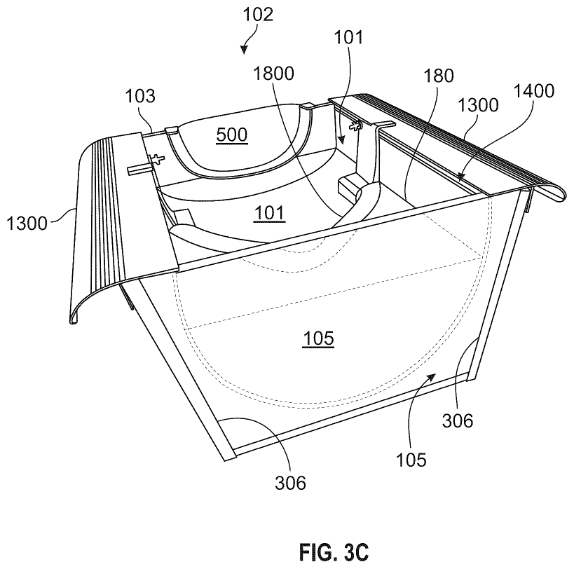

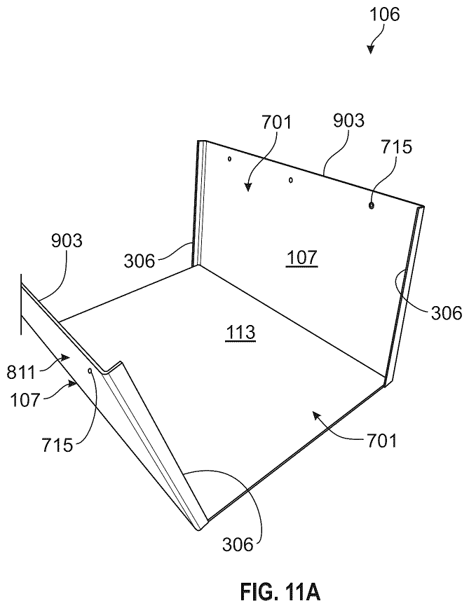

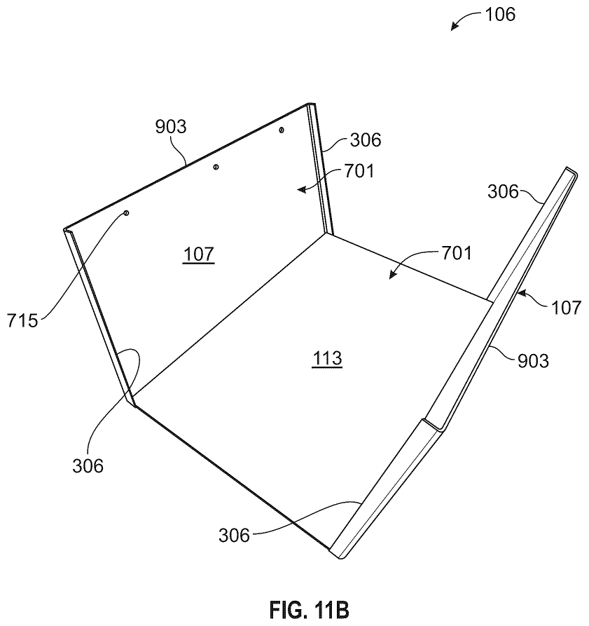

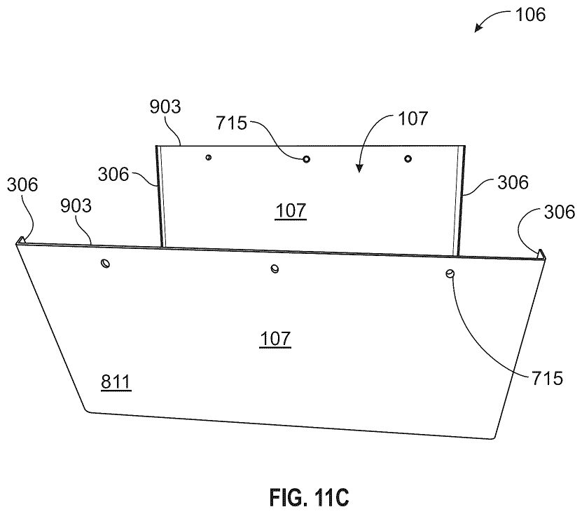

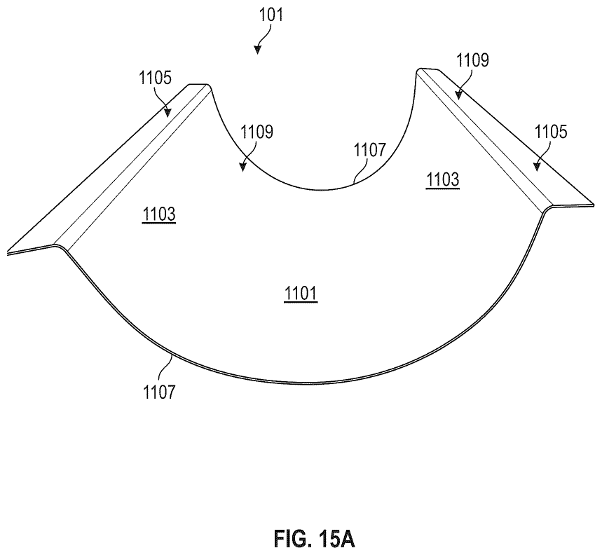

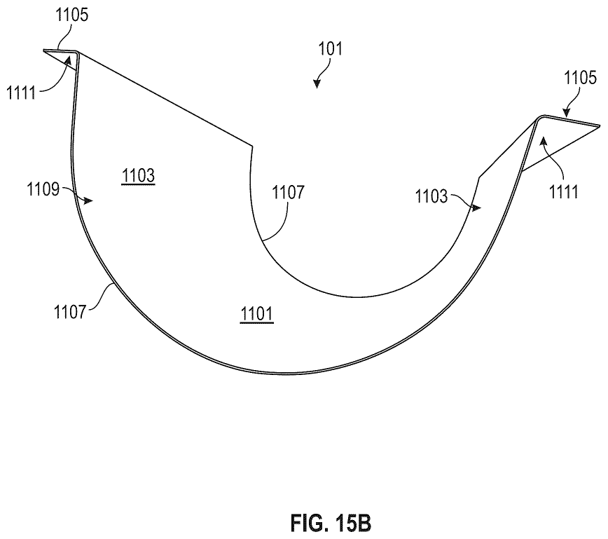

FIG. 3A shows a bottom, front, and side (right-side) perspective view of the vessel-subassembly 102 of soaking-device 100. FIG. 3B shows a bottom, rear (back), and side (right-side) perspective view of the vessel-subassembly 102 of soaking-device 100. FIG. 3C shows a top rear (back) perspective view of the vessel-subassembly 102 of soaking-device 100. Tower 2700 and user 190 are omitted in FIG. 3A, FIG. 3B, and FIG. 3C. In some embodiments, vessel-subassembly 102 may comprise wettable-subassembly 104 and integral-outermost-sidewall-and-bottom 106 (also referred to as outermost-shell 106). In some embodiments, vessel-subassembly 102 may comprise wettable-subassembly 104, outermost-shell 106, and handle(s) 1300. In some embodiments, vessel-subassembly 102 may comprise wettable-subassembly 104, outermost-shell 106, handle(s) 1300, and a means to attach handle(s) 1300 to outermost-shell 106 (such as, but not limited to, fastener [s] 1307). In some embodiments, when wettable-subassembly 104 is fitted within opposing capture-surfaces 306 of outermost-shell 106, that fit may be friction and/or a press fit., because a linear length of outermost-shell 106 may be predetermined, fixed, finite, non-variable, and sized to fit the overall predetermined, fixed, finite, and non-variable length of wettable-subassembly 104 between those opposing capture-surfaces 306. In some embodiments, when wettable-subassembly 104 is fitted within opposing capture-surfaces 306 (retention-surfaces 306) of outermost-shell 106, then vessel-subassembly 102 may be formed. In some embodiments, when wettable-subassembly 104 is fitted within opposing capture-surfaces 306 of outermost-shell 106 and when handle(s) 1300 are attached to outermost-shell 106, then vessel-subassembly 102 may be formed. In some embodiments, when vessel-subassembly 102 is assembled as intended, the opposing capture-surfaces 306 of outermost-shell 106 may exert opposing compressive forces upon front-panel 103 and upon rear-panel 105, such that front-panel 103 and rear-panel 105 are squeezed against opposing terminal end edges of wettable-floor-and-sidewalls 101, that as such may help to make wettable-subassembly 104 leak proof (or be without leaks). In some embodiments, outermost-shell 106 may be comprised of three main flat and/or planar sections of: two opposing side-panel-portions 107 and one bottom-panel-portion 113. In some embodiments, the two side-panel-portions 107 and the one bottom-panel-portion 113 may be all integral and of a single article of manufacture. In some embodiments, bottom-panel-portion 113 may be disposed between the two side-panel-portions 107. In some embodiments, bottom-panel-portion 113 may be integrally attached to the two side-panel-portions 107. In some embodiments, side-panel-portions 107 may form the exterior most sidewall portions of vessel-subassembly 102 and/or of soaking-device 100. In some embodiments, bottom-panel-portion 113 may form the exterior most bottom portion of vessel-subassembly 102 and/or of soaking-device 100. In some embodiments, outermost-shell 106 may be comprise side-panel-portions 107, bottom-panel-portion 113, and capture-surfaces 306 In some embodiments, outermost-shell 106, side-panel-portions 107, bottom-panel-portion 113, and/or capture-surfaces 306 may not be intended to be waterproof nor to hold and/or retain a liquid (such as, but not limited to, immersion-liquid 180 and/or water); however, during normal use of soaking-device 100, at least some portions of outermost-shell 106, side-panel-portions 107, bottom-panel-portion 113, and/or capture-surfaces 306 may be occasionally get wet from some splashing, dripping, or the like. In some embodiments, the capture-surfaces 306 may located at at least some of opposing terminal ends of side-panel-portions 107 and/or of bottom-panel-portion 113. In some embodiments, outermost-shell 106 may be made from sheet metal. In some embodiments, a single sheet of metal may be folded and/or bent into shape to become outermost-shell 106 with its two side-panel-portions 107, its one bottom-panel-portion 113, and its capture-surfaces 306. Outermost-shell 106 may be shown by itself in FIG. 11A, FIG. 11B, and FIG. 11C. In some embodiments, wettable-floor-and-sidewalls 101 may be made from sheet metal. Wettable-floor-and-sidewalls 101 may be shown by itself in FIG. 15A and FIG. 15B.

Note, in contrast to outermost-shell 106 in this present (instant) patent application where its regions side-panel-portions 107 and bottom-panel-portion 113 are merely different regions of the same single integral article of manufacture; the side-panel(s) 107 and the bottom-panel 113 in U.S. nonprovisional patent application Ser. No. 18/197,365 filed on May 15, 2023, are not integral with each other, but are instead entirely separate and distinct parts (components) from each other; and the side-panel(s) 107 and the bottom-panel 113 of U.S. nonprovisional patent application Ser. No. 18/197,365 may utilize mechanical fasteners for attachment to front-panel 103 and/or rear-panel 105.

Continuing discussing FIG. 3A, FIG. 3B, and FIG. 3C, in some embodiments, there may be no mechanical fasteners (such as, but not limited to, screws, bolts, nails, brads, staples, rivets, pins, dowels, biscuits, or the like) used between front-panel 103 and outermost-shell 106. In some embodiments, there may be no mechanical fasteners (such as, but not limited to, screws, bolts, nails, brads, staples, rivets, pins, dowels, biscuits, or the like) used between front-panel 103 and side-panel-portion 107. In some embodiments, there may be no sealants, glues, adhesives, epoxies, welds, or the like used between front-panel 103 and outermost-shell 106. In some embodiments, there may be no seal ants, glues, adhesives, epoxies, welds, or the like used between front-panel 103 and side-panel-portion 107. In some embodiments, there may be no mechanical fasteners (such as, but not limited to, screws, bolts, nails, brads, staples, rivets, pins, dowels, biscuits, or the like) used between rear-panel 105 and outermost-shell 106. In some embodiments, there may be no mechanical fasteners (such as, but not limited to, screws, bolts, nails, brads, staples, rivets, pins, dowels, biscuits, or the like) used between rear-panel 105 and side-panel-portion 107. In some embodiments, there may be no sealants, glues, adhesives, epoxies, welds, or the like used between rear-panel 105 and outermost-shell 106. In some embodiments, there may be no sealants, glues, adhesives, epoxies, welds, or the like used between rear-panel 105 and side-panel-portion 107.

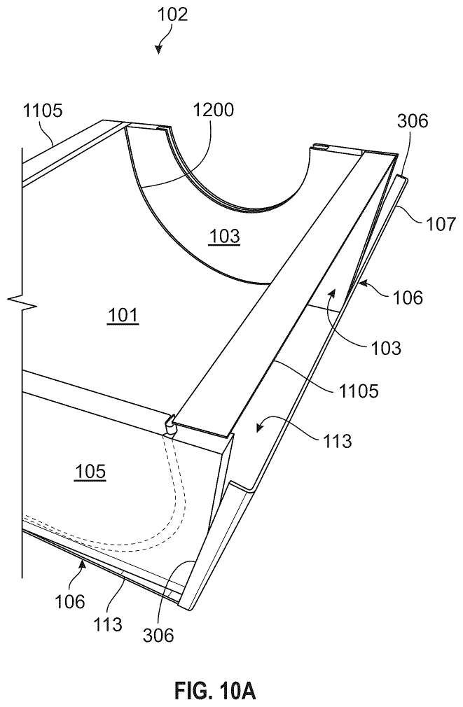

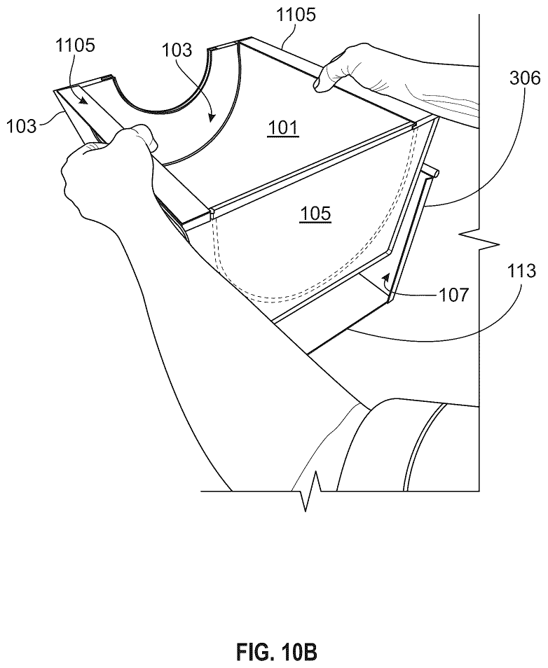

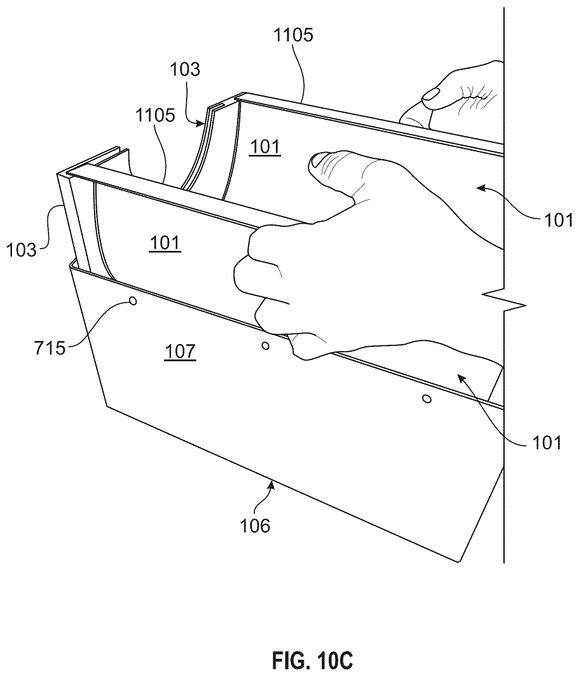

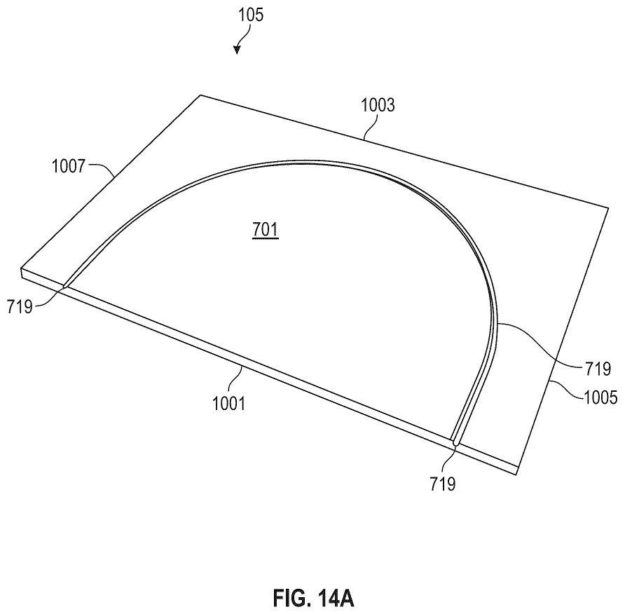

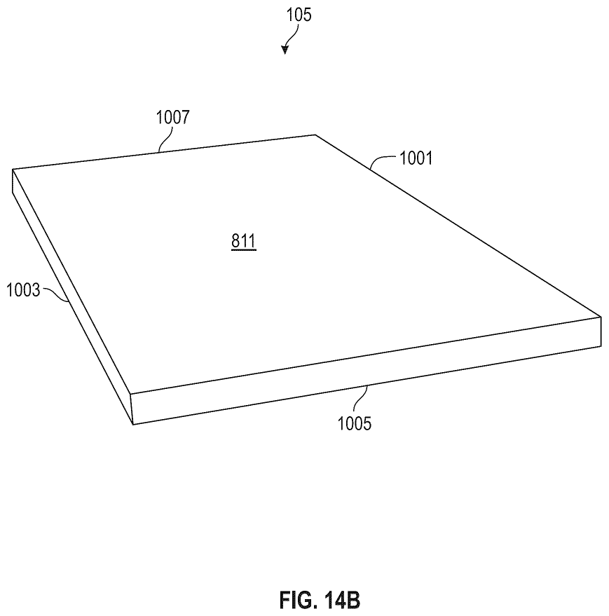

With respect to FIG. 3B and FIG. 3C, note, some exterior views of rear-panel 105 (or a portion thereof) show it interior surface 701 located channel-for-end-gasket 719 (for gasket 1200), of rear-panel 105, drawn in broken lines (shown in a “U,” “C,” semi-circle, or the like shape) to indicate that at least some portions of rear-panel 105 may be at least substantially (mostly) transparent and/or translucent with respect to light shined out from light-source 2723 of tower 2700. See e.g., FIG. 3B, FIG. 3C, FIG. 10A, FIG. 10B, and FIG. 12C for these broken lines of channel-for-end-gasket 719. Note, reference numerals 701 and 719 are explicitly shown (called out) in FIG. 14A, the internal (interior) view of rear-panel 105 shown by itself. See FIG. 18A and FIG. 19 for tower 2700 and light-source 2723. Reference numeral “701” may in general refer to surfaces of soaking-device 100, vessel-subassembly 102 and/or wettable-subassembly 104 that are interiorly oriented and/or interiorly facing; whereas, in contrast, reference numeral “811” may in general refer to surfaces of soaking-device 100, vessel-subassembly 102 and/or wettable-subassembly 104 that are externally (exteriorly) oriented and/or facing externally (exteriorly).

FIG. 3C also shows a portion of the level height of immersion-liquid 180 behind rear-panel 105 in broken lines to again demonstrate that at least some portion of rear-panel 105 may be transparent and/or translucent with respect to light emitted by light-source 2723 (of tower 2700). Similarly, in FIG. 3C a portion of headrest assembly 1800 that is behind rear-panel 105 is also thus shown in broken lines. In some embodiments, at least some portion of rear-panel 105 may be transparent and/or translucent with respect to light emitted by light-source 2723 (of tower 2700). In some embodiments, a majority of rear-panel 105 may be transparent and/or translucent with respect to light emitted by light-source 2723 (of tower 2700). In some embodiments, the transparent and/or translucent portion(s) of rear-panel 105 may be made from glass, a plastic, acrylic, polycarbonate, a portion thereof, combinations thereof, and/or the like.

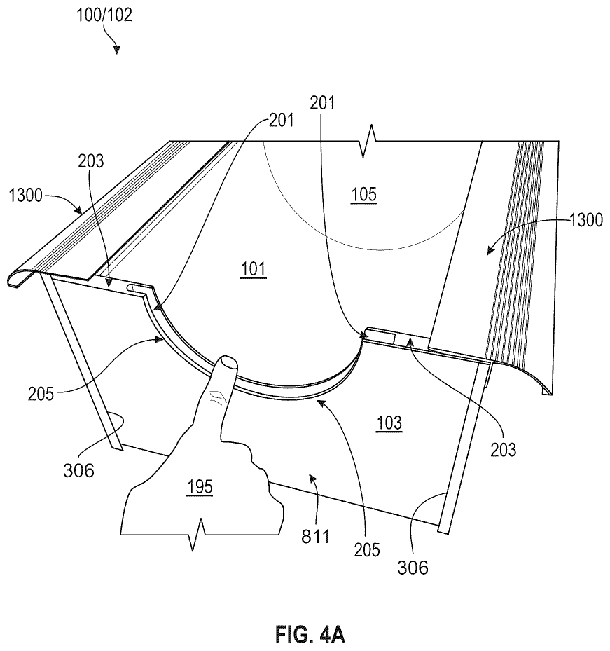

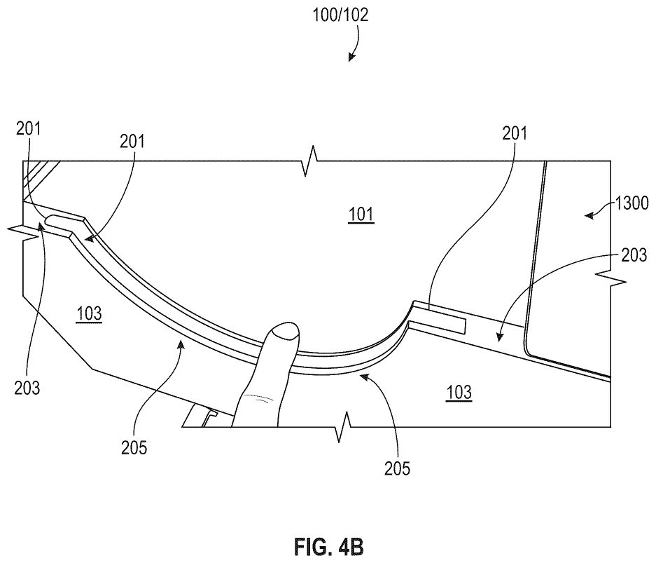

FIG. 4A is a top front perspective of soaking-device 100, with a focus on front-panel 103. FIG. 4B a top front perspective of front-panel 103 that shows a neck-gasket-channel 201 within a top 203 of a cutout region 205 of front-panel 103. FIG. 4B shows a more enlarged (closer up view) of neck-gasket-channel 201 as compared to neck-gasket-channel 201 shown in FIG. 4A. Note, FIG. 4A and FIG. 4B shows front-panel 103 with its neck-gasket 500 and its wedge 600 (clamp 600) removed from a neck-gasket-channel 201 of front-panel 103. Whereas, in FIG. 1 FIG. 2A, FIG. 2B, FIG. 2C, FIG. 2D, FIG. 3A, and in FIG. 3C the neck-gasket 500 and its wedge 600 are shown and/or are included as being removably attached to front-panel 103. However, when the neck-gasket 500 and the wedge 600 may be removably attached to front-panel 103, then the neck-gasket-channel 201 of front-panel 103 may not be readily visible because neck-gasket-channel 201 may be at least partially visibly blocked by portions of neck-gasket 500 and of wedge 600 being seated within neck-gasket-channel 201.

As shown in FIG. 4A and in FIG. 4B, a top 203 center region of front-panel 103 has cutout region 205. In some embodiments, cutout region 205 may have top portions that are below (beneath) top 203 of front-panel 103. In some embodiments, when cutout region 205 may be view from a front view (or a back [rear] view), cutout region 205 may have a shape that is at least substantially (mostly) similar to one or more of: a half-circle, a semi-circle, a half-oval, a half-ellipse, a polygon, a half-polygon, a square, a rectangle, portions thereof, combinations thereof, and/or the like. Note, cutout region 205 need not be formed from cutting into a top 203 of front-panel 103.

Continuing discussing FIG. 4A and FIG. 4B, in some embodiments, extending into cutout region 205 from its top (a finite and fixed distance), may be a channel, namely, the neck-gasket-channel 201. In some embodiments, neck-gasket-channel 201 may be a channel that runs a fixed (finite) distance into a portion of a top cutout region 205 of front-panel 103. In some embodiments, neck-gasket-channel 201 may be configured to (removably) receive the bottom portions of neck-gasket 500 and of wedge 600 to create the watertight (waterproof) seal between the neck-gasket 500 and front-panel 103. In some embodiments, neck-gasket-channel 201 may be configured for removably receiving a bottom portion of the neck-gasket 500. In some embodiments, neck-gasket-channel 201 may be configured for removably receiving a bottom portion of the wedge 600. In some embodiments, neck-gasket-channel 201 may be configured for removably receiving both the bottom portion of the neck-gasket 500 and the bottom portion of the wedge 600 at the same time. In some embodiments, the bottom portion of neck-gasket 500 may be held removably in place within neck-gasket-channel 201 by wedge 600 that also fits into the neck-gasket-channel 201 and presses up against the bottom portion of neck-gasket 500. When the neck-gasket 500 may be removably attached to front-panel 103 in this manner, there may be a continuous watertight (waterproof) seal between portions of front-panel 103 that physically contact neck-gasket 500.

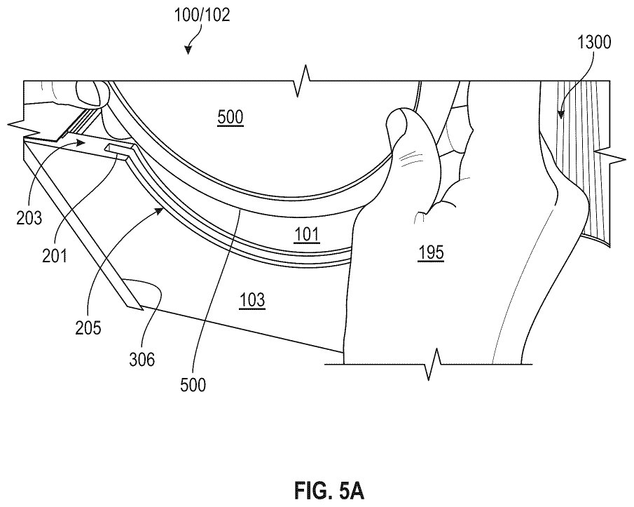

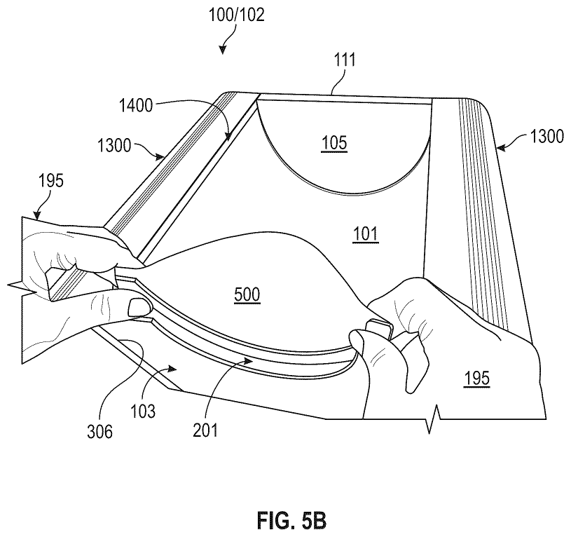

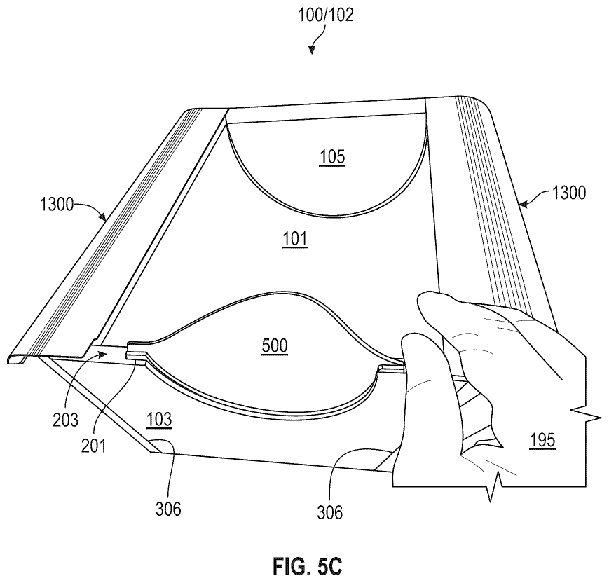

FIG. 5A to FIG. 5C are a series of three sequential drawings showing a sequential process of inserting the bottom edge portions of neck-gasket 500 into its receiving neck-gasket-channel 201 (in front-panel 103). FIG. 5A is a top front perspective view of front-panel 103 and showing a bottom portion of neck-gasket 500 not yet inserted within its receiving neck-gasket-channel 201 FIG. 5A shows a beginning of the process to removably attach neck-gasket 500 to the front-panel 103. In some embodiments, the bottom edge portions of neck-gasket 500 will be inserted into its receiving neck-gasket-channel 201.

FIG. 5B is a top front perspective view of front-panel 103 and showing bottom portions of neck-gasket 500, with some of the bottom portions of neck-gasket 500 being inserted its receiving neck-gasket-channel 201 located in front-panel 103. FIG. 3B shows the process to removably attach neck-gasket 500 to its receiving neck-gasket-channel 201 in front-panel 103 a bit further along as compared to FIG. 3A. Now in FIG. 3B, at least some of the bottom edge portions of neck-gasket 500 have been inserted into its receiving neck-gasket-channel 201 in front-panel 103.

FIG. 5C is a top front perspective view of front-panel 103 and showing bottom portions of neck-gasket 500 having been inserted into its receiving neck-gasket-channel 201 located in front-panel 103. FIG. 5C shows the process to removably insert neck-gasket 500 to front-panel 103 completed, with the bottom portions of neck-gasket 500 fully (entirely) inserted into its receiving neck-gasket-channel 201 located in front-panel 103. However, note at this point shown in FIG. 3C, wedge 600 is not yet also inserted into receiving neck-gasket-channel 201 located in front-panel 103, and thus there may not yet be a watertight (waterproof) seal between neck-gasket 500 and front-panel 103.

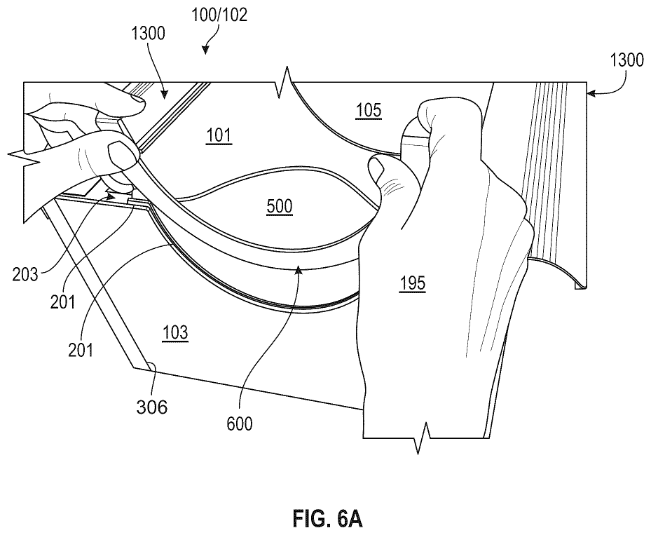

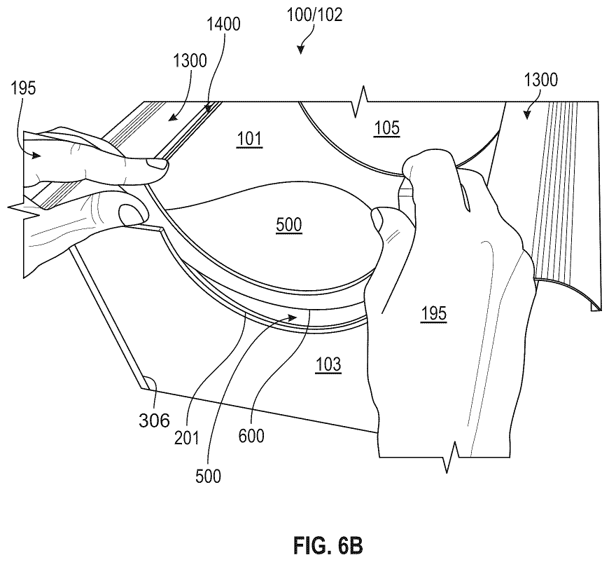

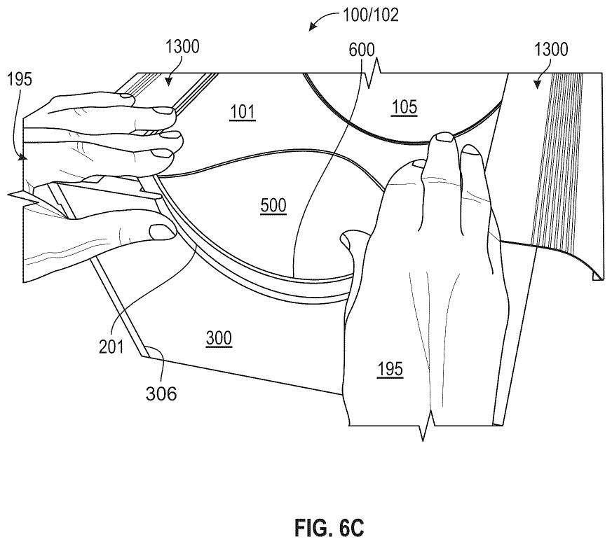

FIG. 6A to FIG. 6C are a series of three sequential drawings showing a sequential process of inserting the bottom edge portions of wedge 600 into neck-gasket-channel 201 (of front-panel 103) and adjacent to the already inserted bottom edges of neck-gasket 500 into neck-gasket-channel 201. Note, FIG. 1 FIG. 2A, FIG. 2B, FIG. 2C, FIG. 2D, FIG. 3A, and/or FIG. 3C show and/or have both the neck-gasket 500 and the wedge 600 fully and entirely inserted (seated) to neck-gasket-channel 201, resulting in the watertight (waterproof) seal between neck-gasket 500 and front-panel 103.

FIG. 6A is a top front perspective view of front-panel 103, with neck-gasket 500 inserted into its neck-gasket-channel 201 located on front-panel 103, and with wedge 600 not yet inserted into this neck-gasket-channel 201 FIG. 6A shows a beginning of the process to removably attach wedge 600 to the front-panel 103. In some embodiments, wedge 600 may be inserted into neck-gasket-channel 201 next to the already inserted bottom edge portions of neck-gasket 500 such that the inserted wedge 600 will press (wedge) up against the inserted portions of neck-gasket 500 within neck-gasket-channel 201. In some embodiments, the insertion process of wedge 600 may be very similar to the insertion process of neck-gasket 500. In some embodiments, wedge 600 may be a stiff and/or rigid member that is not elastic and non-variable in its fixed dimensions and shape.

FIG. 6B is a top front perspective view of front-panel 103, with neck-gasket 500 inserted into its receiving neck-gasket-channel 201 located on front-panel 103, and with wedge 600 only partially inserted into this neck-gasket-channel 201 FIG. 6B shows the process to removably attach wedge 600 to front-panel 103 a bit further along as compared to FIG. 6A. Now in FIG. 6B, at least some of the bottom edge portions of wedge 600 have been inserted into neck-gasket-channel 201 next to the already inserted neck-gasket 500.

FIG. 6C is a top front perspective view of front-panel 103, with neck-gasket 500 inserted into its receiving neck-gasket-channel 201 located on front-panel 103, and with wedge 600 more inserted into this neck-gasket-channel 201 as compared to FIG. 6B. FIG. 6C shows the process to removably attach wedge 600 to front-panel 103 further along as compared to FIG. 6B. Now in FIG. 6C, more of bottom edge portions of wedge 600 have been inserted into neck-gasket-channel 201 next to the already inserted neck-gasket 500 as compared to FIG. 6B.

FIG. 7A is a top perspective exploded view of the neck-gasket 500 assembly, showing that the neck-gasket 500 may be at least comprised of two separate parts (components), namely, a flexible-member 501 and a rigid-member 503, in at least some embodiments. That is, reference numeral “500” may refer to the overall neck-gasket assembly, in its assembled configuration, that may at least comprise flexible-member 501 and rigid-member 503. In some embodiments, flexible-member 501 may be a flexible member. In some embodiments, flexible-member 501 may be a waterproof material. In some embodiments, flexible-member 501 may be an elastomeric material. In some embodiments, flexible-member 501 may be selected from one or more of: neoprene, silicone, rubber, a flexible plastic, a portion thereof, combinations thereof, and/or the like. In some embodiments, flexible-member 501 may be a flat and planar member that is wider (or longer) than thick. In some embodiments, when flexible-member 501 may be spread out and laying flat upon a flat substrate surface, then flexible-member 501 may have a predetermined shape that at least substantially matches and/or is sized to cover over void space formed from the cutout region 205 of front-panel 103, except that a top of flexible-member 501 may extend above top 203 of front-panel 103. For example, and without limiting the scope of the present invention, when cutout region 205 may have a substantially semi-circle shape, then flexible-member 501 may also have a substantially semi-circle shape (and/or of a similar size), except for the top of flexible-member 501.

Continuing discussing FIG. 7A, in some embodiments, rigid-member 503 may be planar flat rigid member that has a shape that at least substantially (mostly) complementary matches a bottom edge shape of flexible-member 501, such that when rigid-member 503 is attached to the bottom portions of flexible-member 501, then that neck-gasket 500 assembly shares a common bottom edge shape that is now rigid, whereas, the rest of flexible-member 501 may remain flexible. For example, and without limiting the scope of the present invention, when the bottom edge portions of flexible-member 501 may be have a substantially (mostly) U-shape or a half-arc of a circle shape, then rigid-member 503 may have a similarly sized and shape U-shape or have a shape that is of a similar shape and size to the half-arc of circle shape. In some embodiments, rigid-member 503 may be configured to function as a stiffener that is attached to the bottom side portion of flexible-member 501 to provide some stiffness (rigidity) to the bottom edge portions of neck-gasket 500.

FIG. 7B is a view of flexible-member 501 showing a portion of flexible-member 501 (by itself and without rigid-member 503) being bent and/or folded over on itself to demonstrate that flexible-member 501 may be flexible. FIG. 7B shows that flexible-member 501 may be flexible.

FIG. 7C shows a backing 507 from an adhesive 505 being removed from one side of rigid-member 503, such that rigid-member 503 may be attached to a bottom side portion of flexible-member 501. In some embodiments, neck-gasket 500 may comprise flexible-member 501, rigid-member 503, and adhesive 505. In some embodiments, neck-gasket 500 may comprise flexible-member 501, rigid-member 503, adhesive 505, and backing 507. In some embodiments, adhesive 505 may be an adhesive. In some embodiments, adhesive 505 may be configured for attaching a side of rigid-member 503 to a bottom side portion of flexible-member 501 to form neck-gasket 500.

FIG. 7D shows a bottom side edge portion of flexible-member 501 being attached to a side of rigid-member 503 by using of adhesive 505, wherein adhesive 505 is disposed between the bottom side edge portion of flexible-member 501 and the side of rigid-member 503. In FIG. 7D this attachment process is shown as only being partially completed, i.e., in process. In an alternative embodiment, adhesive 505 could instead or also be on a portion of flexible-member 501.

FIG. 7E shows the bottom side edge portion of flexible-member 501 having been fully (entirely) attached to the side of rigid-member 503 by use of adhesive 505, wherein adhesive 505 is disposed between the bottom side edge portion of flexible-member 501 and the side of rigid-member 503. In FIG. 7E this attachment process is shown in its completed state, such that fully assembled neck-gasket 500 is shown in FIG. 7E.

FIG. 7F is a bottom front and (right) side partial perspective view of soaking-device 100, with a focus on showing how neck-gasket 500 removably interacts with a body part of user 190, such as, a front of a neck of user 190. FIG. 7F is a different view of the same situation of FIG. 1, i.e, when user 190 has their face immersed within the vessel portion of soaking-device 100 (e.g., with the face of user 190 within the immersion-liquid 180), and the front-of-neck 197 of user 190 is in removable physical contact with side surface(s) of neck-gasket 500. In some embodiments, when the front-of-neck 197 of user 190 may be physically pressing up against side surface(s) of neck-gasket 500 and physically touching side surface(s) of neck-gasket 500, then there may be (secondary) watertight (waterproof) seal as between the front of the neck of user 190 and the side surface(s) of neck-gasket 500, wherein this may be deemed a “secondary” watertight (waterproof) seal in comparison to a “primary” watertight seal that may exist between neck-gasket 500 and neck-gasket-channel 201 of front-panel 103. In some embodiments, as soon the neck of user 190 is removed from neck-gasket 500, this secondary watertight seal may cease to exist; however, the immersion-liquid 180 will not leak out from the vessel portion of soaking-device 100 because when the face 192 of the user 190 is removed from this vessel (wettable-subassembly 104) the immersion-liquid 180 level within the vessel naturally lowers a bit and is not sufficiently high to come over a top of neck-gasket 500 (nor over the top of this vessel).

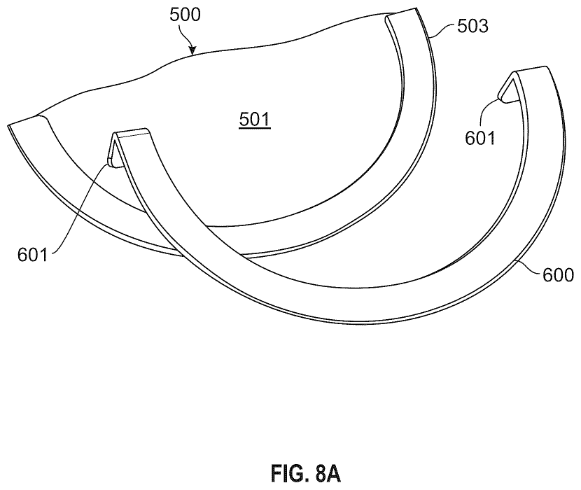

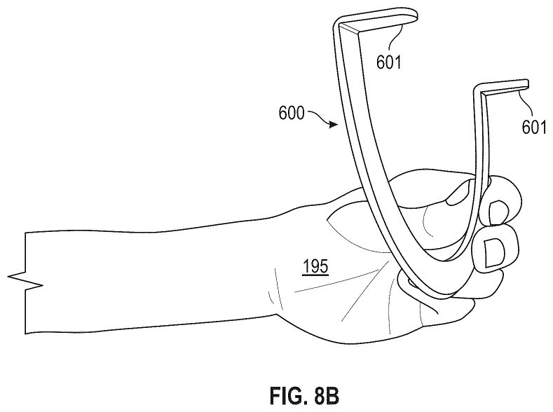

FIG. 8A merely shows wedge 600 and neck-gasket 500 together by themselves (with wedge 600 laying on top of neck-gasket 500) without showing other aspects of front-wall 103 and/or of soaking-device 100. FIG. 8A may illustrate a size and shape relationship between wedge 600 and neck-gasket 500, but otherwise, the configuration, arrangement, and/or orientation of neck-gasket 500 and wedge 600 shown in FIG. 8A is not important (not relevant).

FIG. 8B is a perspective view of just wedge 600 (clamp 600) shown by itself. In some embodiments, wedge 600 may be a rigid member. In some embodiments, wedge 600 may be made from one or more of: a metal, an alloy, a wood, a composite, a plastic, a reinforced plastic, a laminate, portions thereof, combinations thereof, and/or the like. In some embodiments, wedge 600 may be planar flat rigid member (except for its prongs 601) that has a shape that at least substantially (mostly) complementary matches a bottom edge shape of neck-gasket 500 and/or of neck-gasket-channel 201. For example, and without limiting the scope of the present invention, when the bottom edge portions of neck-gasket 500 may have a substantially (mostly) U-shape or a half-arc of a circle shape, then wedge 600 (except for its prongs 601) may have a similarly sized and shape U-shape or have a shape that is of a similar shape and size to the half-arc of circle shape. In some embodiments, wedge 600 (except for its prongs 601) may be configured to fit at least mostly into neck-gasket-channel 201 and up against the bottom edge portions of neck-gasket 500 that are already within neck-gasket-channel 201. In some embodiments, wedge 600 (except for its prongs 601) may be shaped and/or sized to fit at least mostly into neck-gasket-channel 201 and up against the bottom edge portions of neck-gasket 500 that are already within neck-gasket-channel 201. In some embodiments, wedge 600 (except for its prongs 601) may be configured to function as a wedge to help push portions of neck-gasket 500 up against surfaces of neck-gasket-channel 201, to form the primary watertight (waterproof) seal.

Continuing discussing FIG. 8B, in some embodiments, wedge 600 may have two terminal ends. In some embodiments, wedge 600 may comprise a prong 601 located at each of its terminal ends. In some embodiments, prongs 601 of wedge 600 may point at least substantially (mostly) orthogonally away from the flat planar surfaces of wedge 600. In some embodiments, prongs 601 of wedge 600 may be configured to aid in removal of wedge 600 from neck-gasket-channel 201. In some embodiments, wedge 600 may be removed from neck-gasket-channel 201 by squeezing opposing prongs 601 of wedge 600 towards each other and lifting (pulling) wedge 600 away from 201.

FIG. 9A shows a partial top, front, and side (left-side) perspective view of soaking-device 100 (and/or of vessel-subassembly 102), where a given handle 1300 is at least partially detached from a top region (portion) of a (left) side-panel-portion 107 of outermost-shell 106. FIG. 9A may show how assembly of a given handle 1300 to a side-panel-portion 107 of outermost-shell 106 can occur. FIG. 9A may show how disassembly of a given handle 1300 from a side-panel-portion 107 of outermost-shell 106 can occur. In some embodiments, one or more mechanical fastener(s) 1307 may be used to secure (attach) a given handle 1300 to a given side-panel-portion 107 of outermost-shell 106, by using apertures 715 and apertures 1305 (e.g., at least some portions of the mechanical fastener [s] 1307 may through apertures 715 and apertures 1305). See FIG. 9C and FIG. 9D for mechanical fastener(s) 1307. In some embodiments, aperture(s) 715 may be one or more through apertures (holes) within side-panel-portion 107 of outermost-shell 106. In some embodiments, aperture(s) 1305 may be one or more through apertures (holes) through downward-protecting-portion 1303 of a given handle 1300. FIG. 9A also shows use of a thermal-break 1309 disposed between a given handle 1300 and a top of a side-panel-portion 107 of outermost-shell 106 and a top of wettable-floor-and-sidewalls 101. In some embodiments, thermal-break 1309 may be located underneath a portion of a given handle 1300 and on top of side-panel-portion 107 (of outermost-shell 106) and also on top of wettable-floor-and-sidewalls 101.

FIG. 9B shows a partial top, front, and side (left-side) perspective view of soaking-device 100 (and/or of vessel-subassembly 102), where a given handle 1300 is removed and showing a given thermal-break 1309. FIG. 9B may show how assembly of a given thermal-break 1309 to a top of a side-panel-portion 107 (of outermost-shell 106) and/or to a top of wettable-floor-and-sidewalls 101 can occur. FIG. 9B may show how disassembly of a given thermal-break 1309 from a top of a side-panel-portion 107 (of outermost-shell 106) and/or from a top of wettable-floor-and-sidewalls 101 can occur. Note, a portion of neck-gasket-channel 201 in front-panel 103 is also visible in FIG. 9B.

Note, FIG. 9A and FIG. 9B also show bracket(s) 1821, wherein bracket(s) 1821 may be components (parts) of the overall headrest-assembly 1800 and are further described in U.S. nonprovisional patent application Ser. No. 18/197,365 filed on May 15, 2023, by the same inventor as the present patent application; wherein the entire disclose of patent application Ser. No. 18/197,365 is included herein by reference.

FIG. 9C is a close up left and front perspective view of the left front upper corner region (portion) of the soaking-device 100 showing how a given handle 1300 may be attached to a given side-panel-portion 107 (such as the left side-panel-portion 107 shown in FIG. 9C). FIG. 9C shows a top-portion 1301 of handle 1300 laying flat on top of a top 903 of the given side-panel-portion 107, with a downward-protecting-portion 1303 of handle 1300 abutting up against the external (exterior) surface 811 of the given side-panel-portion 107, towards (near) top 903 of side-panel-portion 107. In some embodiments, top-portion 1301 and downward-protecting-portion 1303 may be different regions (portions) of a same given handle 1300. In some embodiments, top-portion 1301 and downward-protecting-portion 1303 may be attached to each other. In some embodiments, top-portion 1301 and downward-protecting-portion 1303 may be connected to each other. In some embodiments, top-portion 1301 and downward-protecting-portion 1303 may be integral with each other. In some embodiments, top-portion 1301 and downward-protecting-portion 1303 may be of a single article of manufacture with respect to each other. In some embodiments, top-portion 1301 may be an elongate member that is planar and flat. In some embodiments, top-portion 1301 may be an elongate member that is planar and flat that is sized and shaped to be able to rest on top of top 903 of a given side-panel-portion 107. In some embodiments, downward-protecting-portion 1303 may be another elongate member that is planar and flat, that is separate and different from the elongate, planar, and flat regions of top-portion 1301. In some embodiments, downward-protecting-portion 1303 may function as a flange that is configured to butt up against the external (exterior) surface 811 of the given side-panel-portion 107, towards (near) top 903 of side-panel-portion 107. In some embodiments, downward-protecting-portion 1303 may be termed flange 1303. In some embodiments, the major surfaces/sides of top-portion 1301 and downward-protecting-portion 1303 may be at least substantially orthogonal with respect to each other.

In some embodiments, downward-protecting-portion 1303 may have one or more apertures 1305 (see FIG. 9A and/or FIG. 9F for aperture 1305). In some embodiments, aperture 1305 may be a hole that passes entirely through downward-protecting-portion 1303 (flange 1303). In some embodiments, a (mechanical) fastener 1307 may pass through a given aperture 1305 of downward-protecting-portion 1303 and into aperture 715 of side-panel-portion 107 to secure handle 1300 to side-panel-portion 107. In some embodiments, a fastener 1307 may pass through a given aperture 1305 of downward-protecting-portion 1303 and into aperture 715 of side-panel-portion 107 to secure handle 1300 to side-panel-portion 107. In FIG. 9C, one such fastener 1307, a portion of downward-protecting-portion 1303, and a portion of top-portion 1301 are all visible; as well as portions of the external (exterior) surface 811 of side-panel-portion 107 and portions of the external (exterior) surface 811 of front-panel 103. However, apertures 1305 and apertures 715 are all readily not visible in FIG. 9C because they are covered by other structures (e.g., such as by a fastener 1307).

FIG. 9C also shows a portion of at least one thermal-break 1309. In some embodiments, when a given handle 1300 may be attached to a given side-panel-portion 107, disposed between top 903 of that given side-panel-portion 107 and a bottom of top-portion 1301 of handle 1300 may be at least one thermal-break 1309. In some embodiments, thermal-break 1309 may slow a heat transfer rate between wettable-floor-and-sidewalls 101 and handle 1300. In some embodiments, thermal-break 1309 may minimize the handle 1300 getting uncomfortably too hot and/or too cold for holding by a naked human 190 hand 195 or the like. In some embodiments, thermal-break 1309 may be made from a material (or materials) with slower heat transfer rates as compared to wettable-floor-and-sidewalls 101 and/or as compared to handle 1300. In some embodiments, thermal-break 1309 may be an insulator. In some embodiments, thermal-break 1309 may be at least partially made from one or more of: an elastomer; silicone; rubber; plastic; foam; fiber; mesh; aero-gel; combinations thereof; portions thereof; and/or the like. In some embodiments, thermal-break 1309 may be sized to complementary fit between a top of top-ledge 1105 (of wettable-floor-and-sidewalls 101) and a bottom of top-portion 1301 of handle 1300. In some embodiments, thermal-break 1309 may be an elongate member. In some embodiments, thermal-break 1309 may be longer than wide and wider than thick. In some embodiments, thermal-break 1309 may be a planar and/or sheet member. In some embodiments, thermal-break 1309 may be flexible.

In some embodiments, thermal-break 1309 may be omitted from soaking-device 100 (and/or omitted from vessel-subassembly 102); e.g., if and when the handle 1300 (or top-portion 1301) has relatively poor heat transfer characteristics (as compared to wettable-floor-and-sidewalls 101), as then thermal-break 1309 may be unnecessary.

FIG. 9D is a top perspective view showing a pair of handles 1300 assemblies side by side to each other, in a state of disassembly. In some embodiments, soaking-device 100 may comprise two handle 1300 assemblies, one for each of the two side-panel-portions 107. In some embodiments, a single handle 1300 assembly may comprise at least one handle 1300, at least one fastener 1307, and at least one thermal-break 1309. In some embodiments, a quantity of fasteners 1307 may match a quantity of: apertures 1305 (or of apertures 715) of a given soaking-device 100 (and/or of a given vessel-subassembly 102).

FIG. 9E is a top front right perspective view showing installation of a given thermal-break 1309 onto a top of top-ledge 1105 (of wettable-floor-and-sidewalls 101) and beneath the top-portion 1301 of handle 1300. FIG. 9E may also demonstrate that thermal-break 1309 may be flexible in some embodiments. FIG. 9E is similar to FIG. 9B.

FIG. 9F is a top front right respective view of the upper top front right corner region of soaking-device 100 (and/or of a given vessel-subassembly 102) showing how a given handle 1300 may be installed onto the top (upper) region of a given side-panel-portion 107. In FIG. 9F a thermal-break 1309 has already been installed onto a top of top-ledge 1105 of wettable-floor-and-sidewalls 101 and beneath the top-portion 1301 of handle 1300, and now the top-portion 1301 of that handle 1300 is being lowered onto a top of that thermal-break 1309 and over top 903 of that given side-panel-portion 107. In FIG. 9F, at least one aperture 1305 of downward-protecting-portion (flange) 1303 is visible; as well as, at least one aperture 715 of that given side-panel-portion 107. Once that given top-portion 1301 of that handle 1300 is seated on top of that given thermal-break 1309 and/or on top of top 903 of that given side-panel-portion 107, then each aperture 1305 of downward-protecting-portion (flange) 1303 may be in colinear alignment with a given aperture 715 of that given side-panel-portion 107, such those colinearly aligned pairs of apertures 1305/715 may receive a fastener 1307 to secure that handle 1300 to that given side-panel-portion 107. Compare FIG. 9C to FIG. 9F.

FIG. 9F also shows that in some embodiments, an end-view of a given handle 1300 may resemble a letter “f” and/or a transverse-width cross section through a given handle 1300 may resemble a letter “f” in some embodiments. For example, and without limiting the scope of the present invention, at least a portion of the horizontal stroke region of a letter “f” may coincide with downward-protecting-portion (flange) 1303; at least a portion of the stem region of a letter “f” may coincide with top-portion 1301; and/or at least a portion of the ascender region of a letter “f” may coincide with a portion of handle 1300 where human 190 fingers may be holding that given handle 1300, wherein this region of handle 1300 may be ascender-portion 1311. In some embodiments, a given handle 1300 may comprise at least one top-portion 1301, at least one downward-protecting-portion (flange) 1303, at least one aperture 1305, and at least one ascender-portion 1311. In some embodiments, ascender-portion 1311 may be a curved region (portion) of handle 1300.

FIG. 9G shows an end view of a given handle 1300. In some embodiments, terminal-end-edge 1405 may be a terminal end edge of top-portion 1301 that is disposed away from downward-protecting-portion (flange) 1303 and/or that is disposed away from ascender-portion 1311 of that given handle 1300. In some embodiments, handle 1300 and/or top-portion 1301 may comprise terminal-end-edge 1405. In some embodiments, descending from a terminal-end-edge 1405 of top-portion 1301 of that given handle 1300 may be a slot 1400. In some embodiments, a length of slot 1400 may be at least substantially (mostly) parallel and/or dimensionally equal to a length of its associated (connected) terminal-end-edge 1405. In some embodiments, slot 1400 may run in a direction that is at least substantially (mostly) parallel to the length of its associated (connected) terminal-end-edge 1405. In some embodiments, slot 1400 may run in a direction that is at least substantially (mostly) linearly straight and/or unobstructed. In some embodiments, slot 1400 may comprise an opening 1401 and an enclosed-region 1403. In some embodiments, opening 1401 and enclosed-region 1403 may be operationally directly linked (connected) to each other. In some embodiments, opening 1401 may be facing away from downward-protecting-portion (flange) 1303 and/or away from ascender-portion 1311. In some embodiments, when both handles 1300 may be each attached to their respective side-panel-portion 107, then each opening 1401 may be facing each other (e.g., in vessel-subassembly 102). In some embodiments, opening 1401 and enclosed-region 1403 may also run in a direction that is at least substantially (mostly) parallel with the length of slot 1400 and/or with the length of its associated (connected) terminal-end-edge 1405. In some embodiments, opening 1401 and enclosed-region 1403 may be configured to allow back-and-forth sliding translation (movement) of at least one mating-member 1407 held (trapped) within slot 1400. In some embodiments, a transverse-width cross-section through a given handle and/or a given slot 1400 may show that a shape of slot 1400 may at least substantially resemble a letter “T” with a bottom of a stem portion of a letter “T” coinciding with opening 1401 to slot 1400, and with the top horizontal arms portion of a letter “T” coinciding with the portions of slot 1400 that are mostly enclosed, as in enclosed-region 1403. That is, slot 1400 may be a “T” slot in some embodiments.

FIG. 9H is a close up (detail) view of FIG. 9G, that may better show at least one mating-member 1407 in a process of being inserted into slot 1400. In some embodiments, at least some portions of a given mating-member 1407 may have a size and/or a shape that complementary fits within slot 1400. In some embodiments, the at least some portions of the given mating-member 1407 may have a size and/or a shape that complementary fits within opening 1401 and/or within enclosed-region 1403. In some embodiments, the at least some portions of the given mating-member 1407 may have a size and/or a shape that complementary fits within slot 1400, such that those at least some portions of the given mating-member 1407 may slidingly translate back-and-forth within slot 1400. In some embodiments, the at least some portions of the given mating-member 1407 may have a size and/or a shape that at least substantially (mostly) resembles a letter “T.” In some embodiments, the at least some portions of the given mating-member 1407 may be shaped as a screw, a bolt, a flat-head screw, and/or the like. In some embodiments, a given mating-member 1407 may be configured for two purposes, namely, (1) to removably and/or sliding attach to handle 1300 and/or (2) to permit one or more accessories to be removably attached to soaking-device 100, via the mating-member 1407 to slot 1400 interaction (engagement).

In some embodiments, the one or more accessories may be selected from: a breathing apparatus, a head rest (e.g., headrest 1800), airline tubing, gas line tubing, a light, a thermometer, a temperature probe, a timer, portions thereof, combinations thereof, and/or the like.

FIG. 9I is an end perspective view of a given handle 1300 showing at least one mating-member 1407 received into slot 1400 of that given handle 1300. FIG. 9I is an end perspective view of a given handle 1300 showing at least two different mating-members 1407 being received into slot 1400 of that given handle 1300. In some embodiments, a given slot 1400 may be configured to accommodate one or more mating-members 1407 within that given slot 1400. However, because the length of slot 1400 is fixed, finite, and/or non-variable, there is a finite maximum quantity of mating-members 1407 that may simultaneously fit into a given slot 1400. Additionally, a greater the quantity of mating-members 1407 within a given slot 1400, the greater the reduction in sliding translation freedom of movement of those mating-members 1407 within that given slot 1400.

In some embodiments, the headrest-assembly 1800 may be (removably) attachable to the vessel-subassembly 102. In some embodiments, the headrest-assembly 1800 may be (removably) attachable to the handles 1300 of the vessel-subassembly 102. In some embodiments, the headrest-assembly 1800 may be (removably) attachable to slots (tracks) 1400 of the handles 1300 (such as, but not limited to, by using at least one mating-member 1407 in each slot [track] 1400). See e.g., FIG. 9I, FIG. 2A, FIG. 2B, FIG. 2C, FIG. 3C, and FIG. 17A.

FIG. 10A shows a partial perspective view of vessel-subassembly 102 in a state of at least partial disassembly, with handle(s) 1300 (and with thermal thermal-break [s] 1309) removed. FIG. 10A also shows that since the handle(s) 1300 are removed, side-panel-portion 107 (of outermost-shell 106) may be coming removed from wettable-subassembly 104. FIG. 10A also shows that since the handle(s) 1300 are removed, side-panel-portion 107 (of outermost-shell 106) may be coming removed from front-panel 103 and from rear-panel 105.

FIG. 10B shows a front top perspective view of wettable-subassembly 104 being lifted out (separated) of/from outermost-shell 106. Or in the alternative, FIG. 10B shows a perspective view of wettable-subassembly 104 being set into place within outermost-shell 106. FIG. 10C shows another perspective view, a side (right-side) perspective view, of wettable-subassembly 104 being lifted out (separated) of/from outermost-shell 106. Or in the alternative, FIG. 10C shows a perspective view of wettable-subassembly 104 being set into place within outermost-shell 106. In some embodiments, when handles 1300 are detached from soaking-device 100 (and/or from vessel-subassembly 102), then wettable-subassembly 104 may be physically separated from outermost-shell 106. In some embodiments, with respect to vessel-subassembly 102 there are no mechanical fasteners used to secure front-panel 103 to side-panel-portion 107 (of outermost-shell 106). In some embodiments, with respect to vessel-subassembly 102 there are no mechanical fasteners used to secure rear-panel 105 to side-panel-portion 107 (of outermost-shell 106). See e.g., FIG. 10A, FIG. 10B, and FIG. 10C.

FIG. 11A shows a front top (or a rear top) perspective view of outermost-shell 106, shown by itself. FIG. 11B shows another front top (or a rear top) perspective view of outermost-shell 106, shown by itself. The perspective views from FIG. 11A and FIG. 11B are different from each other. FIG. 11C shows a side top (left or right) perspective view of outermost-shell 106, shown by itself. Recall at least some of outermost-shell 106 was previously discussed above in the discussions of FIG. 3A, FIG. 3B, and FIG. 3C. A right-side view may be the same as a left-side view of outermost-shell 106 due to left-right symmetry of outermost-shell 106 in some embodiments. A front view may be the same as a rear (back) view of outermost-shell 106 due to front-back symmetry of outermost-shell 106 in some embodiments. However, a top view of outermost-shell 106 may differ from a bottom view of outermost-shell 106 as outermost-shell 106 may not be top-bottom symmetric. In some embodiments, outermost-shell 106 may also be referred to as integral-outermost-sidewall-and-bottom 106. In some embodiments, outermost-shell 106 may form the outer most exterior bottom and sidewalls of soaking-device 100 and/or of vessel-subassembly 102 In some embodiments, a length of outermost-shell 106 (e.g., from front-panel 103 to rear-panel 105) may be predetermined, fixed, finite, non-variable, and/or non-elastic. In some embodiments, opposing terminal ends of each side-panel-portion 107 (of outermost-shell 106), with respect to the length of outermost-shell 106, may turn up and in (or bend up and in or fold up and in) into a region of capture-surface 306 (retention-surface 306). In some embodiments, capture-surface 306 may also be referred to as retention-surface 306. In some embodiments, with respect to one terminal end of outermost-shell 106, two different sets of capture-surfaces 306 (from the two side-panel-portions 107), i.e, a pair of capture-surfaces 306, may at least mostly face or point towards each other, particularly when that outermost-shell 106 is attached to (and/or retaining) wettable-subassembly 104; i.e., this pair of capture-surfaces 306 are not turning away from each other. In some embodiments, a pair of capture-surfaces 306 (that at least mostly face and/or point towards each other) may capture, retain, pull, and/or hold front-panel 103 against outermost-shell 106 and also may push that front-panel 103 against wettable-floor-and-sidewalls 101; while the other (opposing) pair of capture-surfaces 306 (that at least mostly face and/or point towards each other) may capture, retain, pull, and/or hold rear-panel 105 against outermost-shell 106 and may also push that rear-panel 105 against that same wettable-floor-and-sidewalls 101. Thus, outermost-shell 106 may work in this clamping aspect squeezing front-panel 103 against wettable-floor-and-sidewalls 101 and squeezing rear-panel 105 against wettable-floor-and-sidewalls 101. This may work because the length of outermost-shell 106 is sized to make this clamping action happen, taking into account a length of wettable-floor-and-sidewalls 101, and thicknesses of front-panel 103 and of rear-panel 105. Thus, when outermost-shell 106 is retaining (holding and/or squeezing) wettable-subassembly 104, to form vessel-subassembly 102 (by placing front-panel 103 into one pair of capture-surfaces 306, placing rear-panel 105 into the other pair of capture-surfaces 306 and securing handles 1300 to side-panel-portions 107); then wettable-subassembly 104 becomes waterproof because of this squeezing action from outermost-shell 106 and does so without use of mechanical fasteners between outermost-shell 106 and front-panel 103 and without mechanical fasteners between outermost-shell 106 and rear-panel 105. In some embodiments, outermost-shell 106 may be made from at least one metal or at least one alloy. In some embodiments, outermost-shell 106 may be made from at least one single sheet that is bent into a shape.

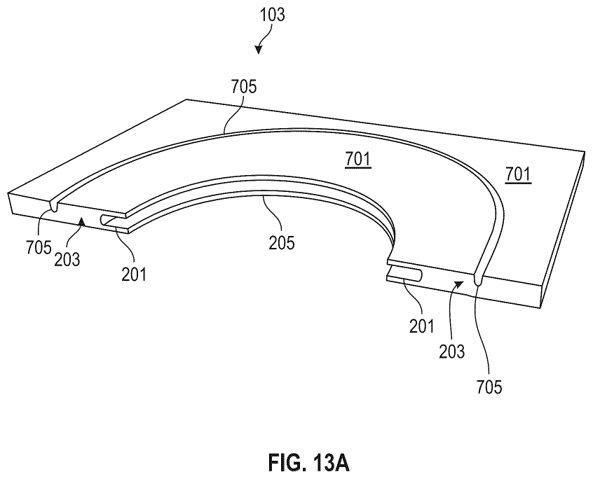

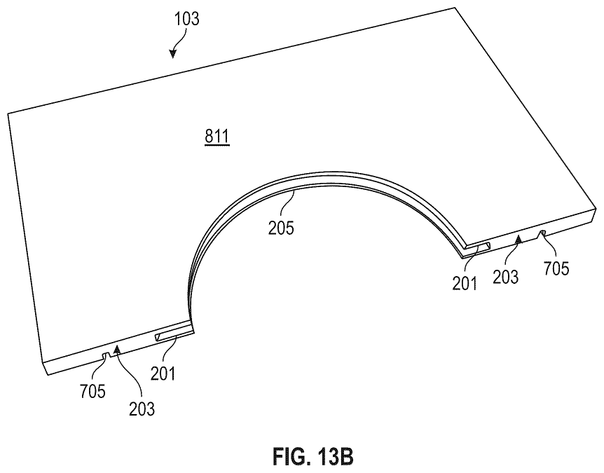

FIG. 12A shows a front top perspective view of just wettable-subassembly 104 by itself (e.g., without outermost-shell 106, handles 1300, breathing-apparatus 1700, headrest assembly 1800, and tower 2700). FIG. 12B shows more of top perspective view of just wettable-subassembly 104 by itself. FIG. 12C shows a rear (back) top perspective view of just wettable-subassembly 104 by itself. In some embodiments, wettable-subassembly 104 may comprise: front-panel 103, wettable-floor-and-sidewalls 101, and rear-panel 105. In some embodiments, wettable-subassembly 104 may comprise: front-panel 103, wettable-floor-and-sidewalls 101, rear-panel 105, and end-gasket 1200. In some embodiments, when wettable-subassembly 104 is assembled by itself, e.g., as shown in FIG. 12A, FIG. 12B, and FIG. 12C, this assembled configuration may be held together entirely by frictional forces from press fits. In some embodiments, such press fits may be between channel-for-end-gasket 705, (a first) end-gasket 1200, and (a first) terminal end 1107 (of wettable-floor-and-sidewalls 101) with respect to the physical interaction between front-panel 103 and wettable-floor-and-sidewalls 101; and/or between channel-for-end-gasket 719, another (different or second) end-gasket 1200, and (a second and/or opposing) terminal end 1107 (of wettable-floor-and-sidewalls 101) with respect to the physical interaction between rear-panel 105 and wettable-floor-and-sidewalls 101. In some embodiments, wettable-subassembly 104 may be referred to as wettable because its upper and/or interior opposing facing surfaces 701 may be intended to be in direct physical contact with immersion-liquid 180 for temporary periods of time, such as, but not limited to, long enough for a given user 190 to use soaking-device 100 as intended. In some embodiments, at least some of the top, upper, and/or upward facing surfaces of wettable-floor-and-sidewalls 101 shown in FIG. 12A, FIG. 12B, and/or FIG. 12C may be configured to be intentionally wetted and/or submerged while soaking-device 100 may be in intended use for soaking a given body part of user 190. In some embodiments, at least some of the opposing facing interior surfaces 701 of front-panel 103 and of rear-panel 105 shown in FIG. 12A, FIG. 12B, and/or FIG. 12C may be configured to be intentionally wetted and/or submerged while soaking-device 100 may be in intended use for soaking a given body part of user 190. In some embodiments, the top, upper, and/or upward facing surfaces of wettable-floor-and-sidewalls 101 and the opposing facing interior surfaces 701 of front-panel 103 and of rear-panel 105, all shown in FIG. 12A, FIG. 12B, and/or FIG. 12C, when in the wettable-subassembly 104 configuration, may be configured to be waterproof and/or to hold and/or retain at least some of immersion-liquid 180 within the volume of wettable-subassembly 104. In some embodiments, the top, upper, and/or upward facing surfaces of wettable-floor-and-sidewalls 101 and the opposing facing interior surfaces 701 of front-panel 103 and of rear-panel 105, all shown in FIG. 12A, FIG. 12B, and/or FIG. 12C, when in the wettable-subassembly 104 configuration and being retained by outermost-shell 106, may be configured to be waterproof and/or to hold and/or retain at least some of immersion-liquid 180 within the volume of wettable-subassembly 104. In some embodiments, the top, upper, and/or upward facing surfaces of wettable-floor-and-sidewalls 101 and the opposing facing interior surfaces 701 of front-panel 103 and of rear-panel 105, all shown in FIG. 12A, FIG. 12B, and/or FIG. 12C, when in the wettable-subassembly 104 configuration and being retained by outermost-shell 106 and with affixed handles 1300, may be configured to be waterproof and/or to hold and/or retain at least some of immersion-liquid 180 within the volume of wettable-subassembly 104. Note, front-panel 103 may be shown by itself in FIG. 13A and in FIG. 13B. Note, rear-panel 105 may be shown by itself in FIG. 14A and in FIG. 14B. Note, wettable-floor-and-sidewalls 101 may be shown by itself in FIG. 15A and in FIG. 15B.

In some embodiments, the opposing main (largest) surfaces (e.g., exterior surface 811 and/or interior surface 701) of front-panel 103 may have a perimeter that is at least substantially (mostly) in a shape of a trapezoid, not including the cutout region for the neck-gasket-channel 201, wherein the only two parallel sides of that trapezoid are the top and the bottom sides of front-panel 103, wherein the top side is wider than the bottom side. See e.g., FIG. 12A.

In some embodiments, the opposing main (largest) surfaces (e.g., exterior surface 811 and/or interior surface 701) of front-panel 103 may have a perimeter that is at least substantially (mostly) in a shape of a polygon (or a quadrilateral), not including the cutout region for the neck-gasket-channel 201. See e.g., FIG. 12A.

In some embodiments, the opposing main (largest) surfaces (e.g., exterior surface 811 and/or interior surface 701) of rear-panel 105 may have a perimeter that is at least substantially (mostly) in a shape of a trapezoid, wherein the only two parallel sides of that trapezoid are the top and the bottom sides of rear-panel 105, wherein the top side is wider than the bottom side. See e.g., FIG. 12C.

In some embodiments, the opposing main (largest) surfaces (e.g., exterior surface 811 and/or interior surface 701) of rear-panel 105 may have a perimeter that is at least substantially (mostly) in a shape of a polygon (or a quadrilateral). See e.g., FIG. 12C.

FIG. 12D shows a bottom rear perspective view of wettable-subassembly 104, shown in a process of installing (or removing) insulation 115 from a bottom of wettable-floor-and-sidewalls 101. In some embodiments, soaking-device 100, vessel-subassembly 102 and/or wettable-subassembly 104 may comprise insulation 115. In some embodiments, insulation 115 may be (thermal) insulation. In some embodiments, insulation 115 may be configured to slow down (reduce) heat transfer from (to) wettable-floor-and-sidewalls 101 and/or from (to) submersion-liquid 180 within wettable-subassembly 104. In some embodiments, insulation 115 may be made at least partially from one or more of: mineral wool, rock wool, fiberglass, hemp, cellulose, foam, animal wool, polystyrene, polyurethane, spray foam, spray foam insulation, phase-shift insulation, a sealed packet of phase-shift insulation, aerogel, a portion thereof, combinations thereof, and/or the like. In some embodiments, a form factor of insulation 115 may be in one or more of: a planar foam sheet; a fibrous batt; a fiberglass batt; a rock (mineral) wool batt; sprayed foam; a sealed pouch (of phase shift insulation); sprayed insulation; loose cellulose; foam board; aerogel, a portion thereof; combinations thereof; and/or the like.

FIG. 12E shows a bottom rear perspective view of wettable-subassembly 104, shown with installed insulation 115 (installed onto a bottom of wettable-floor-and-sidewalls 101). In some embodiments, insulation 115 may be located on a bottom surface of wettable-floor-and-sidewalls 101. In some embodiments, insulation 115 may cover over at least most of a bottom surface of wettable-floor-and-sidewalls 101. Note, in the vessel-subassembly 102 configuration, insulation 115 may not be visible, as bottom-panel-portion 113 (of outermost-shell 106) may cover over installed insulation 115. In some embodiments, (with respect to vessel-subassembly 102) insulation 115 may be disposed between wettable-floor-and-sidewalls 101 and outermost-shell 106.

FIG. 12E may also show a rabbet (inset-shelf or inset-ledge) 123. In some embodiments, front-panel 103 and/or rear-panel 105 may comprise one or more rabbet(s) 123. In some embodiments, vertical edges of external (exterior) surface 811 of front-panel 103 and/or of rear-panel 105 may comprise a rabbet 123. In some embodiments, rabbet 123 may be an inset-shelf and/or an inset-ledge along a given vertical edge, i.e, a rabbet, located at the vertical edges of external (exterior) surface 811 of front-panel 103 and/or of rear-panel 105. In some embodiments, these rabbet(s) 123 may be configured to receive the capture-surface(s) (retention-surface [s]) 306 of outermost-shell 106, so that the overall external (exterior) surface 811 of front-panel 103 and/or rear-panel 105 are flush with the exteriors of the capture-surface(s) (retention-surface [s]) 306, and/or to facilitate the outermost-shell 106 being able to squeeze (compress) the front-panel 103 against a first terminal-end 1107 of the wettable-floor-and-sidewalls 101 and the outermost-shell 106 also simultaneously being able to squeeze (compress) the rear-panel 105 against a second terminal-end 1107 of the wettable-floor-and-sidewalls 101.

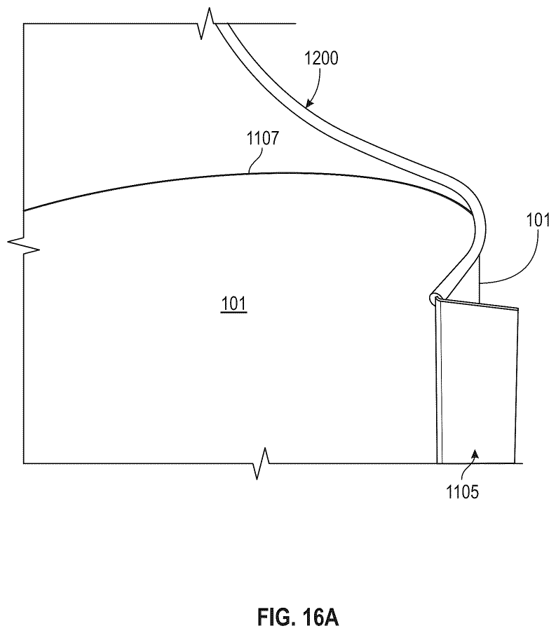

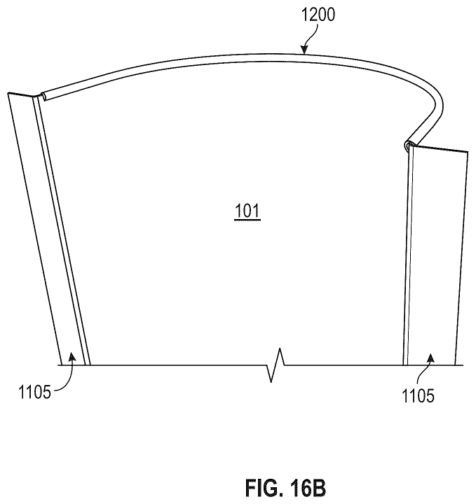

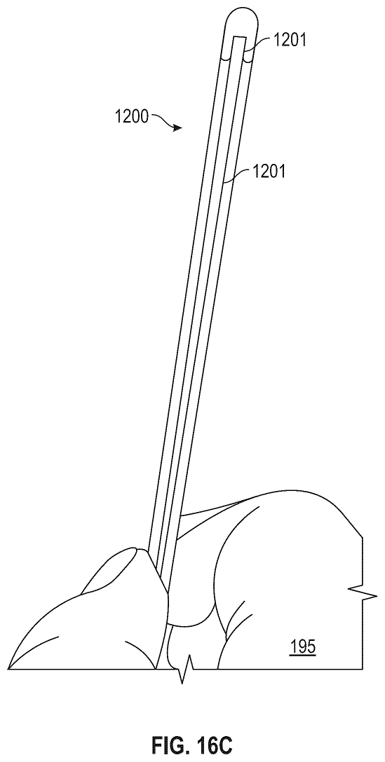

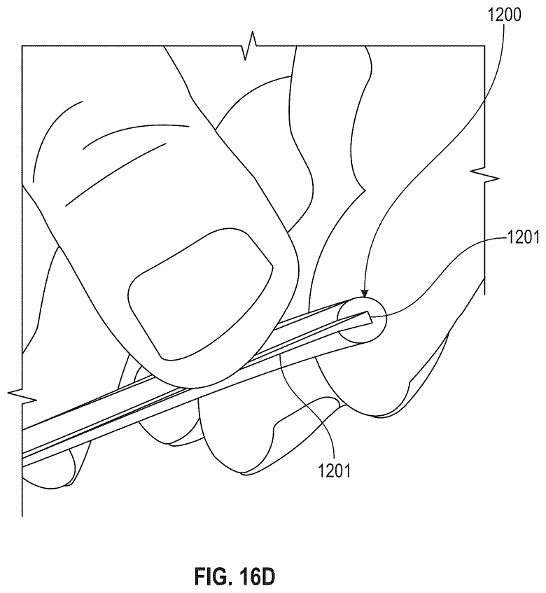

FIG. 13A is top 203 internal (interior) 701 perspective view of just front-panel 103 shown by itself. Top 203 and internal (interior) facing surface 701 of front-panel 103 are shown in FIG. 13A. The cutout region 205 of front-panel 103 and neck-gasket-channel 201 of front-panel 103 are also at least partially visible in FIG. 13A; as well as, channel 705 (channel-for-end-gasket 705). In some embodiments, channel 705 (of interior surface 701 of front-panel 103) may be configured to receive an edge of (a first) terminal end 1107 of wettable-floor-and-sidewalls 101 when that edge of that terminal end 1107 is being retained within a receiving-channel 1201 of (a first) end-gasket 1200 (see e.g., FIG. 16A, FIG. 16B, FIG. 16C, and FIG. 16D for terminal end 1107, end-gasket 1200, and receiving-channel 1201, and their interactions).

FIG. 13B is top 203 external (exterior) surface 811 perspective view of just front-panel 103 shown by itself. Top 203 and external (exterior) surface 811 of front-panel 103 are shown in FIG. 13B. The cutout region 205 of front-panel 103 and neck-gasket-channel 201 of front-panel 103 are also at least partially visible in FIG. 13B. The two opposed openings to channel 705 on top 203 of front-panel 103 are also visible in FIG. 13B. In some embodiments, external (exterior) surface 811 of front-panel 103 may be free from visible holes, apertures, pockets, fasteners, portions thereof, combinations thereof, and/or the like.

FIG. 14A is a top 1001 internal (interior) 701 perspective view of just rear-panel 105 shown by itself. In some embodiments, rear-panel 105 may comprise a top side 1001, a bottom side 1003, a left side 1005, and a right side 1007, wherein top side 1001, bottom side 1003, left side 1005, and right side 1007 define a continuous polygonal (such as, but not limited to, a quadrilateral, a trapezoid, a square, a rectangle, and/or the like) perimeter (boundary) to rear-panel 105, when rear-panel 105 is viewed from above or below and a major planar surface of rear-panel 105 (e.g., internal surface 701 or exterior surface 811 of rear-panel 105) may be lying flat upon a surface. In some embodiments, top side 1001 may be disposed opposite from bottom side 1003. In some embodiments, top side 1001 may be separated from bottom side 1003 by a fixed and/or non-variable height (tallness) of rear-panel 105. In some embodiments, top side 1001 and bottom side 1003 may be at least substantially parallel to each other. In some embodiments, left side 1005 may be disposed opposite from right side 1007. In some embodiments, left side 1005 may be separated from right side 1007 by a width of rear-panel 105. In some embodiments, left side 1005 and right side 1007 may be at least substantially parallel to each other. In some embodiments, left side 1005 and right side 1007 may be non-parallel to each other. Top side 1001 and internal (interior) facing surface 701 of rear-panel 105 are shown in FIG. 14A. The channel 719 (channel-for-end-gasket 719) of rear-panel 105 is shown in FIG. 14A. In some embodiments, channel 719 (of interior surface 701 of rear-panel 105) may be configured to receive an edge of the opposing terminal end 1107 of wettable-floor-and-sidewalls 101, when that edge of terminal end 1107 is being retained within a receiving-channel 1201 of a second (different) end-gasket 1200 (see e.g., FIG. 16A, FIG. 16B, FIG. 16C, and FIG. 16D for terminal end 1107, end-gasket 1200, and receiving-channel 1201, and their interactions).

FIG. 14B is a bottom 1003 left 1005 external (exterior) 811 perspective view of just rear-panel 105 shown by itself. FIG. 14B shows bottom side 1003, left side 1005, and the external (exterior) surface 811 of rear-panel 105.

FIG. 15A shows just the wettable-floor-and-sidewalls 101 by itself, from a top perspective view. FIG. 15B shows just the wettable-floor-and-sidewalls 101 by itself from a front (or rear) perspective view. In some embodiments, a transverse width cross-section of the wettable-floor-and-sidewalls 101 may have a shape that at least substantially (mostly) resembles a “U” shape, a half-circle, a semi-circle, half of a cylinder, half pipe, combinations thereof, portions thereof, and/or the like. In some embodiments, the wettable-floor-and-sidewalls 101 member may be a continuous member that serves as both a floor and as opposing sidewalls to the vessel of soaking-device 100. In some embodiments, the wettable-floor-and-sidewalls 101 member may be waterproof. In some embodiments, at least some or most of the upper-surfaces 1109 of a given wettable-floor-and-sidewalls 101 may be configured to periodically touch and/or house immersion-liquid 180. In some embodiments, wettable-floor-and-sidewalls 101 may have a predetermined shape. In some embodiments, wettable-floor-and-sidewalls 101 may be bent, rolled, stamped, pressed, folded, combinations thereof, portions thereof, and/or the like into its predetermined overall final shape from at least one single planar sheet of stock material. In some embodiments, wettable-floor-and-sidewalls 101 may be injection (and/or diecast) molded, 3D printed, extruded, and/or the like. In some embodiments, a given wettable-floor-and-sidewalls 101 may comprise a single floor-portion 1101; two (2) opposing sidewall-portions 1103; and two (2) opposing top-ledges 1105 portions. In some embodiments, a given wettable-floor-and-sidewalls 101 may comprise a single floor-portion 1101; two (2) opposing sidewall-portions 1103; and two (2) opposing top-ledges 1105 portions; wherein wettable-floor-and-sidewalls 101 may be a single integral article of manufacture, with these five (5) portions being merely different regions of that single wettable-floor-and-sidewalls 101. In some embodiments, the two (2) opposing sidewall-portions 1103 may flank and be continuously attached to floor-portion 1101. In some embodiments, floor-portion 1101 may be centrally located and may be a lowest portion of wettable-floor-and-sidewalls 101, when assembled soaking-device 100 (and/or wettable-subassembly 104 and/or vessel-subassembly 102) may be resting upon a flat surface (e.g., a tabletop). In some embodiments, two (2) opposing sidewall-portions 1103 may form opposing sidewalls of wettable-floor-and-sidewalls 101. In some embodiments, each of two (2) opposing sidewall-portions 1103 may terminate and/or be (integrally) attached to (transition to) a given top-ledge 1105. In some embodiments, each top-ledge 1105 may be configured to rest on top of top 903 of a given side-panel-portion 107, when soaking-device 100 (and/or vessel-subassembly 102) may be in its assembled configuration. In some embodiments, when soaking-device 100 (and/or vessel-subassembly 102) may be in its assembled configuration, then a given top-ledge 1105 of wettable-floor-and-sidewalls 101 may rests on top of a top 903 of a given side-panel-portion 107. In some embodiments, a given wettable-floor-and-sidewalls 101 may comprise two (2) opposing terminal ends 1107 (with respect to a length of wettable-floor-and-sidewalls 101). In some embodiments, each terminal end 1107 of a given wettable-floor-and-sidewalls 101 may be configured to be attached to a given end-gasket 1200. In some embodiments, the two opposing terminal ends 1107 of the wettable-floor-and-sidewalls 101 may be separated from each other by the length of wettable-floor-and-sidewalls 101. See e.g., FIG. 15A and/or FIG. 15B.

Small portions of bottom-surface 1111 of wettable-floor-and-sidewalls 101 may be visible in FIG. 15B, underneath portions of top-ledges 1105. In some embodiments, bottom-surface 1111 may be a bottom main (major) surface of a given top-ledge 1105. In some embodiments, bottom-surface 1111 and upper-surface 1109 may be oppositely disposed main (major) surfaces of a given top-ledge 1105. In some embodiments, bottom-surface 1111 and upper-surface 1109 may generally face away from each other.

In some embodiments, wettable-floor-and-sidewalls 101 (or most of wettable-floor-and-sidewalls 101) may be made from a material that is considered by persons of ordinary skill in the relevant industries to be a thermal insulator or poor or undesirable at heat transfer, such as, but not limited to, a plastic, and/or the like. In an assembled configuration, below wettable-floor-and-sidewalls 101 may be no heating and/or cooling elements.

In some embodiments, wettable-floor-and-sidewalls 101 (or most of wettable-floor-and-sidewalls 101) may be made from a material that is considered by persons of ordinary skill in the relevant industries to be good or desirable at heat transfer, such as, but not limited to, a metal, an alloy, stainless steel, copper, graphene, and/or the like. In an assembled configuration, below wettable-floor-and-sidewalls 101 may be heating and/or cooling elements, which is why it may be beneficial for wettable-floor-and-sidewalls 101 to be relatively good at heat transfer; i.e., so that immersion-liquid 180 may be heated, warmed, cooled, chilled, combinations thereof, portions thereof, and/or the like in reasonable amounts of time.

In some embodiments, wettable-floor-and-sidewalls 101 may be made from at least one metal or at least one alloy. In some embodiments, wettable-floor-and-sidewalls 101 may be made from at least one single sheet that is bent into a shape.

FIG. 16A is a rear top perspective view showing attachment of an end-gasket 1200 to one of the two terminal ends 1107 of wettable-floor-and-sidewalls 101. In some embodiments, end-gasket 1200 may be a flexible elongate member with a receiving-channel 1201 that runs along a length of the given end-gasket 1200. In some embodiments, end-gasket 1200 may be at least substantially (mostly) made from one or more: elastomeric materials; waterproof materials; hydrophobic materials; gasket materials; sealing materials; combinations thereof; portions thereof; and/or the like. In some embodiments, end-gasket 1200 may be an elastomeric material. In some embodiments, end-gasket 1200 may be selected from one or more of: neoprene, silicone, rubber, a flexible plastic, portions thereof, combinations thereof, and/or the like. In some embodiments, a given soaking-device 100 (and/or wettable-subassembly 104 and/or vessel-subassembly 102) may comprise two (2) separate and distinct end-gaskets 1200 (e.g., a first end-gasket 1200 and a second [different] end-gasket 1200); i.e., one end-gasket 1200 for each of the two terminal ends 1107 of wettable-floor-and-sidewalls 101. In some embodiments, a given end-gasket 1200 may be configured for (removable) attachment to a given terminal end 1107 of wettable-floor-and-sidewalls 101. In some embodiments, end-gasket 1200 is attached to terminal end 1107 of wettable-floor-and-sidewalls 101 by pressing terminal end 1107 into receiving-channel 1201 of that end-gasket 1200, until that terminal end 1107 is at least substantially (mostly) filling (occupying) that receiving-channel 1201 FIG. 16A shows the beginning of this attachment process. And FIG. 16B shows this attachment process for one end-gasket 1200 and one terminal end 1107 of wettable-floor-and-sidewalls 101 FIG. 16B is a rear top perspective view showing completion of the attachment process of FIG. 16A of end-gasket 1200 to at least one of the two terminal ends 1107 of the wettable-floor-and-sidewalls 101.

FIG. 16C is a perspective view of just a portion of one end-gasket 1200. FIG. 16C shows the elongate nature of end-gasket 1200. In some embodiments, the member that may be formed into end-gasket 1200 may be come in an extruded roll that may be cut to (predetermined) length to arrive at a given end-gasket 1200. In some embodiments, end-gasket 1200 may be formed from extrusion, die cutting, 3D printing, injection molding, and/or the like.

FIG. 16D is a perspective close up view of just a portion of one end-gasket 1200 showing its receiving-channel 1201 FIG. 16D shows receiving-channel 1201 within a given end-gasket 1200. In some embodiments, this receiving-channel 1201 may run a length of end-gasket 1200. In some embodiments, this receiving-channel 1201 may be configured to fit onto and/or around a given terminal end 1107 of wettable-floor-and-sidewalls 101. In some embodiments, a transverse width cross-section of a given end-gasket 1200 may have a shape that is at least substantially shaped as a letter “U,” a letter “C,” a letter “V,” portions thereof, combinations thereof, and/or the like.

FIG. 17A through FIG. 17H show various aspects of breathing-apparatus 1700 FIG. 17A is a top front right side perspective view of soaking-device 100 along with a breathing-apparatus 1700 (or showing breathing-apparatus 1700 that soaking-device 100 may comprise in some embodiments). In some embodiments, soaking-device 100 may further comprise breathing-apparatus 1700 (or other breathing apparatus). In some embodiments, a system (or a kit) may comprise soaking-device 100 and breathing-apparatus 1700 (or other breathing apparatus). In some embodiments, soaking-device 100 may further comprise breathing-apparatus 1700 (or other breathing apparatus) and headrest 1800. In some embodiments, a system (or a kit) may comprise soaking-device 100, breathing-apparatus 1700 (or other breathing apparatus), and headrest 1800. In FIG. 17A, breathing-apparatus 1700 is shown partially residing (resting) within the vessel portion (vessel-subassembly 102) of soaking-device 100, i.e., with a portion of breathing-apparatus 1700 in direct physical contact with floor-portion 1101 of floor-and-sidewalls 101. In some embodiments of breathing-apparatus 1700, FIG. 17A may show a general size relationship (comparison) between soaking-device 100 (and/or vessel-subassembly 102) and breathing-apparatus 1700. In some embodiments, when user 190 may have their mouth and/or nose submerged within immersion-liquid 180 within the vessel portion (vessel-subassembly 102 and/or wettable-subassembly 104) of soaking-device 100, then that user 190 may continue to breathe by intended use of breathing-apparatus 1700.

FIG. 17B shows a perspective view of just breathing-apparatus 1700 by itself (in its assembled configuration). In some embodiments, breathing-apparatus 1700 may be comprised of one or more of: a rigid-elongate-hollow-member 1701 (or semi-rigid-elongate-hollow-member 1701), a flexible-elongate-hollow-member 1703, and a mouthpiece 1705. In some embodiments, breathing-apparatus 1700 may be comprised of: at least one rigid-elongate-hollow-member 1701 (or at least one semi-rigid-elongate-hollow-member 1701), two separate flexible-elongate-hollow-members 1703, and one mouthpiece 1705. In some embodiments, breathing-apparatus 1700 may further comprise one or more fittings 1707. In some embodiments, fitting(s) 1707 may be configured to facilitate (removable) attachment between one or more of: rigid-elongate-hollow-member 1701 (or semi-rigid-elongate-hollow-member 1701), flexible-elongate-hollow-member 1703, and/or mouthpiece 1705. In some embodiments, breathing-apparatus 1700 may be comprised of one or more of: rigid-elongate-hollow-member 1701, flexible-elongate-hollow-member 1703, mouthpiece 1705, and/or fitting 1707.

Continuing discussing FIG. 17B, in some embodiments, mouthpiece 1705 (or a portion thereof) may be configured to be removably gripped by a mouth, lip, teeth, and/or gums of user 190. In some embodiments, mouthpiece 1705 may be at least substantially similar to a mouthpiece used in snorkels (for use in snorkeling) and/or to a mouthpiece used in a breathing apparatus for SCUBA diving or the like. In some embodiments, mouthpiece 1705 may be fitted with at least one one-way-valve (check-valve) that is configured to release immersion-liquid 180 (or other liquid) from within mouthpiece 1705 but is also configured to block (prevent and/or minimize) immersion-liquid 180 from entering past that check-valve and getting into mouthpiece 1705. In some embodiments, this check-valve may be a flapper type check-valve. Such check-valves are common on snorkeling snorkels and are incorporated by reference herein. In some embodiments, mouthpiece 1705 may be at least substantially (mostly) made from injection molding (and/or 3D printing). In some embodiments, mouthpiece 1705 may be at least substantially (mostly) made from one or more: elastomers, silicone, rubber, a flexible plastic, plastic, portions thereof, combinations thereof, and/or the like. In some embodiments, mouthpiece 1705 may be operatively connected to a terminal end of one or more of flexible-elongate-hollow-member(s) 1703; and/or to one or more fitting(s) 1707. In some embodiments, mouthpiece 1705 may be configured for washing and/or sterilizing within a dishwasher (or pot of boiling water). In some embodiments, mouthpiece 1705 may be configured for sterilizing within a microwave and/or oven.

Continuing discussing FIG. 17B, in some embodiments, flexible-elongate-hollow-member 1703 may be configured to operatively link mouthpiece 1705 to rigid-elongate-hollow-member 1701 (semi-rigid-elongate-hollow-member 1701). In some embodiments, flexible-elongate-hollow-member 1703 may be an elongate member that is hollow and at least partially flexible. In some embodiments, flexible-elongate-hollow-member 1703 may be an elongate member that is tubular and hollow. In some embodiments, flexible-elongate-hollow-member 1703 may have a predetermined, fixed, finite, and/or non-variable length. In some embodiments, flexible-elongate-hollow-member 1703 may have a variable length because flexible-elongate-hollow-member 1703 may be stretchable and/or because at least some of flexible-elongate-hollow-member 1703 may have an accordion (telescoping) aspect that permits some expansion or some retraction. In some embodiments, flexible-elongate-hollow-member 1703 may comprise two opposing terminal ends. In some embodiments, at each of the two terminal ends of flexible-elongate-hollow-member 1703 may be one main opening to the hollow interior of flexible-elongate-hollow-member 1703; such that, flexible-elongate-hollow-member 1703 has two opposing main openings. In some embodiments, one terminal end of flexible-elongate-hollow-member 1703 may be configured for (removable) attachment to mouthpiece 1705 and/or to a fitting 1707; whereas, the other remaining terminal end of flexible-elongate-hollow-member 1703 may be configured to (removable) attachment to rigid-elongate-hollow-member 1701 (semi-rigid-elongate-hollow-member 1701) and/or to another different fitting 1707. In some embodiments, breathing-apparatus 1700 may comprise two separate and distinct flexible-elongate-hollow-members 1703. In some embodiments, at least some of flexible-elongate-hollow-member 1703 may be made from the same or at least substantially (mostly) similar materials the flexible tubing used in snorkeling snorkels and/or SCUBA gear breathing tubing. In some embodiments, at least some of flexible-elongate-hollow-member 1703 may be made from extruding one or more: elastomers, silicone, rubber, flexible plastic, plastic, portions thereof, combinations thereof, and/or the like. In some embodiments, at least some of flexible-elongate-hollow-member 1703 may be reinforced to minimize or prevent kinking of flexible-elongate-hollow-member 1703. In some embodiments, at least some of flexible-elongate-hollow-member 1703 may be braided to reinforce flexible-elongate-hollow-member 1703. In some embodiments, at least some of flexible-elongate-hollow-member 1703 may be optically transparent and/or translucent with respect to human vision, as that may permit a cleanliness state of flexible-elongate-hollow-member 1703 to be determined by human visual inspection from an exterior of flexible-elongate-hollow-member 1703. In some embodiments, flexible-elongate-hollow-member 1703 may be configured for washing and/or sterilizing within a dishwasher (and/or within a boiling pot of water). In some embodiments, flexible-elongate-hollow-member 1703 may be configured for sterilizing within a microwave and/or oven.

Continuing discussing FIG. 17B, in some embodiments, rigid-elongate-hollow-member 1701 (semi-rigid-elongate-hollow-member 1701) may be configured to operatively link rigid-elongate-hollow-member 1701 (semi-rigid-elongate-hollow-member 1701) to mouthpiece 1705 via at least one intermediary of flexible-elongate-hollow-member 1703. In some embodiments, rigid-elongate-hollow-member 1701 (semi-rigid-elongate-hollow-member 1701) may be directly connected to one or two flexible-elongate-hollow-member(s) 1703. In some embodiments, rigid-elongate-hollow-member 1701 (semi-rigid-elongate-hollow-member 1701) may be directly connected to one or two fitting(s) 1707. In some embodiments, rigid-elongate-hollow-member 1701 may be an elongate member that is hollow and fixedly rigid (at least compared to flexible-elongate-hollow-member 1703). In some embodiments, rigid-elongate-hollow-member 1701 may be rigid. Whereas, in other embodiments, semi-rigid-elongate-hollow-member 1701 may be flexible, with a same or similar flexibility as flexible-elongate-hollow-member 1703 or less so. In some embodiments, rigid-elongate-hollow-member 1701 (semi-rigid-elongate-hollow-member 1701) may be an elongate member that is tubular and hollow. In some embodiments, rigid-elongate-hollow-member 1701 (semi-rigid-elongate-hollow-member 1701) may have a predetermined, fixed, finite, and/or non-variable length. In some embodiments, an overall length of rigid-elongate-hollow-member 1701 (semi-rigid-elongate-hollow-member 1701) may have a predetermined overall shape. In some embodiments, this overall shape of rigid-elongate-hollow-member 1701 (semi-rigid-elongate-hollow-member 1701) may a fixed and predetermined curvature. In some embodiments, this overall shape of rigid-elongate-hollow-member 1701 (semi-rigid-elongate-hollow-member 1701) may be of a fixed and predetermined arc. In some embodiments, this overall shape of rigid-elongate-hollow-member 1701 may at least substantially (mostly) resemble a letter “c,” half-circle, semicircle, half-oval, half-ellipse, portions thereof, combinations thereof, and/or the like. In some embodiments, rigid-elongate-hollow-member 1701 (semi-rigid-elongate-hollow-member 1701) may comprise two opposing terminal ends. In some embodiments, at each of the two terminal ends of rigid-elongate-hollow-member 1701 (semi-rigid-elongate-hollow-member 1701) may be one main opening to the hollow interior of rigid-elongate-hollow-member 1701 (semi-rigid-elongate-hollow-member 1701); such that, rigid-elongate-hollow-member 1701 (semi-rigid-elongate-hollow-member 1701) has only two opposing main openings. In some embodiments, only one of the two terminal ends of rigid-elongate-hollow-member 1701 (semi-rigid-elongate-hollow-member 1701) may have a single main opening to the hollow interior of rigid-elongate-hollow-member 1701 (semi-rigid-elongate-hollow-member 1701); such that, rigid-elongate-hollow-member 1701 has only one main opening. In some embodiments, one terminal end of rigid-elongate-hollow-member 1701 (semi-rigid-elongate-hollow-member 1701) may be configured for (removable) attachment to flexible-elongate-hollow-member 1703 and/or to a fitting 1707; whereas, the other remaining terminal end of rigid-elongate-hollow-member 1701 (semi-rigid-elongate-hollow-member 1701) may be configured to (removable) attachment to a separate and different flexible-elongate-hollow-member 1703 and/or to another different fitting 1707. In some embodiments, breathing-apparatus 1700 may comprise one rigid-elongate-hollow-member 1701 (semi-rigid-elongate-hollow-member 1701). In some embodiments, at least some of rigid-elongate-hollow-member 1701 (semi-rigid-elongate-hollow-member 1701) may be made from the same or at least substantially (mostly) similar materials as the tubing used in snorkeling snorkels and/or used in SCUBA gear breathing tubing. In some embodiments, at least some of rigid-elongate-hollow-member 1701 (semi-rigid-elongate-hollow-member 1701) may be made from extruding one or more: metals, alloys, aluminum, stainless steel, elastomers, silicone, rubber, rigid plastic, flexible plastic, plastic, PVC, ABS, PEX (cross-linked polyethylene), portions thereof, combinations thereof, and/or the like. In some embodiments, at least some of rigid-elongate-hollow-member 1701 (semi-rigid-elongate-hollow-member 1701) may be reinforced to minimize or prevent kinking of rigid-elongate-hollow-member 1701 (semi-rigid-elongate-hollow-member 1701). In some embodiments, at least some of rigid-elongate-hollow-member 1701 (semi-rigid-elongate-hollow-member 1701) may be braided to reinforce rigid-elongate-hollow-member 1701 (semi-rigid-elongate-hollow-member 1701). In some embodiments, at least some of rigid-elongate-hollow-member 1701 (semi-rigid-elongate-hollow-member 1701) may be optically transparent and/or translucent with respect to human vision, as that may permit a cleanliness state of rigid-elongate-hollow-member 1701 (semi-rigid-elongate-hollow-member 1701) to be determined by human visual inspection from an exterior of rigid-elongate-hollow-member 1701 (semi-rigid-elongate-hollow-member 1701). In some embodiments, rigid-elongate-hollow-member 1701 (semi-rigid-elongate-hollow-member 1701) may be configured for washing and/or sterilizing within a dishwasher (and/or within a pot of boiling water). In some embodiments, rigid-elongate-hollow-member 1701 (semi-rigid-elongate-hollow-member 1701) may be configured for sterilizing within a microwave and/or oven.

Continuing discussing FIG. 17B, in some embodiments, breathing-apparatus 1700 may comprise one or more fittings 1707. In some embodiments, breathing-apparatus 1700 may comprise no fittings 1707. In some embodiments, fitting 1707 may be optional and/or omitted in breathing-apparatus 1700. In some embodiments, a given fitting 1707 may be configured to operatively link: rigid-elongate-hollow-member 1701 (semi-rigid-elongate-hollow-member 1701) to flexible-elongate-hollow-member 1703; flexible-elongate-hollow-member 1703 to mouthpiece 1705; combinations thereof; and/or the like. In some embodiments, a given fitting 1707 may be hollow. In some embodiments, a given fitting 1707 may be at least substantially (mostly) similar to a given plumbing fitting used to attach one end of a tube, tubing, hose, or pipe to another end of a tube, tubing, hose, or pipe. In some embodiments, a given fitting 1707 may comprise one or more hose barbs, threads, unions, couplings, portions thereof, combinations thereof, and/or the like. In some embodiments, a given fitting 1707 may function via friction and/or compression. In some embodiments, fitting 1707 may be rigid, flexible, combinations thereof, and/or the like. In some embodiments, at least some of fitting 1707 may be made from one or more: metals, alloys, aluminum, stainless steel, elastomers, silicone, rubber, rigid plastic, flexible plastic, plastic, PVC, ABS, PEX, portions thereof, combinations thereof, and/or the like. In some embodiments, at least some of fitting 1707 may be reinforced to minimize or prevent kinking of fitting 1707. In some embodiments, at least some of fitting 1707 may be braided to reinforce fitting 1707. In some embodiments, at least some of fitting 1707 may be optically transparent and/or translucent with respect to human vision, as that may permit a cleanliness state of fitting 1707 to be determined by human visual inspection from an exterior of fitting 1707. In some embodiments, fitting 1707 may be configured for washing and/or sterilizing within a dishwasher. In some embodiments, fitting 1707 may be configured for sterilizing within a microwave and/or oven.

FIG. 17C shows a (right) side perspective view of just breathing-apparatus 1700 by itself (in its assembled configuration). FIG. 17C may show at least one aperture 1709. In some embodiments, breathing-apparatus 1700 may comprise at least one aperture 1709. In some embodiments, rigid-elongate-hollow-member 1701 (semi-rigid-elongate-hollow-member 1701) may comprise at least one aperture 1709. In some embodiments, aperture 1709 may be a through hole that passes entirely through a sidewall (thickness) of rigid-elongate-hollow-member 1701 (semi-rigid-elongate-hollow-member 1701) from an exterior of rigid-elongate-hollow-member 1701 (semi-rigid-elongate-hollow-member 1701) and into the hollow interior of rigid-elongate-hollow-member 1701 (semi-rigid-elongate-hollow-member 1701). In some embodiments, aperture 1709 may extend in a radial direction that may be at least substantially (mostly) orthogonal or perpendicular with respect to an axial length of rigid-elongate-hollow-member 1701 (semi-rigid-elongate-hollow-member 1701). In some embodiments, one or more apertures 1709 may be located on the exterior/outside curving arc region of rigid-elongate-hollow-member 1701 (semi-rigid-elongate-hollow-member 1701) that may be disposed and/or facing away from mouthpiece 1705, when breathing-apparatus 1700 is in its assembled configuration (see e.g., FIG. 17D). In some embodiments, when breathing-apparatus 1700 is in its assembled configuration and in use (as intended), with mouthpiece 1705 and a mouth of user 190 submerged within immersion-liquid 180 of the vessel portion of soaking-device 100, the aperture(s) 1709 may remain vertically above and outside of immersion-liquid 180 and thus dry enough (aside from moisture in respiratory gasses and in the ambient air's humidity) (see e.g., FIG. 17H).

FIG. 17D shows another perspective view of just breathing-apparatus 1700 by itself (in its assembled configuration). FIG. 17D may be from a view that opposing from the other perspective view of FIG. 17B. FIG. 17D may show two or more apertures 1709 of rigid-elongate-hollow-member 1701 (semi-rigid-elongate-hollow-member 1701). FIG. 17D may show two or more apertures 1709 located on the exterior/outside curving arc region of rigid-elongate-hollow-member 1701 (semi-rigid-elongate-hollow-member 1701) that may be disposed and/or facing away from mouthpiece 1705, when breathing-apparatus 1700 is in its assembled configuration.

FIG. 17E is a top-down view of one embodiment of breathing-apparatus 1700, showing that breathing-apparatus 1700 embodiment in a disassembled configuration. In some embodiments, breathing-apparatus 1700 may comprise one rigid-elongate-hollow-member 1701 (semi-rigid-elongate-hollow-member 1701), two separate and distinct flexible-elongate-hollow-members 1703, one mouthpiece 1705, and one fitting 1707. In some embodiments, each opposite terminal end of rigid-elongate-hollow-member 1701 (semi-rigid-elongate-hollow-member 1701) may be (removably) connected to a given terminal end of one of the two flexible-elongate-hollow-members 1703. In some embodiments, the other remaining two terminals ends of the flexible-elongate-hollow-members 1703 may each be (removably) connected to a different location of the same fitting 1707. In some embodiments, that fitting may be further (removably) connected to mouthpiece 1705. In some embodiments, the parts and/or components of breathing-apparatus 1700 may be routinely disassembled to facilitate cleaning and/or sterilization of those parts and/or components of breathing-apparatus 1700.

FIG. 17F is right side view of breathing-apparatus 1700 in its intended relational configuration with respect to user 190, showing mouthpiece 1705 currently being gripped by the mouth, lip, teeth, and/or gums of user 190, with each of the two separate and distinct flexible-elongate-hollow-members 1703 passing over a side of face 192 of user 190, with opposite portions of breathing-apparatus 1700 in direct physical contact with the shoulders of user 190 (or with those opposite portions of breathing-apparatus 1700 close to the shoulders of user 190 [e.g., within two inches of the given shoulder of user 190]); and with rigid-elongate-hollow-member 1701 (semi-rigid-elongate-hollow-member 1701) being disposed over an upper back portion of user 190. In some embodiments, when breathing-apparatus 1700 is in use (as intended), such as shown in FIG. 17F through FIG. 17H, the opposite portions of breathing-apparatus 1700 may be in direct physical contact with the shoulders of user 190 or those opposite portions of breathing-apparatus 1700 may be located close (near, adjacent, proximate) to the shoulders of user 190, such as, within two inches of the given shoulder of user 190. In some embodiments, the opposite portions of breathing-apparatus 1700 that may be near or in direct physical contact with the shoulder(s) of user 190, may be portions of flexible-elongate-hollow-member 1703 and/or of rigid-elongate-hollow-member 1701 (semi-rigid-elongate-hollow-member 1701). In some embodiments, when breathing-apparatus 1700 is in use (as intended), such as shown in FIG. 17F through FIG. 17H, the curvature and/or arc region of rigid-elongate-hollow-member 1701 (semi-rigid-elongate-hollow-member 1701) may help to keep the opposite portions of breathing-apparatus 1700 resting upon the shoulders of user 190. In some embodiments, when breathing-apparatus 1700 is in use (as intended), such as shown in FIG. 17F through FIG. 17H, the curvature and/or arc region of rigid-elongate-hollow-member 1701 (semi-rigid-elongate-hollow-member 1701) may help to overall align breathing-apparatus 1700 in a position that is comfortable for user 190 to wear and/or use. In some embodiments, when breathing-apparatus 1700 is in use (as intended), such as shown in FIG. 17F through FIG. 17H, head 191 of user 190 may be located in the interior void space of the overall breathing-apparatus 1700, with a front of head 191 of user 190 being located closer to mouthpiece 1705 than to rigid-elongate-hollow-member 1701 (semi-rigid-elongate-hollow-member 1701). In some embodiments, when breathing-apparatus 1700 is in use (as intended), such as shown in FIG. 17F through FIG. 17H, the curvature and/or arc region of rigid-elongate-hollow-member 1701 (semi-rigid-elongate-hollow-member 1701) may help to keep the opposite portions of breathing-apparatus 1700 resting upon the shoulders of user 190.

FIG. 17G is a rear top perspective view of soaking-device 100, showing breathing-apparatus 1700 (removably) fitted to user 190, but with head 191 of user 190 not yet at least partially submerged within immersion-liquid 180 of the vessel portion (vessel-subassembly 102 and/or wettable-subassembly 104) of soaking-device 100. In some embodiments, when breathing-apparatus 1700 may be (removably) fitted to user 190, at least some portion of mouthpiece 1705 may be (removably) gripped by a mouth, a lip, teeth, a gum, portions thereof, combinations thereof, and/or the like of user 190. See e.g., FIG. 17G and/or FIG. 17F. FIG. 17G may be a rear respective view of FIG. 17F (or front view from the perspective of user 190), but also showing soaking-device 100. In some embodiments, the relational configurations as between breathing-apparatus 1700 and user 190 shown in FIG. 17F may be maintained in FIG. 17G.

FIG. 17H is a rear top perspective view of soaking-device 100, showing breathing-apparatus 1700 (removably) fitted to user 190, but now with head 191 of user 190 at least partially submerged within immersion-liquid 180 of the vessel portion of soaking-device 100. In some embodiments, when breathing-apparatus 1700 may be (removably) fitted to user 190, at least some portion of mouthpiece 1705 may be (removably) gripped by a mouth, a lip, teeth, a gum, portions thereof, combinations thereof, and/or the like of user 190. FIG. 17H may be a same or similar view as compared to FIG. 17G, but in FIG. 17H head 191 (and/or face 192) of user 190 may be at least partially submerged immersion-liquid 180 of the vessel portion of soaking-device 100, whereas, in FIG. 17G head 191 (and/or face 192) of user 190 may not be at least partially submerged immersion-liquid 180 of the vessel portion (vessel-subassembly 102 and/or wettable-subassembly 104) of soaking-device 100. In some embodiments, in FIG. 17H, at least some portions of breathing-apparatus 1700 may be submerged within immersion-liquid 180 of the vessel portion (vessel-subassembly 102 and/or wettable-subassembly 104) of soaking-device 100. In some embodiments, in FIG. 17H, mouthpiece 1705 and/or at least some portions of flexible-elongate-hollow-member 1703 may be submerged within immersion-liquid 180 of the vessel portion (vessel-subassembly 102 and/or wettable-subassembly 104) of soaking-device 100. In some embodiments, in FIG. 17H, rigid-elongate-hollow-member 1701 (semi-rigid-elongate-hollow-member 1701) and/or aperture(s) 1709 may be disposed vertically above and outside of immersion-liquid 180 of the vessel portion (vessel-subassembly 102 and/or wettable-subassembly 104) of soaking-device 100. In some embodiments, in FIG. 17H, at least a portion of rigid-elongate-hollow-member 1701 (semi-rigid-elongate-hollow-member 1701) may be located at a highest point with respect to: other portions of rigid-elongate-hollow-member 1701 (semi-rigid-elongate-hollow-member 1701), other portions of breathing-apparatus 1700, soaking-device 100, face 192 of user 190, head 191 of user 190, user 190, portions thereof, combinations thereof, and/or the like. In some embodiments, in FIG. 17H, at least a portion of mouthpiece 1705 (and/or a centrally located fitting 1707) may be located at a lowest point with respect to other portions of breathing-apparatus 1700. In some embodiments, the relational configurations as between breathing-apparatus 1700 and user 190 shown in FIG. 17F and/or in FIG. 17G may be maintained in FIG. 17H.

In some embodiments, when breathing-apparatus 1700 may be in use as intended (see e.g., FIG. 17F to FIG. 17H), fresh external ambient air may be move into (through) aperture(s) 1709, then into the hollow interior of rigid-elongate-hollow-member 1701 (semi-rigid-elongate-hollow-member 1701), then into the hollow interior of flexible-elongate-hollow-member 1703, then into the hollow interior of mouthpiece 1705, and then into the mouth of user 190. In some embodiments, when breathing-apparatus 1700 may be in use as intended (see e.g., FIG. 17F to FIG. 17H), internal used (respired and/or exhaled) air (e.g., which may contain more carbon dioxide [CO2] than the fresh external ambient air) may move out from the mouth of user 190, then into the hollow interior of mouthpiece 1705, then into the hollow interior of flexible-elongate-hollow-member 1703, then into the hollow interior of rigid-elongate-hollow-member 1701 (semi-rigid-elongate-hollow-member 1701), then through aperture(s) 1709, and lastly out into the fresh external ambient air. In some embodiments, from aperture(s) 1709 to mouthpiece 1705, breathing-apparatus 1700 may comprise at least one airtight sealed pathway that is configured for respiratory gas movement. Thus, breathing-apparatus 1700 may be used for natural and/or normal respiratory breathing of user 190. See e.g., FIG. 17B to FIG. 17H.

Note, FIG. 17H may also show two opposing mating-members 1407, with each such mating-member 1407 being slidingly confined (retained) to its respective slot 1400 (track 1400).

In some embodiments, soaking-device 100 may be used without breathing-apparatus 1700. In some embodiments, in lieu of breathing-apparatus 1700, i.e., breathing-apparatus 1700 may be replaced with any breathing apparatus or the like shown and described in U.S. utility U.S. Pat. No. 10,667,990, U.S. utility U.S. Pat. No. 10,449,341, U.S. utility U.S. Pat. No. 10,667,991, U.S. utility U.S. Pat. No. 11,154,697, U.S. design patent D863575, U.S. design patent D863576, U.S. design patent D864403, U.S. design patent D889675, and/or in U.S. design patent D916303; wherein the disclosures of these U.S. patents is incorporated by reference herein as if fully set-forth herein.

In some embodiments, in lieu of breathing-apparatus 1700, i.e., breathing-apparatus 1700 may be replaced with a snorkel used for snorkeling or the like.

FIG. 18A shows a front and top perspective view of a tower 2700 by itself. FIG. 18B shows an embodiment of tower 2700 from a top, front, and a right-side perspective view. In some embodiments, use of tower 2700 may provide benefits and/or enhancements to immersion-liquid 180 and/or to user 190 who may be using immersion-liquid 180 within soaking-device 100 (vessel-subassembly 102 and/or wettable-subassembly 104). In some embodiments, these benefits and/or enhancements may comprise one or more of: providing gas bubbles 250 to immersion-liquid 180 within wettable-subassembly 104; providing lighting effects to immersion-liquid 180 within wettable-subassembly 104; monitoring a temperature of immersion-liquid 180 within wettable-subassembly 104; doing so with a (countdown or count up) timer function; a portion thereof; combinations thereof; and/or the like. In some embodiments, during intended use of tower 2700, tower 2700 may be removably located adjacent to (next to and/or proximate to) wettable-subassembly 104; wherein adjacent to, next to, and/or proximate to may be six inches or less between a portion of tower 2700 and a portion of wettable-subassembly 104. In some embodiments, during intended use of tower 2700, at least some portions of tower 2700 may be removably located (insertable) into immersion-liquid 180 within wettable-subassembly 104. In some embodiments, these at least some portions of tower 2700 may be at least a region of: temperature-sensor 2707, gas-line-tubing 2709, bubble-emitter 2710, a portion thereof, combinations thereof, and/or the like. In some embodiments, at least a region of: temperature-sensor 2707, gas-line-tubing 2709, and/or bubble-emitter 2710, may be configured for (removable) immersion into immersion-liquid 180 within wettable-subassembly 104. In some embodiments, tower 2700 may be removable from vessel-subassembly 102 and/or from wettable-subassembly 104. For when tower 2700 may be in use with vessel-subassembly 102 and/or with wettable-subassembly 104 see FIG. 2A, FIG. 2B, FIG. 2C, and/or FIG. 2D. In some embodiments, tower 2700 may be taller than vessel-subassembly 102 and/or from wettable-subassembly 104 (see e.g., FIG. 2A, FIG. 2B, FIG. 2C, and/or FIG. 2D). In some embodiments, soaking-device 100 may further comprise tower 2700. In some embodiments, soaking-device 100 may further comprise breathing-apparatus 1700 (or other breathing apparatus), headrest 1800, and tower 2700. In some embodiments, a system (or a kit) may comprise soaking-device 100 and tower 2700. In some embodiments, a system (or a kit) may comprise soaking-device 100, breathing-apparatus 1700 (or other breathing apparatus), headrest 1800, and tower 2700. In some embodiments, use of tower 2700 with vessel-subassembly 102 and/or with wettable-subassembly 104 may be optional, skipped, and/or omitted.

Continuing discussing FIG. 18A and/or FIG. 18B, in some embodiments, tower 2700 may include any and/or all electronics of soaking-device 100 and/or of a system (or a kit) that utilizes soaking-device 100. In some embodiments, no electronics may be located in and/or on vessel-subassembly 102 wettable-subassembly 104, breathing-apparatus 1700, headrest 1800, a portion thereof, combinations thereof, and/or the like. In some embodiments, tower 2700 may comprise one or more of: user-interface 2701, housing 2703, temperature-sensor 2707, gas-line-tubing 2709, bubble-emitter 2710, gas-source 2725, controller 2721, light-source 2723, screen 2727, power 2729, electronics, a portion thereof, combinations thereof, and/or the like. In some embodiments, housing 2703 may be an external physical enclosure of tower 2700. In some embodiments, housing 2703 may house at least some portions of the electronics within and/or on housing 2703.

Continuing discussing FIG. 18A and/or FIG. 18B, in some embodiments, tower 2700 may comprise one or more user-interface(s) 2701, at least one of which may be accessible from housing 2703. In some embodiments, user-interface 2701 may be located on housing 2703. In some embodiments, user-interface 2701 may be how user 190 uses, controls, operates, manages, turns on, turns off, and/or the like the electronics of tower 2700. In some embodiments, user-interface 2701 may be how user 190 provides input(s) to the electronics of tower 2700, such as, but limited to, a controller 2721. In some embodiments, user-interface 2701 may one or more electronic input devices and/or input means. In some embodiments, user-interface 2701 may be selected from one or more of: a touchscreen, a button, a switch, a dial, a slide, a lever, a microphone, a camera, an antenna, a radio, a WiFi radio, a Bluetooth radio, a port, a portion thereof, a combination thereof, and/or the like. In some embodiments, at least one user-interface 2701 may be located on a top of tower 2700. In some embodiments, user-interface 2701 may be operatively connected to electronics of tower 2700, such as, but not limited to, controller 2721.

Continuing discussing FIG. 18A and/or FIG. 18B, in some embodiments, temperature-sensor 2707 may be configured to read and/or determine a temperature of immersion-liquid 180 within wettable-subassembly 104. In some embodiments, temperature-sensor 2707 may be temperature probe, a thermometer, a temperature probe, a thermocouple, a portion thereof, combinations thereof, and/or the like. In some embodiments, temperature-sensor 2707 may be operatively connected to electronics of tower 2700, such as, but not limited to, controller 2721.

Continuing discussing FIG. 18A and/or FIG. 18B, in some embodiments, gas-line-tubing 2709 may be configured to transport one or more gasses within gas-line-tubing 2709. In some embodiments, gas-line-tubing 2709 may be gas line tubing. In some embodiments, gas-line-tubing 2709 may be one or more of: hollow, tubing, piping, elongate, flexible, semi-rigid, rigid, have an exterior that is non-permeable to its intended gasses, a portion thereof, combinations thereof, and/or the like. In some embodiments, gas-line-tubing 2709 may be configured to provide one or more gasses from gas-source 2725 to bubble-emitter 2710. In some embodiments, gas-line-tubing 2709 may be disposed between gas-source 2725 and bubble-emitter 2710. In some embodiments, gas-line-tubing 2709 may be attached to both gas-source 2725 and to bubble-emitter 2710.

Continuing discussing FIG. 18A, in some embodiments, bubble-emitter 2710 may be configured to be (removably) immersed into immersion-liquid 180 within wettable-subassembly 104 and to release gas bubbles 250 into immersion-liquid 180 within wettable-subassembly 104 (see FIG. 2A for gas bubbles 250). In some embodiments, bubble-emitter 2710 may be one or more of: hollow, tubing, piping, elongate, flexible, semi-rigid, rigid, have an exterior that is permeable to its intended gasses (e.g., perforated), a portion thereof, combinations thereof, and/or the like. In some embodiments, bubble-emitter 2710 may be an air stone. In some embodiments, bubble-emitter 2710 may be a fixed length of tubing that is permeable to the gasses. In some embodiments, bubble-emitter 2710 may comprise a plurality of holes, apertures, pores, and/or the like that are configured to release gas bubbles 250 into immersion-liquid 180 within wettable-subassembly 104. In some embodiments, a given section bubble-emitter 2710 may be attached to at least one section of gas-line-tubing 2709. In some embodiments, a given section bubble-emitter 2710 may be attached to two different sections of gas-line-tubing 2709.

In some embodiments, gas-source 2725, may be a source of gas or gasses to tower 2700, gas-line-tubing 2709, and/or bubble-emitter 2710. In some embodiments, gas-source 2725 may be one or more gas cylinders; wherein each such gas cylinder may contain a predetermined volume and/or pressure of one or more gasses, such as, but not limited to, air, oxygen, carbon dioxide, nitrogen, argon, a portion thereof, combinations thereof, and/or the like. In some embodiments, such a given gas cylinder may be fitted with a pressure regulator and/or a solenoid valve, wherein the solenoid valve may be operatively connected to controller 2721 (and/or to user-interface 2701). In some embodiments, gas-source 2725 may be an electrical pump and/or compressor that is configured to compress and pump air. In some embodiments, such a given electrical pump and/or compressor may be in operative communication with controller 2721 (and/or with user-interface 2701). In some embodiments, gas-source 2725 may be operatively connected to gas-line-tubing 2709. In some embodiments, an output of gas-source 2725 may be attached to gas-line-tubing 2709. See e.g., FIG. 19 for gas-source 2725.

Continuing discussing FIG. 18A and/or FIG. 18B, in some embodiments, light-source 2723, may be one or more light sources. In some embodiments, light-source 2723 may be one or more light emitting diodes (LEDs), incandescent light sources, fluorescent light sources, a portion thereof, and/or the like. In some embodiments, light-source 2723 may be configured to shine in or at one or more: color(s), predetermined color(s), selectable color(s), programmable color(s), (color) temperature(s) (e.g., often referred to in Kelvin), predetermined temperature(s), selectable temperature(s), programmable temperature(s), wavelength(s), predetermined wavelength(s), selectable wavelength(s), programmable wavelength(s), a color of the human visual spectrum, in the ultraviolet (UV) spectrum, in the infrared (IR) spectrum, a portion thereof, combinations thereof, and/or the like. In some embodiments, light-source 2723 may be oriented to be emitted from tower 2700 and/or from housing 2703 and into and/or at rear-panel 105. In some embodiments, at least some light emitted by light-source 2723 may shine at and/or on rear-panel 105. In some embodiments, at least some light emitted by light-source 2723 may be directed to shine at and/or on rear-panel 105. In some embodiments, at least a portion of rear-panel 105 may be transparent and/or translucent with respect to the wavelength(s) of light being emitted by light-source 2723, so that at least some of the emitted light of light-source 2723 may shine into the immersion-liquid 180 within wettable-subassembly 104. In some embodiments, light-source 2723 may be in operative communication with controller 2721 (and/or with user-interface 2701).

Continuing discussing FIG. 18A and/or FIG. 18B, in some embodiments, screen 2727, may be a display and/or a screen of tower 2700. In some embodiments, screen 2727 may be a touchscreen. In some embodiments, screen 2727 may not be a touchscreen. In some embodiments, screen 2727 may be an output device and/or an output means of tower 2700. In some embodiments, screen 2727 may be a LED, a LCD (liquid crystal display), and/or the like type of screen (display). In some embodiments, screen 2727 may be configured to display current and/or past status of one or more of the electronics of tower 2700. In some embodiments, screen 2727 may be configured to display one or more timers and/or user profiles. In some embodiments, screen 2727 may be in operative communication with controller 2721 (and/or with user-interface 2701).

In some embodiments, power 2729, may be configured to receive electrical power from main-power-cable 2711 and to then distribute electrical power to one or more electronics of tower 2700. In some embodiments, power 2729 may be one or more of: an electrical power management circuit, an electrical distribution circuit, an AC/DC converter, a DC/AC inverter, a battery, a rechargeable battery, a capacitor, a portion thereof, combinations thereof, and/or the like. In some embodiments, power 2729 may be operatively connected to one or more of: electronics of tower 2700, user-interface 2701, temperature-sensor 2707, controller 2721, light-source 2723, gas-source 2725, screen 2727, a portion thereof, combinations thereof, and/or the like. In some embodiments, power 2729 may provide electrical power (directly and/or indirectly) to one or more of: electronics of tower 2700, user-interface 2701, temperature-sensor 2707, controller 2721, light-source 2723, gas-source 2725, screen 2727, a portion thereof, combinations thereof, and/or the like. In some embodiments, power 2729 may provide direct electrical power to the given electronics component and/or hardware element, by being directly wired to that given electronics component and/or hardware element. In some embodiments, power 2729 may provide indirect electrical power to the given electronics component and/or hardware element, by being directly wired to controller 2721, and then controller 2721 may be directly wired to that given electronics component and/or hardware element. See e.g., FIG. 19 for power 2729, and see FIG. 18C and/or FIG. 18D for main-power-cable 2711.

In some embodiments, controller 2721, may be configured to control, operate, and/or manage one or more of: electronics of tower 2700, user-interface 2701, temperature-sensor 2707, light-source 2723, gas-source 2725, screen 2727, power 2729, a portion thereof, combinations thereof, and/or the like. In some embodiments, controller 2721 may be operatively and/or directly connected to one or more of: electronics of tower 2700, user-interface 2701, temperature-sensor 2707, light-source 2723, gas-source 2725, screen 2727, power 2729, a portion thereof, combinations thereof, and/or the like. In some embodiments, controller 2721 may be directly wired to one or more of: electronics of tower 2700, user-interface 2701, temperature-sensor 2707, light-source 2723, gas-source 2725, screen 2727, power 2729, a portion thereof, combinations thereof, and/or the like. In some embodiments, controller 2721 may be one or more: control circuits, a processor, a PCB (printed circuit board), a motherboard, a PLC (programmable logic controller), a graphics card, a portion thereof, a combination thereof, and/or the like. In some embodiments, controller 2721 may comprise and/or may be operatively connected to memory and/or to storage, for the non-transitory storing and/or saving of firmware, operating code, software, programs, computer programs, data, information, settings, profiles, a portion thereof, combinations thereof, and/or the like. See e.g., FIG. 19 for controller 2721.

FIG. 18C shows an embodiment of tower 2700 from a rear (back) and right-side perspective view. FIG. 18D shows an embodiment of tower 2700 from a rear (back) perspective view. In some embodiments, tower 2700 may comprise at least one handle 2705. In some embodiments, handle 2705 may be located on and/or attached to housing 2703. In some embodiments, handle 2705 may be a handle of tower 2700. In some embodiments, handle 2705 may be configured to be used as a handle by user 190, such that user 190 may completely lift tower 2700 completely off of a given support structure (such as, but not limited to, a tabletop, a desktop, a shelf, a countertop, the floor, the ground, and/or the like). In some embodiments, handle 2705 may be configured to structurally support a load of tower 2700. In some embodiments, tower 2700 may comprise at least one main-power-cable 2711. In some embodiments, main-power-cable 2711 may be an electrical power cable. In some embodiments, main-power-cable 2711 may be attached to power 2729 and/or to controller 2721. In some embodiments, a free terminal end of main-power-cable 2711 (e.g., that is not attached to power 2729 and/or to controller 2721) may be a plug that is configured for removable attachment to an electrical receptable. In some embodiments, the electrical receptable may be one from a building that may provide building mains power, such as, but limited to, in a form of 110 volts to 120 volts A C or 220 volts to 240 volts AC.

Note, in some embodiments, a left-side of tower 2700 may be at least substantially (mostly) a mirror image of a right-side of tower 2700, both in terms of looks and in terms of functionality.

Note, in some embodiments, tower 2700 may not provide any direct electrical wiring and/or electrical distribution or supply to vessel-subassembly 102 wettable-subassembly 104, breathing-apparatus 1700, headrest 1800, a portion thereof, combinations thereof, and/or the like. In some embodiments, there may be no electrical wiring and/or no wires running from tower 2700 to one or more of: vessel-subassembly 102 wettable-subassembly 104, breathing-apparatus 1700, headrest 1800, a portion thereof, combinations thereof, and/or the like. See e.g., FIG. 2A, FIG. 2B, FIG. 2C, FIG. 2D, FIG. 18A, FIG. 18B, FIG. 18C, and/or FIG. 18D.

FIG. 19 shows a schematic block diagram of at least some of the possible electronics of tower 2700. In some embodiments, tower 2700 may comprise one or more of: user-interface 2701, housing 2703, temperature-sensor 2707, gas-line-tubing 2709, bubble-emitter 2710, gas-source 2725, controller 2721, light-source 2723, screen 2727, power 2729, electronics, a portion thereof, combinations thereof, and/or the like.

In some embodiments, soaking-device 100, vessel-subassembly 102 wettable-subassembly 104, tower 2700, a portion thereof, combinations thereof, and/or the like may be entirely and/or completely devoid of active heating and/or cooling means. In some embodiments, soaking-device 100, vessel-subassembly 102, wettable-subassembly 104, tower 2700, a portion thereof, combinations thereof, and/or the like may be entirely and/or completely devoid of any heater, refrigerator, and/or freezer. However, in some embodiments, at least portions of soaking-device 100, vessel-subassembly 102 wettable-subassembly 104, a portion thereof, combinations thereof, and/or the like may be insulated to reduce (slow down) heat transfer from immersion-liquid 180 within wettable-subassembly 104.

In some embodiments, the volume of immersion-liquid 180 intended to be used in wettable-subassembly 104, may be heated and/or cooled prior to be poured (inserted) into wettable-subassembly 104. Thus, in some embodiments, any heating and/or cooling of immersion-liquid 180 to be used in wettable-subassembly 104 may be come devices and/or means that are external and/or outside of soaking-device 100, vessel-subassembly 102 wettable-subassembly 104, tower 2700, a portion thereof, combinations thereof, and/or the like.

In some embodiments, the intended volume of immersion-liquid 180 to be used in wettable-subassembly 104 may be initially held in or more liquid holding vessels, such as, but not limited to, one or more pitchers, carafes, or the like. Those vessel(s) holding the volume(s) of immersion-liquid 180 may be chilled by placing in a freezer and/or a refrigerator for long enough to chill that immersion-liquid 180 to a desired cool temperature. Alternatively, those vessel(s) holding the volume(s) of immersion-liquid 180 may be chilled by use of ice cubes, crushed ice, cold packs, or the like. Also, the immersion-liquid 180 within those vessel(s) may be heated by obtaining immersion-liquid 180 directly from a hot water source, such as, but not limited to, hot water from a hot water tap source, hot water from a heated kettle, teapot, pot, and/or the like. When the volume(s) of immersion-liquid 180 within those vessel(s) is at the desired temperature (hot, warm, cool, or cold), that immersion-liquid 180 may then be poured into wettable-subassembly 104.

FIG. 20 shows how the volume(s) of immersion-liquid 180, before being poured into wettable-subassembly 104, may be heated or cooled, and then after such heating or cooling, poured into wettable-subassembly 104. FIG. 20 may be schematic block diagram showing the initial heating or cooling phase and then followed by the pouring phase. FIG. 20 may show pitcher 2000 (or the like) that is temporarily holding a volume of immersion-liquid 180 that is intended for use in wettable-subassembly 104. Block 2001 in FIG. 20 may be cooling-means 2001 and may represent cooling pitcher 2000, with its volume of immersion-liquid 180, by use of one or more of: a freezer, refrigerator, ice, ice cubes, crushed ice, ice packs, and/or the like. Block 2003 in FIG. 20 may be heating-means 2003 and may represent heating the volume of immersion-liquid 180, by use of one or more of: hot water from a hot water tap source (e.g., hot water spigot), hot water from a heated kettle, teapot, pot, and/or the like and/or the like. In some embodiments, the kettle, teapot, and/or the pot may be the pitcher 2000 with its volume of immersion-liquid 180.

Note, at least some embodiments of soaking-device 100, vessel-subassembly 102 wettable-subassembly 104, and/or tower 2700 as shown, described, and taught herein may not comprise nor include components, parts, and/or structures referred to in U.S. nonprovisional patent application Ser. No. 18/197,365 filed on May 15, 2023, such as, but not limited to the following from U.S. nonprovisional patent application Ser. No. 18/197,365: side-panel 107 as a separate and distinct part (component); bottom-panel 113 as a separate and distinct part (component); fastener 109; washer 110; cam-post 707; cam-terminal-end 709; cam-pocket 711; bore 713; aperture 721; terminal end 801; aperture 803; threaded-insert 805; threaded-insert 917; bore 1203; threaded-insert 1205; light-source 1500; wire(s) (cable(s)) 1501; cam-nut 1600; and/or intermediary-power-cable 2713.

For example, and without limiting the scope of the present invention, side-panel-portion 107 and bottom-panel-portion 113 in the present patent application are merely different regions of a same integral single article of manufacture, namely of outermost-shell 106; whereas, in U.S. nonprovisional patent application Ser. No. 18/197,365 side-panel 107 and bottom-panel 113 are each a separate and distinct part (component) from each other. Outermost-shell 106 does not exist in U.S. nonprovisional patent application Ser. No. 18/197,365.

For example, and without limiting the scope of the present invention, electronics 117 of U.S. nonprovisional patent application Ser. No. 18/197,365 does not exist as components (parts) of vessel-subassembly 102 and/or of wettable-subassembly 104, in the present patent application, but electronics 117 of U.S. nonprovisional patent application Ser. No. 18/197,365 may be at least some electronics of tower 2700 in some embodiments of the present invention as long as vessel-subassembly 102 and/or of wettable-subassembly 104 do not have any electronics.

In some embodiments, soaking-device 100 may comprise wettable-floor-and-sidewalls 101 front-panel 103, rear-panel 105, and outermost-shell 106. In some embodiments, wettable-floor-and-sidewalls 101 may form both a wettable-floor (such as, but not limited to, floor-portion 1101) and wettable-sidewalls (such as, but not limited to, sidewall-portions 1103) of wettable-subassembly 104 of soaking-device 100. In some embodiments, wettable-subassembly 104 may be configured to hold a volume of immersion-liquid 180 without leaking (particularly when the outermost-shell 106 is used as intended). In some embodiments, front-panel 103 may attach to a first terminal-end 1107 of wettable-floor-and-sidewalls 101 (and in some embodiments this attachment may utilize a given end-gasket 1200). In some embodiments, rear-panel 105 may attach to a second (and opposing) terminal-end 1107 of wettable-floor-and-sidewalls 101 (and in some embodiments this attachment may utilize a given different [separate] end-gasket 1200). In some embodiments, wettable-subassembly 104 may comprise wettable-floor-and-sidewalls 101, front-panel 103, and rear-panel 105. In some embodiments, when front-panel 103 is attached to wettable-floor-and-sidewalls 101 and when rear-panel 105 is attached to wettable-floor-and-sidewalls 101, then wettable-subassembly 104 may be formed. In some embodiments, outermost-shell 106 may form both an external bottom (such as, but not limited to, bottom-panel-portion 113) and external sidewalls (such as, but not limited to, side-panel-portions 107) of soaking-device 100 (and/or of vessel-subassembly 102). In some embodiments, outermost-shell 106 may externally cover over wettable-floor-and-sidewalls 101 in an assembled configuration of soaking-device 100 (and/or of vessel-subassembly 102). In some embodiments, wettable-subassembly 104 when holding the volume of immersion-liquid 180 may be configured to soak a portion of a body part of an animal 190. In some embodiments, the animal 190 may be a human 190 or a person 190. In some embodiments, the body part may be a neck of user 190.

In some embodiments, front-panel 103 may comprise a neck-gasket 500. In some embodiments, neck-gasket 500 is configured for removable physical contact with a front region 197 of a neck of the animal 190, wherein the neck is the body part. In some embodiments, when neck-gasket 500 is in intended use with the animal 190, neck-gasket 500 does not go around (and does not enclose) a full circumference of the neck of the animal 190. See e.g., FIG. 1 FIG. 2A, and FIG. 7F.

In some embodiments, the soaking-device 100 and/or vessel-subassembly 102 may further comprise a pair of handles 1300 that are attached to outermost-shell 106. See e.g., FIG. 1, FIG. 2C, FIG. 9A, FIG. 9C, FIG. 9E, and FIG. 9F.

In some embodiments, in an assembled configuration of soaking-device 100 (and/or of vessel-subassembly 102), outermost-shell 106 may squeeze front-panel 103 against wettable-floor-and-sidewalls 101 and may also simultaneously squeeze rear-panel 105 against wettable-floor-and-sidewalls 101. In some embodiments, physical contact between front-panel 103 and outermost-shell 106 does not utilize any: screws, bolts, rivets, nails, pins, staples, brads, tacks, dowels, nor biscuits. In some embodiments, physical contact between rear-panel 105 and outermost-shell 106 does not utilize any: screws, bolts, rivets, nails, pins, staples, brads, tacks, dowels, nor biscuits.

In some embodiments, physical contact between front-panel 103 and wettable-floor-and-sidewalls 101 does not utilize any: screws, bolts, rivets, nails, pins, staples, brads, tacks, dowels, nor biscuits. In some embodiments, physical contact between rear-panel 105 and wettable-floor-and-sidewalls 101 does not utilize any: screws, bolts, rivets, nails, pins, staples, brads, tacks, dowels, nor biscuits.

In some embodiments, wettable-subassembly 104 has no electronics. In some embodiments, soaking-device 100 may further comprises tower 2700 that is freely movable and/or separable from wettable-subassembly 104. In some embodiments, a system and/or a kit may comprise soaking-device 100 and tower 2700. In some embodiments, tower 2700 may comprise electronics. In some embodiments, tower 2700 may comprise at least one light source 2723 that is configured to shine at least some light through rear-panel 105 and into immersion-liquid 180 within wettable-subassembly 104. In some embodiments, tower 2700 may comprise at least one gas source 2725 (such as but not limited to, a gas compressor, a gas pump, and/or a gas cylinder). In some embodiments, at least one bubble-emitter 2710 may be configured to emit (gas) bubbles 250 into immersion-liquid 180 within wettable-subassembly 104. In some embodiments, the at least one bubble-emitter 2710 may be operatively connected to the at least one gas source 2725. In some embodiments, tower 2700 may comprise at least one temperature-sensor 2707 that is configured to sense a temperature of immersion-liquid 180 within wettable-subassembly 104. See e.g., FIG. 2A, FIG. 2B, FIG. 2C, FIG. 18A, and FIG. 19.

In some embodiments, soaking-device 100 (and/or vessel-subassembly 102 and/or wettable-subassembly 104) may further comprise insulation 115 that is configured to slow heat transfer from wettable-floor-and-sidewalls 101. See e.g., FIG. 12D and FIG. 12E.

In some embodiments, soaking-device 100 may further comprise a breathing-apparatus 1700. In some embodiments, a kit and/or a system may comprise both soaking-device 100 and breathing-apparatus 1700. In some embodiments, breathing-apparatus 1700 is configured to permit the animal 190 to breathe when a mouth and/or a nose of the animal 190 are immersed within immersion-liquid 180 within wettable-subassembly 104. See e.g., FIG. 17A through FIG. 17H.

In some embodiments, soaking-device 100 may further comprise a headrest 1800. In some embodiments, a kit and/or a system may comprise both soaking-device 100 and headrest 1800. In some embodiments, headrest 1800 is configured to support at least portion of a head of the animal 190 when the portion of the body part (e.g., a portion of a face 192) is immersed within immersion-liquid 180 within wettable-subassembly 104. See e.g., FIG. 2A, FIG. 2B, and FIG. 2C.

In some embodiments, the volume of immersion-liquid 180, intended for use within wettable-subassembly 104, may be heated or cooled externally (separately) from soaking-device 100. See e.g., FIG. 20.

A soaking-device, a face soaking-device, a system and/or a kit that comprises a soaking-device (or face soaking-device) have been described. The foregoing description of the various exemplary embodiments of the invention has been presented for the purposes of illustration and disclosure. It is not intended to be exhaustive or to limit the invention to the precise form disclosed. M any modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A face-soaking-device comprising:
a vessel having an open top and capable of holding a liquid in an interior volume of the vessel; and
a breathing apparatus comprising:
a mouth piece member,
at least one tubing, and
at least one connector,
wherein the at least one tubing comprises two opposing terminal ends, wherein one of the two opposing terminals ends is connected to the mouth piece member and the other of the two opposing terminal ends is connected to the at least one connector, wherein the at least one connector is configured to be attachable to a side wall of the vessel,
wherein the breathing apparatus is configured to permit a user to breathe while a face of the user is at least partially submerged within the liquid in the interior volume of the vessel.

2. The face-soaking-device according to claim 1, wherein the at least one tubing comprises a first tubing and a second tubing.

3. A breathing apparatus that is configured for use with a face soaking device, wherein the breathing apparatus comprises:
a mouth piece member;
at least one tubing, wherein the at least one tubing comprises two opposing terminal ends; and
at least one elongate-hollow-member, wherein the at least one elongate-hollow-member comprises at least one aperture for bringing in air that is external to the breathing apparatus;
wherein one of the two opposing terminals ends is connected to the mouth piece member and the other of the two opposing terminal ends is connected to the at least one elongate-hollow-member;
wherein the breathing apparatus is configured to permit a user to breathe while a face of the user is at least partially submerged within a liquid in an interior volume of the vessel;
wherein during breathing use of the breathing apparatus with the face of the user is at least partially submerged within the liquid in the interior volume of the vessel, the at least one elongate-hollow-member is configured to be disposed at least mostly behind an upper portion of the user.

4. The breathing apparatus according to claim 3, wherein the at least one tubing comprises a first tubing and a second tubing.

5. The breathing apparatus according to claim 4, wherein an overall shape of the breathing apparatus forms a closed loop structure.

6. A breathing apparatus that is configured for use with a face-soaking-device, wherein the breathing apparatus comprises:
a mouth piece member;
at least one tubing, wherein the at least one tubing comprises two opposing terminal ends; and
at least one connector;
wherein one of the two opposing terminals ends is connected to the mouth piece member and the other of the two opposing terminal ends is connected to the at least one connector;
wherein the at least one connector is configured to be attachable to a side wall of a vessel of the face-soaking-device;
wherein the breathing apparatus is configured to permit a user to breathe while a face of the user is at least partially submerged within a liquid in an interior volume of the vessel;
wherein the mouth piece member is movable from below the at least one connector to above the at least one connector when the at least one connector is attached to the side wall.

7. The face-soaking-device according to claim 6, wherein the at least one tubing comprises a first tubing and a second tubing.
